(19) United States
(12) Patent Application Publication
(10) Pub. No.: US 2026/0342685 A1
(43) Pub. Date: Oct. 29, 2026

(54) SYSTEMS AND METHODS FOR AUTOMATED GENERATION AND VISUALIZATION OF GEOREFERENCED AND NON-GEOREFERENCED GRAPHS UNDER A UNIFIED FRAMEWORK

(71) Applicant: SAS Institute Inc., Cary, NC (US)

(72) Inventors: Carlos Andre Reis Pinheiro, Cary, NC (US); Steven Harenberg, Chapel Hill, NC (US)

(73) Assignee: SAS Institute Inc., Cary, NC (US)

(21) Appl. No.: 19/550,622

(22) Filed: Feb. 26, 2026

Related U.S. Application Data
(60) Provisional application No. 63/796,181, filed on Apr. 28, 2025.
(60) Provisional application No. 63/808,793, filed on May 20, 2025.

(51) Int. Cl. H04L 41/22

(52) U.S. Cl. CPC H04L 41/22

(57) ABSTRACT

A system, method, and computer-program product includes receiving a network visualization request associated with one or more network datasets; automatically generating a network visualization file in response to receiving the network visualization request, wherein automatically generating the network visualization file includes: automatically generating a nodes visualization data object and a links visualization data object from the one or more network datasets, automatically computing a plurality of network visualization parameters optimized for the one or more network datasets, and automatically embedding, in the network visualization file, one or more network visualization rendering instructions; displaying, via a user interface, an interactive network visualization object comprising a plurality of graphical nodes and a plurality of graphical links in response to receiving user input opening the network visualization file; and modifying, in the interactive network visualization object, one or more of the plurality of graphical nodes and the plurality of graphical links.

### CROSS-REFERENCE TO RELATED APPLICATIONS

The present application claims the benefit of U.S. Provisional Application No. 63/808,793, filed on 20 May 2025, and U.S. Provisional Application No. 63/796,181, filed on 28 Apr. 2025, each of which is incorporated by reference in its entirety.

### TECHNICAL FIELD

The embodiments of the present application relate generally to computer-implemented data processing and visualization, and more specifically, to systems and methods for generating and rendering network graph visualizations automatically using a unified computational framework.

### BACKGROUND

Modern data analytics pipelines frequently process large, heterogeneous datasets derived from transactional systems, sensor networks, communication logs, and other high-volume data sources. Analytical procedures applied to such datasets increasingly rely on graph-based representations to capture relational structure among entities, events, or states. In a graph-based model, nodes may represent identifiable elements within the dataset and links may represent dependencies, interactions, correlations, or other defined relationships. Network analysis techniques employing such models can provide insight into structural characteristics that may not be observable when data elements are evaluated independently.

Although algorithms for generating graph-structured analytical outputs are widely used, the outputs they produce often take the form of tabular datasets, intermediate data structures, or algorithm-specific artifacts. These representations, while analytically valid, may be difficult for users to interpret because relational features of the graph may not be immediately apparent from inspection of individual records. As network size or relationship density increases, manual interpretation of tabular nodes datasets or links datasets may become increasingly cumbersome and resource-intensive.

To facilitate human understanding of such analytical results, visualization systems have been developed to transform network datasets into visual displays composed of graphical nodes and graphical links. Existing visualization tools, however, often rely on users performing significant preparatory work, including reformatting datasets into tool-specific formats, manually selecting layout algorithms, configuring visualization parameters, or writing custom scripts. These constraints can vary depending on the class of network analysis or network optimization algorithm that produced the dataset, resulting in fragmented workflows that rely on algorithm-specific preparation steps. Additionally, visualization configurations selected for one dataset may not generalize well to networks with substantially different sizes, densities, or topological properties.

Further, conventional visualization systems frequently treat georeferenced and non-georeferenced networks as distinct categories requiring separate configuration procedures. Visualizing datasets that encode geographic coordinates may utilize specialized map-based rendering logic, while non-georeferenced datasets rely on layout algorithms that compute node positions dynamically. Maintaining parallel configuration pipelines for these different categories can increase system complexity and reduce reusability of visualization logic across analytical contexts.

As a result, users may encounter substantial barriers when attempting to rapidly visualize, explore, or share graph-structured analytical results. A need exists for techniques that enable generation of interactive network visualizations directly from diverse network datasets without reliance on manual formatting, manual parameter tuning, or algorithm-specific workflows.

### BRIEF SUMMARY OF THE INVENTION(S)

In some embodiments, a computer-program product may comprise a non-transitory machine-readable storage medium storing computer instructions that, when executed by processing circuitry, perform operations comprising: receiving a network visualization request associated with one or more network datasets; automatically generating a network visualization file in response to receiving the network visualization request, wherein automatically generating the network visualization file includes: automatically generating a nodes visualization data object and a links visualization data object from the one or more network datasets, automatically computing a plurality of network visualization parameters optimized for the one or more network datasets, and automatically embedding, in the network visualization file, one or more network visualization rendering instructions based on the plurality of network visualization parameters, the nodes visualization data object, and the links visualization data object; displaying, via a user interface, an interactive network visualization object comprising a plurality of graphical nodes and a plurality of graphical links in response to receiving user input opening the network visualization file; and modifying, in the interactive network visualization object, one or more of the plurality of graphical nodes and the plurality of graphical links in response to receiving a network manipulation user input while the user interface is displaying the interactive network visualization object.

In some embodiments, a respective graphical node of the plurality of graphical nodes is a visual representation of a respective node visualization object in the nodes visualization data object, and the respective graphical node visually represents one or more of: a label attribute specified in the respective node visualization object; a shape attribute specified in the respective node visualization object; a color attribute specified in the respective node visualization object; and a value attribute specified in the respective node visualization object.

In some embodiments, a respective graphical link of the plurality of graphical links is a visual representation of a respective link visualization object in the links visualization data object, and the respective graphical link visually represents one or more of: a label attribute specified in the respective link visualization object; a color attribute specified in the respective link visualization object; a value attribute specified in the respective link visualization object; a connection from a source node and a target node specified in the respective link visualization object; and a direction attribute specified in the plurality of network visualization parameters that indicates whether the connection from the source node to the target node includes an arrow.

In some embodiments, generating the nodes visualization data object includes: (a) identifying a respective node in the one or more network datasets, (b) in accordance with a determination that the respective node is at a first index, adding, to the nodes visualization data object, a first string of text that: initializes an array of node objects, and includes a first node visualization object comprising one or more attributes of the respective node; (c) in accordance with a determination that the respective node is not at the first index, appending, to the nodes visualization data object, a second string of text comprising the first node visualization object; (d) repeating (a)-(c) for each additional respective node in the one or more network datasets; and (e) adding, to the nodes visualization data object, a final string of text that syntactically closes the array of node objects.

In some embodiments, generating the links visualization data object includes: (a) identifying a respective link in the one or more network datasets, (b) in accordance with a determination that the respective link is at a first index, adding, to the links visualization data object, a first string of text that: initializes an array of link objects, and includes a first link visualization object comprising one or more attributes of the respective link; (c) in accordance with a determination that the respective link is not at the first index, appending, to the links visualization data object, a second string of text comprising the first link visualization object; (d) repeating (a)-(c) for each additional respective link in the one or more network datasets; and (e) adding, to the links visualization data object, a final string of text that syntactically closes the array of link objects.

In some embodiments, the one or more network visualization rendering instructions: instruct a container variable to store a target region for rendering the interactive network visualization object in the user interface, instruct a data variable to store the nodes visualization data object and the links visualization data object, instruct an options variable to store at least a subset of the plurality of network visualization parameters, and instantiate the interactive network visualization object using the container variable, the data variable, and the options variable.

In some embodiments, the network visualization request is configured to visualize a plurality of types of network datasets, and the plurality of types of network datasets that the network visualization request is configured to visualize includes one or more of: the one or more network datasets generated by a core decomposition network algorithm, one or more network datasets generated by a connected components network algorithm, one or more network datasets generated by a community detection network algorithm, one or more network datasets generated by a reach network algorithm, one or more network datasets generated by a pattern match network algorithm, one or more network datasets generated by a node similarity network algorithm, one or more network datasets generated by a cycle network algorithm, one or more network datasets generated by a clique network algorithm, one or more network datasets generated by a topological sort network algorithm, one or more network datasets generated by a shortest path network algorithm, and one or more network datasets generated by a vehicle routing network algorithm.

In some embodiments, the one or more network datasets include a tabular nodes dataset that is not empty and a tabular links dataset that is empty, the tabular links dataset is automatically generated from the tabular nodes dataset in response to a determination that the tabular links dataset is empty, and automatically generating the tabular links dataset includes: in accordance with a determination that a network type input argument included in the network visualization request corresponds to a clique network: (a) detecting a pair of nodes in the tabular nodes dataset that have a common clique identifier; (b) inserting, into the tabular links dataset, a link from a first node specified in the pair to a second node specified in the pair; and (c) repeating steps (a) and (b) for one or more additional pairs of nodes that have one or more second common clique identifiers.

In some embodiments, automatically generating the tabular links dataset from the tabular nodes dataset further includes: in accordance with a determination that the network type input argument included in the network visualization request corresponds to a cycle network: (a) detecting, from the tabular nodes dataset, a respective node and a next node that follows the respective node; (b) inserting, into the tabular links dataset, a link from the respective node to the next node; and (c) repeating steps (a) and (b) for a remainder of nodes in the tabular nodes dataset.

In some embodiments, the one or more network datasets include a tabular links dataset that is not empty, and the computer instructions, when executed by the processing circuitry, perform the operations comprising: (a) identifying a respective link specified in the tabular links dataset, (b) identifying, from a link attributes input argument, a link attribute entry corresponding to the respective link, (c) assigning one or more link attributes to the respective link based on the link attribute entry, and (d) repeating steps (a)-(c) for each additional respective link specified in the tabular links dataset.

In some embodiments, the one or more network datasets include a tabular links dataset that is not empty and a tabular nodes dataset that is empty, and the network visualization request includes a link attributes input argument, the tabular nodes dataset is automatically generated from the tabular links dataset in response to a determination that the tabular nodes dataset is empty, and automatically generating the tabular nodes dataset includes: (a) identifying a respective link in the tabular links dataset and a link attribute entry corresponding to the respective link in the link attributes input argument, (b) adding, to the tabular nodes dataset, a first node that corresponds to a source node associated with the respective link and includes one or more first node attributes derived from the link attribute entry, (c) adding, to the tabular nodes dataset, a second node that corresponds to a destination node associated with the respective link and includes one or more second node attributes derived from the link attribute entry, (d) repeating steps (a)-(c) for a remainder of links specified in the tabular links dataset, (e) assigning one or more additional node attributes to each node added to the tabular nodes dataset in steps (a)-(d), and (f) removing one or more duplicate nodes in the tabular nodes dataset after performing steps (a)-(e).

In some embodiments, the one or more network datasets include a tabular nodes dataset that is not empty, and the computer instructions, when executed by the processing circuitry, perform the operations comprising: (a) identifying a respective node specified in the tabular nodes dataset, (b) identifying, from a nodes attribute input argument, a node attribute entry corresponding to the respective node, (c) assigning one or more node attributes to the respective node based on the node attribute entry, and (d) repeating steps (a)-(c) for each additional respective node specified in the tabular nodes dataset.

In some embodiments, a respective link in the one or more network datasets includes one or more of: a link source attribute, a link destination attribute, a link weight attribute, a link label attribute, a link group attribute, and a link direction attribute; a respective node in the one or more network datasets includes one or more of: a node identifier attribute, a node label attribute, a node group value, a node value attribute, a node shape attribute, and a node color attribute; and if the respective link or the respective node is automatically generated, at least one attribute of the respective link or the respective node corresponds to a default value.

In some embodiments, the interactive network visualization object corresponds to an interactive geographic map, a display center of the interactive geographic map is determined from a centering latitude input argument and a centering longitude input argument specified in the network visualization request, a display zoom of the interactive geographic map is determined from a zoom level input argument specified in the network visualization request, and the interactive geographic map displays a respective graphical node of the plurality of graphical node at a position that corresponds to a latitude and longitude coordinate associated with the respective graphical node.

In some embodiments, the interactive network visualization object is an interactive geographic map that displays a respective graphical node of the plurality of graphical nodes with one or more of: a respective shape, a respective radius, a respective color, and a respective label, and when a map type input argument of the network visualization request corresponds to a first shape, the one or more network visualization rendering instructions: set the respective shape of the respective graphical node to the first shape, select the respective color of the respective graphical node by indexing a color array based on a type specified for the respective graphical node in a source node type input argument, set the respective radius of the respective graphical node to: a predefined constant when a value of the respective graphical node is non-positive; and a scaled value when the value of the respective graphical node is positive, wherein the scaled value is proportional to the value of the respective graphical node relative to a range of node values and offset by a minimum radius, and set the respective label of the respective graphical node to a label attribute specified in a corresponding record of the one or more network datasets.

In some embodiments, the interactive network visualization object is an interactive geographic map that visually represents a respective graphical node of the plurality of graphical nodes as an icon, and when a map type input argument of the network visualization request corresponds to a marker type, the one or more network visualization rendering instructions: set the icon as a marker, set a color of the marker based on a type specified for the respective graphical node in a source node type input argument, render the marker at a latitude and longitude associated with the respective graphical node, bind, to the marker, a label associated with the respective graphical node, bind, to the marker, a value associated with the respective graphical node when the value exceeds a threshold, display a circle centered at the latitude and longitude of the respective graphical node with a respective radius and a respective color when the respective graphical node corresponds an origin node input argument, and bind, to the circle, one or more attributes of the respective graphical node including at least one of: the label, the value, a depot label, and a depot value when the value exceeds the threshold.

In some embodiments, when a map type input argument of the network visualization request corresponds to a line type, the one or more network visualization rendering instructions cause the interactive network visualization object to: render a respective graphical link of the plurality of graphical links as a polyline between a latitude and longitude of a source graphical node and a latitude and longitude of a sink graphical node, set a thickness of the polyline based on a value attribute included in a corresponding record in the one or more network datasets, set a color of the polyline based on a color attribute included in the corresponding record, and when a label attribute is present in the corresponding record, bind the label attribute to the polyline as a tooltip.

In some embodiments, when the map type input argument of the network visualization request corresponds to the line type, the one or more network visualization rendering instructions further cause the interactive network visualization object to: when a marker type input argument corresponds to a first marker type: render a first marker at the latitude and longitude of the source graphical node, when a node label attribute is present for the source graphical node, bind the node label attribute of the source graphical node to the first marker, set a color of the first marker based on a type of the source graphical node, render a second marker at the latitude and longitude of the sink graphical node, when a node label attribute is present for the sink graphical node, bind the node label attribute of the sink graphical node to the second marker, and set a color of the second marker based on a type of the sink graphical node; and when the marker type input argument corresponds to a second marker type: render a third marker at a latitude and longitude of an origin graphical node, bind, to the third marker, a label node attribute associated with the origin graphical node, render a fourth marker at a latitude and longitude of a destination graphical node, and bind, to the fourth marker, a label node attribute associated with the destination graphical node.

In some embodiments, the one or more network visualization rendering instructions includes a network initialization instruction for initializing the interactive network visualization object, and the network initialization instruction receives a plurality of input arguments, including: a first input argument that specifies a target region of the user interface to display the interactive network visualization object, a second input argument that includes the nodes visualization data object and the links visualization data object, and a third input argument that includes the plurality of network visualization parameters.

In some embodiments, a respective graphical node of the plurality of graphical nodes is displayed at a respective size, the interactive network visualization object determines the respective size for the respective graphical node based at least on a node scaling range parameter included in the plurality of network visualization parameters, a lower bound of the node scaling range parameter corresponds to a sum of a first node scaling constant and a logarithm of a total number of nodes in the one or more network datasets, an upper bound of the node scaling range parameter corresponds to a sum of a second node scaling constant and a square of the logarithm of the total number of nodes in the one or more network datasets, and the first node scaling constant and the second node scaling constant creates a slope in a node distribution defined by the logarithm of the total number of nodes.

In some embodiments, a respective graphical node of the plurality of graphical nodes is displayed with a respective label, the interactive network visualization object displays the respective label based on a node font size parameter included in the plurality of network visualization parameters, the node font size parameter corresponds to a sum of a node font size constant and a square of a logarithm of a total number of nodes in the one or more network datasets, and the node font size constant creates a slope in a node distribution defined by the logarithm of the total number of nodes.

In some embodiments, a respective graphical link of the plurality of graphical links is displayed at a respective width, the interactive network visualization object determines the respective width for the respective graphical link based at least on a link scaling range parameter included in the plurality of network visualization parameters, a lower bound of the link scaling range parameter corresponds to a ratio of a logarithm of a total number of links in the one or more network datasets to the total number of links in the one or more network datasets, an upper bound of the link scaling range parameter corresponds to a square of a sum of a link width constant and the logarithm of the total number of links in the one or more network datasets, and the link width constant creates a slope in a link distribution defined by the logarithm of the total number of links.

In some embodiments, a respective graphical link of the plurality of graphical links is displayed with a respective label, the interactive network visualization object displays the respective label based on a link font size parameter included in the plurality of network visualization parameters, the link font size parameter corresponds to a sum of a link font size constant and a logarithm of a total number of links in the one or more network datasets, and the link font size constant creates a slope in a link distribution defined by the logarithm of the total number of links.

In some embodiments, the interactive network visualization object determines a layout for the plurality of graphical nodes and the plurality of graphical links based at least on a layout algorithm parameter included in the plurality of network visualization parameters, the layout algorithm parameter specifies a first layout algorithm when a logarithm of a total number of links in the one or more network datasets exceeds a links threshold that creates a slope in a link distribution defined by the logarithm of the total number of links, and the layout algorithm parameter specifies a second layout algorithm when the logarithm of the total number of links does not exceed the links threshold.

In some embodiments, the interactive network visualization object determines a number of groups of graphical nodes to be used during layout calculations, the interactive network visualization object determines the number of groups of graphical nodes based on a grouping threshold parameter included in the plurality of network visualization parameters, the grouping threshold parameter corresponds to a product of: a grouping threshold constant, and a sum of: a grouping threshold offset constant, and a quotient of: a ratio of a logarithm of a total number of links in the one or more network datasets to a total number of nodes in the one or more network datasets, and a grouping threshold divisor constant that sets a scale of the ratio, and the grouping threshold offset constant adjusts a nodes and a link distribution defined by the logarithm of the total number of links and a logarithm of the total number of nodes.

In some embodiments, the interactive network visualization object determines a spacing between the plurality of graphical nodes, the interactive network visualization object determines the spacing based on a node spacing parameter included in the plurality of network visualization parameters, when a logarithm of a total number of links in the one or more network datasets exceeds a links threshold, the node spacing parameter corresponds to a product of: a first spacing constant that adjusts a node distribution defined by a logarithm of a total number of nodes in the one or more network datasets, and a sum of: a second spacing constant; and the logarithm of the total number of nodes in the one or more network datasets, and when the logarithm of the total number of links in the one or more network datasets does not exceed the links threshold, the node spacing parameter corresponds to a product of: a third spacing constant that adjusts the node distribution defined by the logarithm of the total number of nodes, and the sum of: the second spacing constant, and the logarithm of the total number of nodes in the one or more network datasets.

In some embodiments, the interactive network visualization object positions the plurality of graphical nodes relative to a center of the interactive network visualization object, the interactive network visualization object determines the positions of the plurality of graphical nodes relative to the center of the interactive network visualization object based on a centering parameter included in the plurality of network visualization parameters, when a logarithm of a total number of links in the one or more network datasets exceeds a links threshold, the centering parameter corresponds to a first centering constant that causes separation of the plurality of graphical nodes by a first distance in the interactive network visualization object, and when the logarithm of the total number of links in the one or more network datasets does not exceed the links threshold, the centering parameter corresponds to a second centering constant that causes separation of the plurality of graphical nodes by a second distance in the interactive network visualization object.

In some embodiments, a respective graphical link of the plurality of graphical links is displayed in the interactive network visualization object with a respective length, the interactive network visualization object determines the respective length for the respective graphical link based on a link length parameter included in the plurality of network visualization parameters, when a logarithm of a total number of links in the one or more network datasets exceeds a links threshold, the link length parameter corresponds to a sum of: a first link length constant that adjusts distances of the plurality of graphical links in the interactive network visualization object by a first amount, and a product of: a second link length constant; and a quotient of: a product of a logarithm of a total number of nodes in the one or more network datasets and the logarithm of the total number of links in the one or more network datasets; and a link length divisor constant, and the second link length constant scales an average nodes and links distribution defined by the quotient, when the logarithm of the total number of links in the one or more network datasets does not exceed the links threshold, the link length parameter corresponds to a sum of: a third link length constant that adjusts distances of the plurality of graphical links in the interactive network visualization object by a second amount, and the product of: the second link length constant; and the quotient of: the product of the logarithm of the total number of nodes in the one or more network datasets and the logarithm of the total number of links in the one or more network datasets; and the link length divisor constant.

In some embodiments, a computer-implemented method may comprise receiving a network visualization request associated with one or more network datasets; automatically generating a network visualization file in response to receiving the network visualization request, wherein automatically generating the network visualization file includes: automatically generating a nodes visualization data object and a links visualization data object from the one or more network datasets, automatically computing a plurality of network visualization parameters optimized for the one or more network datasets, and automatically embedding, in the network visualization file, one or more network visualization rendering instructions based on the plurality of network visualization parameters, the nodes visualization data object, and the links visualization data object; displaying, via a user interface, an interactive network visualization object comprising a plurality of graphical nodes and a plurality of graphical links in response to receiving user input opening the network visualization file; and modifying, in the interactive network visualization object, one or more of the plurality of graphical nodes and the plurality of graphical links in response to receiving a network manipulation user input while the user interface is displaying the interactive network visualization object.

In some embodiments, a computer-implemented system may comprise processing circuitry; a memory; and a computer-readable medium operably coupled to the processing circuitry the computer-readable medium having computer-readable instructions stored thereon that, when executed by the processing circuitry, cause a computing device to perform operations comprising: receiving a network visualization request associated with one or more network datasets; automatically generating a network visualization file in response to receiving the network visualization request, wherein automatically generating the network visualization file includes: automatically generating a nodes visualization data object and a links visualization data object from the one or more network datasets, automatically computing a plurality of network visualization parameters optimized for the one or more network datasets, and automatically embedding, in the network visualization file, one or more network visualization rendering instructions based on the plurality of network visualization parameters, the nodes visualization data object, and the links visualization data object; displaying, via a user interface, an interactive network visualization object comprising a plurality of graphical nodes and a plurality of graphical links in response to receiving user input opening the network visualization file; and modifying, in the interactive network visualization object, one or more of the plurality of graphical nodes and the plurality of graphical links in response to receiving a network manipulation user input while the user interface is displaying the interactive network visualization object.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to some embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to some embodiments of the present technology.

FIG. 11 illustrates a flow chart of an example of a process for generating and using a machine-learning model according to some aspects, according to some embodiments of the present technology.

FIG. 12 illustrates an example of a machine-learning model as a neural network, according to some embodiments of the present technology.

FIG. 13 illustrates various aspects of the use of containers as a mechanism to allocate processing, storage and/or other resources of a processing system to the performance of various analyses, according to some embodiments of the present technology.

FIG. 14 illustrates an example method according to some embodiments of the present technology.

FIG. 15A illustrates an example computer-executable network visualization file generation procedure according to some embodiments of the present technology.

FIG. 15B illustrates an example non-georeferenced network visualization function according to some embodiments of the present technology.

FIG. 15C illustrates an example georeferenced network visualization function according to some embodiments of the present technology.

FIG. 15C illustrates an example georeferenced network visualization function according to some embodiments of the present technology.

FIG. 15D illustrates an example links dataset generation procedure according to some embodiments of the present technology.

FIG. 15E illustrates an example links dataset generation procedure according to some embodiments of the present technology.

FIG. 15F illustrates an example link attribute assignment procedure according to some embodiments of the present technology.

FIGS. 15G and 15H illustrate an example nodes dataset generation procedure according to some embodiments of the present technology.

FIG. 15I illustrates an example node attribute assignment procedure according to some embodiments of the present technology.

FIG. 16A illustrates an example node array generation procedure according to some embodiments of the present technology.

FIG. 16B illustrates an example node array generation procedure according to some embodiments of the present technology.

FIG. 16C illustrates an example link array generation procedure according to some embodiments of the present technology.

FIG. 16D illustrates an example link array generation procedure according to some embodiments of the present technology.

FIG. 17A illustrates example network visualization parameters according to some embodiments of the present technology.

FIG. 17B illustrates an example computer-executable network visualization file according to some embodiments of the present technology.

FIGS. 17C through 17V illustrate example non-georeferenced network visualizations according to some embodiments of the present technology.

FIGS. 18A through 18J illustrate example georeferenced network visualizations according to some embodiments of the present technology.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional operations not included in a figure. A process may correspond to a method, a function, a procedure, a subroutine, a subprogram, etc. When a process corresponds to a function, its termination can correspond to a return of the function to the calling function or the main function.

### Example Systems

Systems depicted in some of the figures may be provided in various configurations. In some embodiments, the systems may be configured as a distributed system where one or more components of the system are distributed across one or more networks in a cloud computing system.

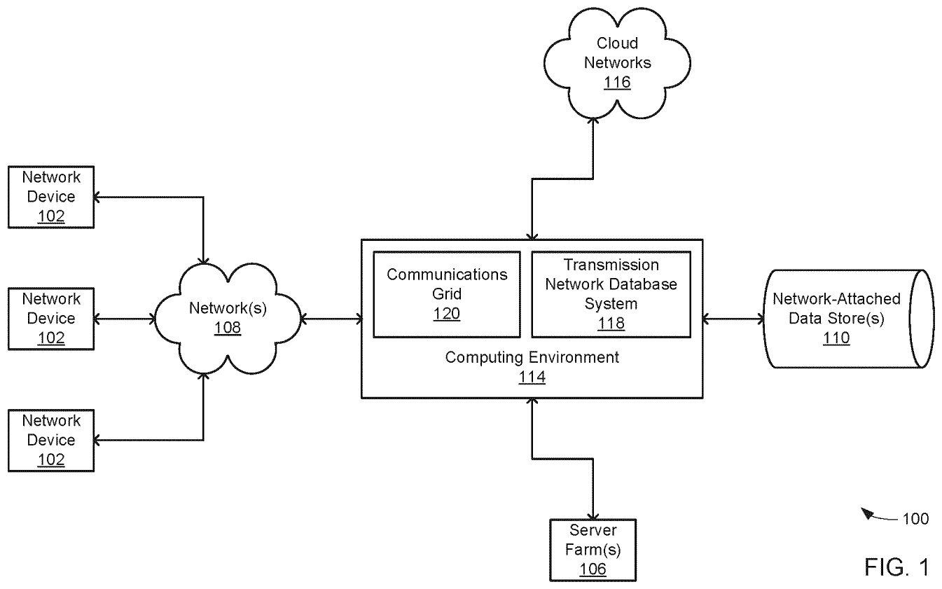

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

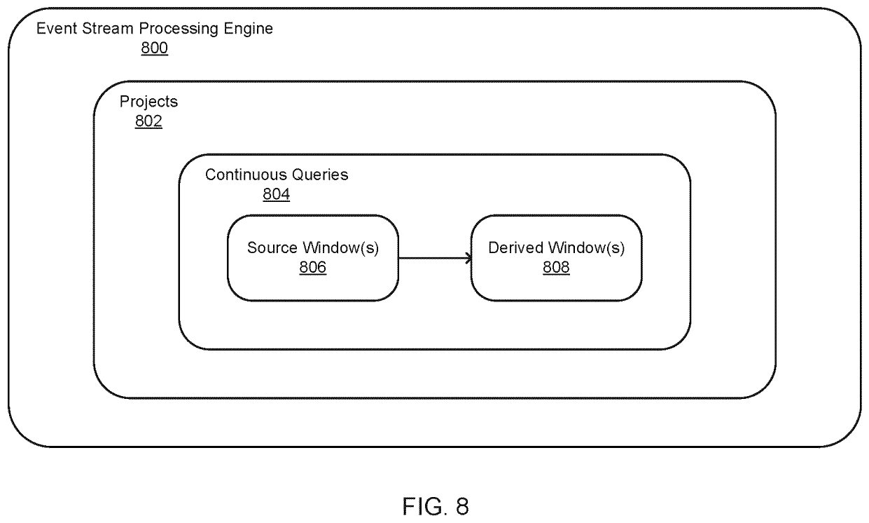

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more server farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

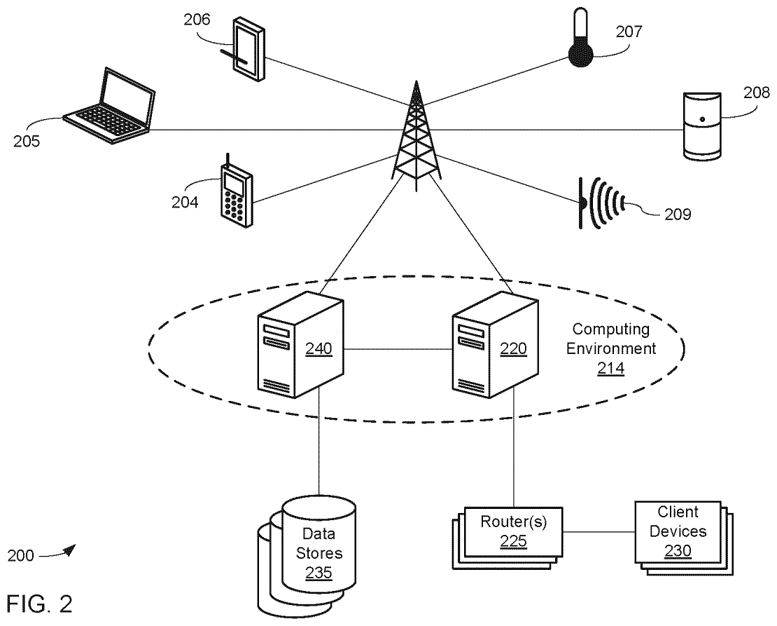

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® Low Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

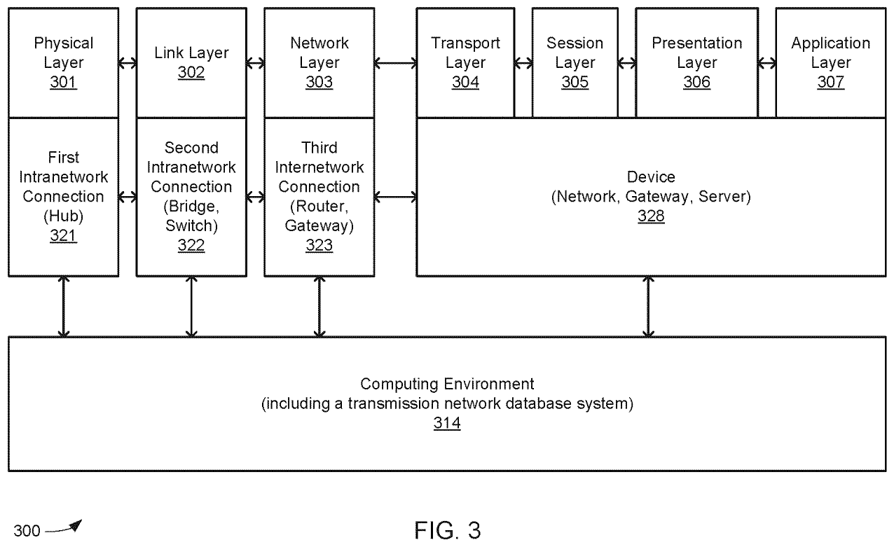

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data and is the farthest layer from the user in a communications system. On the other hand, the application layer is the highest layer because it interacts directly with a software application.

As noted, the model includes a physical layer 301. Physical layer 301 represents physical communication and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in a same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recently saved checkpoint of their status and re-start the project from that checkpoint to minimize lost progress on the project being executed.

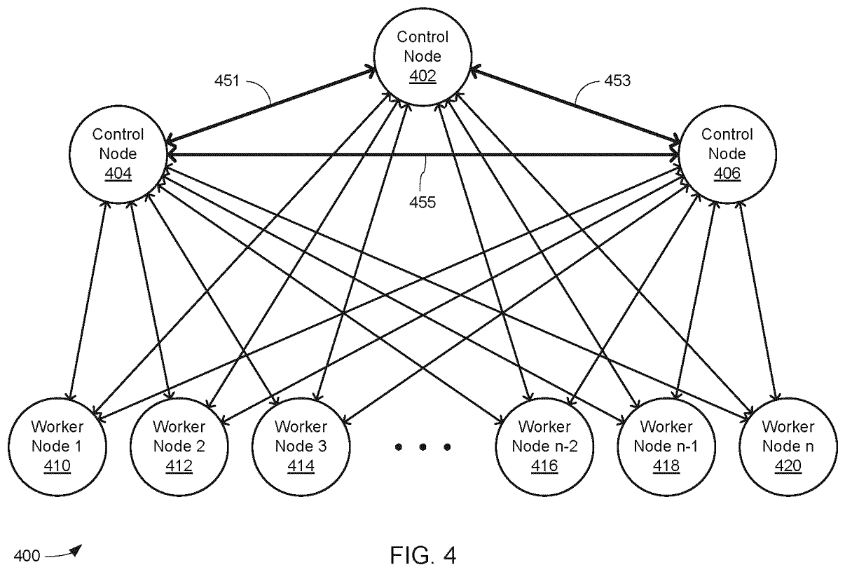

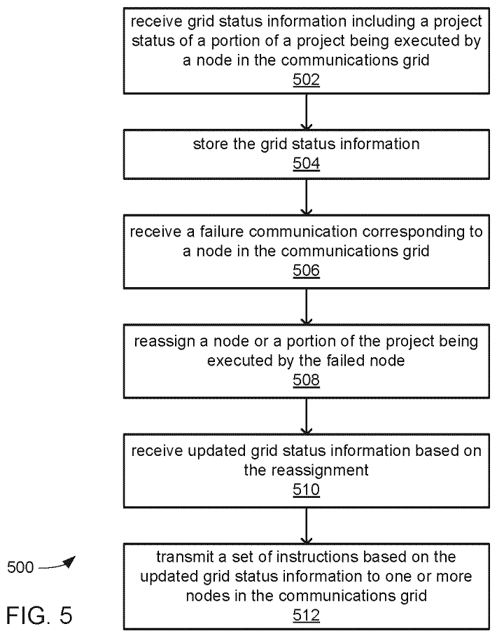

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

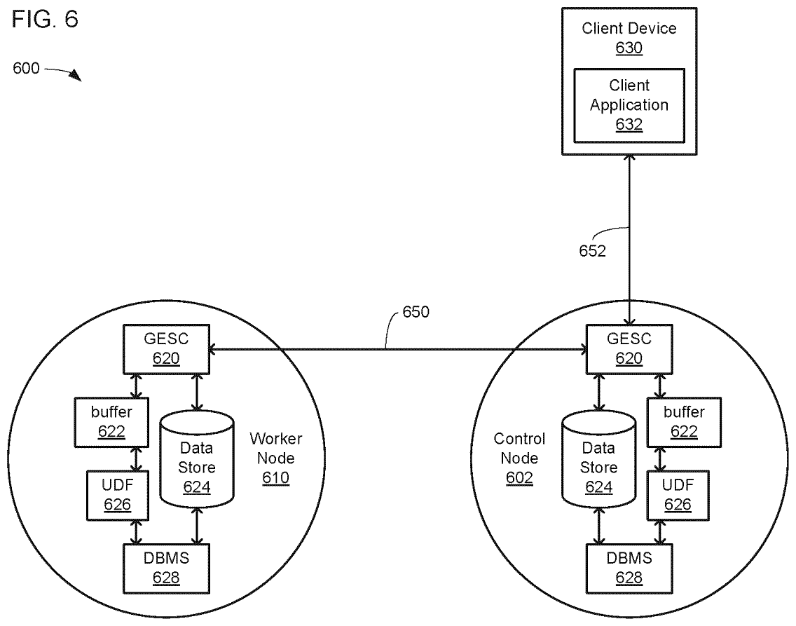

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However, in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a node 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

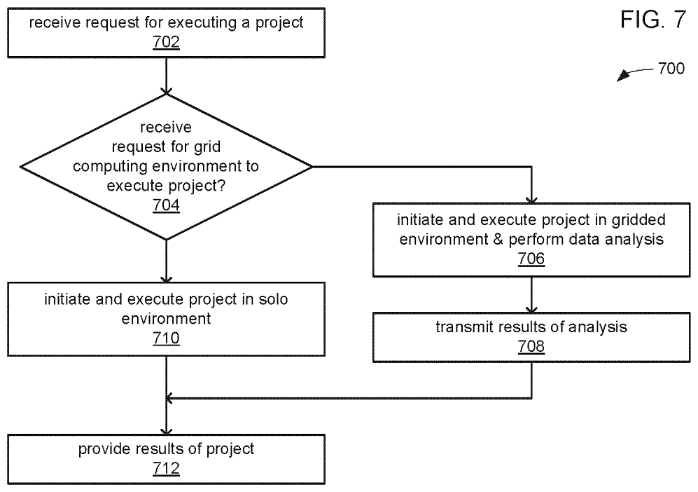

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

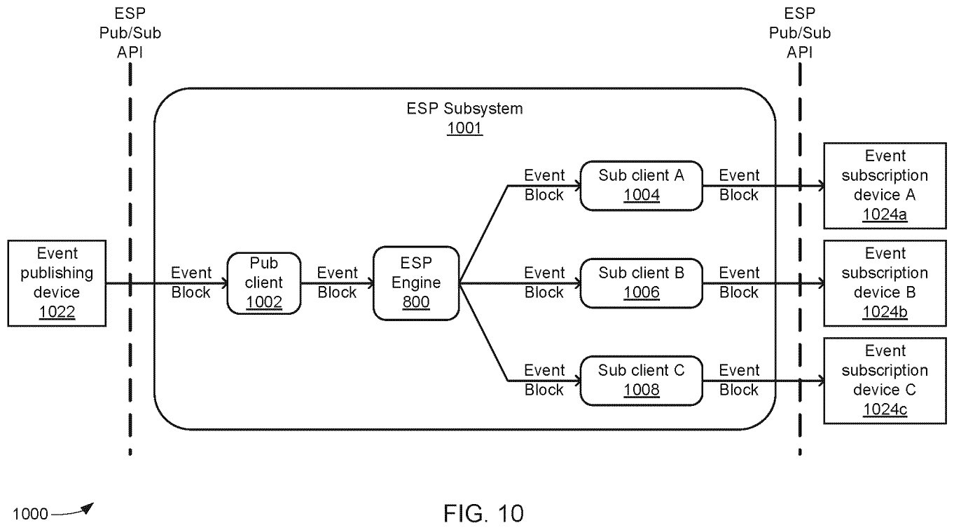

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Clients or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

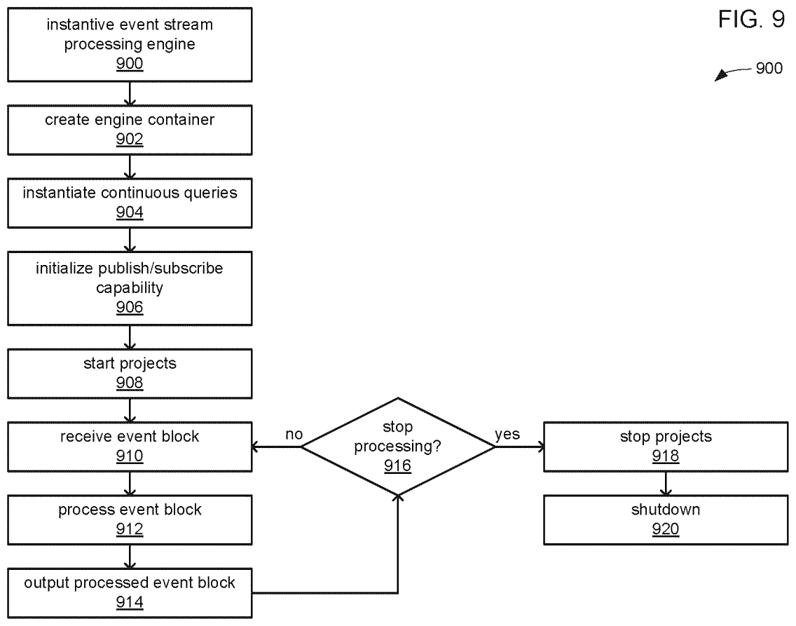

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing devices of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

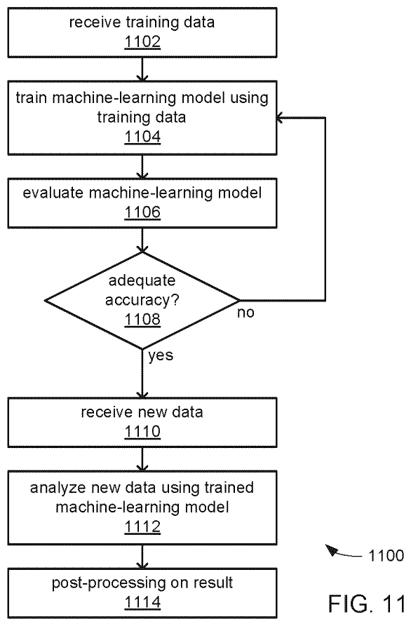

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS)R, SAS Viya R of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108. the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

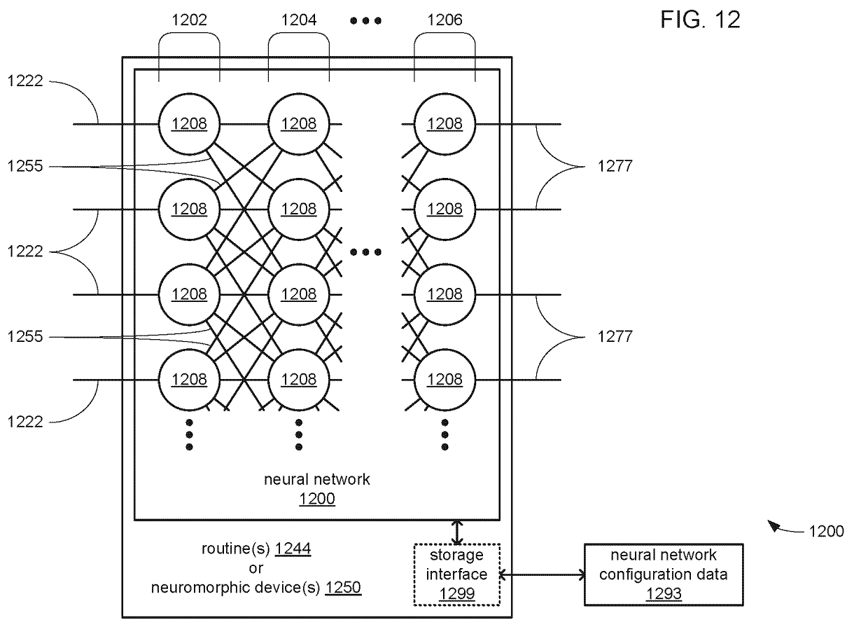

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a “forward” direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a “backward” direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer (“subsequent” in the sense of moving “forward”) of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y=max (x, 0) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively, or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide an energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide (GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

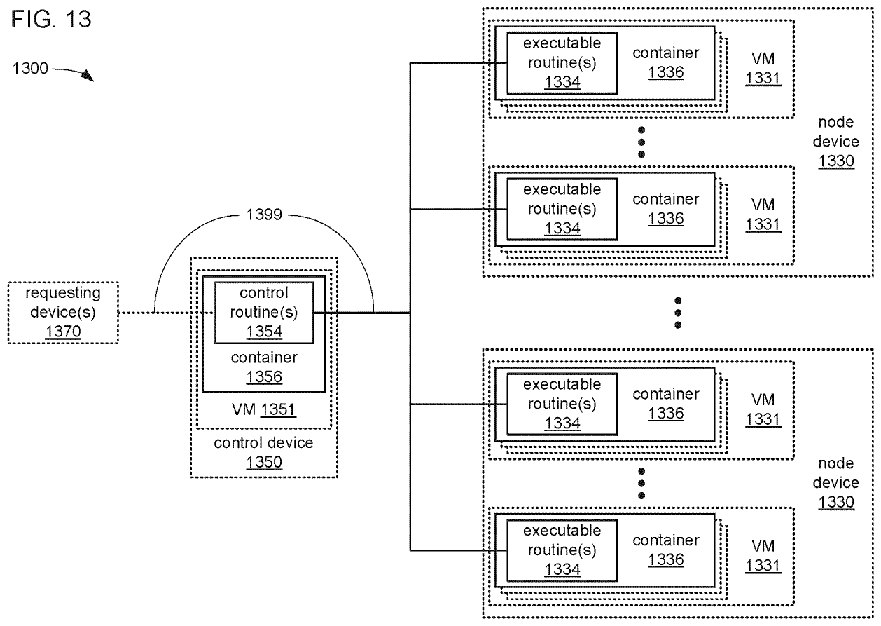

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively, or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively, or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to affect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies thereamong, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more “ACID transactions” that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending thereamong. Again, such a network as the depicted network 1399 may be based on any of a variety of wired and/or wireless technologies and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively, or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Could Native Computing Foundation of San Francisco, CA, USA. In such embodiments, containers 1336 in which executable routines 1334 of requested analyses may be instantiated within “pods” (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively, or additionally, such supporting routines may serve to provide access to one or more storage repositories (not specifically shown) in which at least data objects may be stored for use in performing the requested analyses.

### Associated Processes

Analytics may refer to a systematic process of examining data in order to derive characteristics associated with the data. For instance, analytics may be used to identify patterns, trends, anomalies, or predictive outcomes associated with a set of data. Analytics may be utilized in tasks such as anomaly detection (e.g., detection of a security breach or equipment failure), performance monitoring, or predictive decision making. Conventional techniques for performing analytics may treat data elements as independent observations. However, such techniques may fail to capture relationships within the data, which may limit the utility of such techniques in scenarios in which relational structure influences outcomes.

Network-based analytics may be employed to capture relationships within data. Network-based analytics may utilize one or more network analysis algorithms and/or network optimization algorithms to transform data into a network data structure comprising nodes and links between the nodes. Each node may correspond to an entity, event, state, or data element, whereas each link may represent an association, dependency, communication, temporal relationship, or other defined interaction between the nodes. By analyzing structural properties of the network data structure, network-based analytics may reveal relational patterns or emergent behaviors that are not observable when data elements are evaluated in isolation.

In some examples, network data structures generated via network analysis algorithms or network optimization algorithms may be produced as tabular datasets. Inspection of such tabular datasets may involve evaluating individual records or fields. However, inferring relational patterns or structural characteristics from inspection of individual records may become increasingly complex as network size or relationship density increases, thereby imposing cognitive and analytical burdens on users performing the inspection.

Visualization of network data structures may enable structural characteristics to be more readily perceived. Network visualization systems may render network data structures as interactive visual displays including graphical nodes and graphical links. Such systems may accept, as inputs, a nodes dataset representing graphical nodes and a links dataset representing graphical links. In some cases, network visualization systems may further involve specification of a layout algorithm, visualization parameters governing visual appearance, and rendering instructions that invoke the layout algorithm and apply the visualization parameters. Network visualization systems may support non-georeferenced graphs, in which node positions are determined through computational layout algorithms, as well as georeferenced graphs, in which node positions correspond to geographic coordinates displayed over an interactive map.

Conventional approaches to network visualization may involve substantial manual effort to transform analytical outputs into visualization-ready formats. For example, a particular network data structure may be represented using only a tabular nodes dataset or a tabular links dataset or may be otherwise formatted differently from datasets expected by a particular visualization system, thereby involving manual construction or reformatting of nodes datasets and links datasets. Additionally, use of network visualization systems may involve manual selection of layout algorithms and tuning of visualization parameters. Such preparation may vary depending on the class of network analysis or network optimization algorithm that produced the analytical output, resulting in algorithm-specific visualization workflows that limit reuse across analytical contexts.

Further, conventional network visualization tools may lack adaptability across heterogeneous network datasets. Visualization parameters that yield readable results for small or sparse networks may produce congestion or instability when applied to large or dense networks, while parameters selected for large networks may render small networks difficult to interpret. In addition, distinct configuration logic or invocation mechanisms may be utilized for different algorithm outputs or for georeferenced versus non-georeferenced graphs, thereby increasing configuration complexity and limiting reuse of visualization logic.

By contrast, the systems and methods described herein provide an automated framework for generating interactive network visualizations directly from one or more network datasets using a unified visualization procedure applicable across multiple network analysis and network optimization algorithm classes. In response to receiving a network visualization request, the system may automatically generate a computer-executable network visualization file that encapsulates visualization data objects, visualization parameters, and rendering instructions. The network visualization request may operate as an algorithm-agnostic interface through which heterogeneous network datasets are visualized using a single invocation mechanism, without algorithm-specific visualization workflows or manual parameter tuning.

Automatic generation of the computer-executable network visualization file may include construction of nodes visualization data objects and links visualization data objects, computation of network visualization parameters optimized for characteristics of the one or more network datasets, and embedding of network visualization rendering instructions within the file. The framework may support both non-georeferenced graphs and georeferenced graphs within a unified visualization pipeline. For non-georeferenced graphs, the system may automatically select layout algorithms and visualization parameters based on structural properties of the network datasets. For georeferenced graphs, the system may render graphical nodes and graphical links over an interactive geographic map using latitude and longitude coordinates while supporting map centering, zoom control, and multiple rendering styles.

Automatic computation of network visualization parameters may enable visualization behavior to adapt to variations in network size, relationship density, and network topology across different analytical scenarios. By encoding visualization logic and configuration into a portable computer-executable network visualization file generated in response to a single network visualization request, the framework may enable repeated visual exploration of network structures produced by different analytical scenarios without performing regeneration of visualization logic. Execution of the computer-executable network visualization file independently of the analytical environment in which the request was received may further facilitate sharing, reuse, and execution of network visualizations across different computing environments and user interfaces.

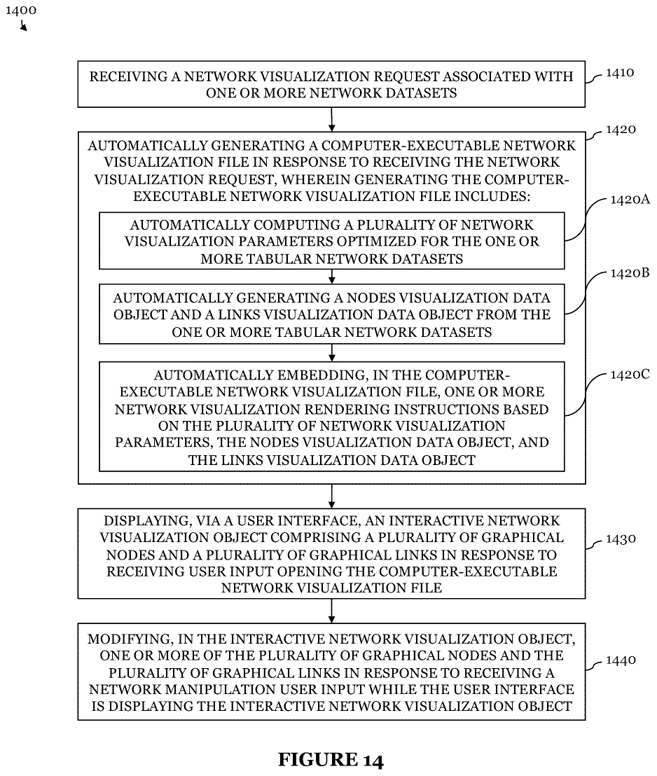

FIG. 14 illustrates one embodiment of method 1400. It shall be appreciated that other embodiments contemplated within the scope of the present disclosure may involve more processes, fewer processes, different processes, or a different order of processes than illustrated in FIG. 14. It should be noted that a computer-program product may include a non-transitory machine-readable storage medium storing computer instructions that, when executed by one or more operations, may perform operations corresponding to the processes and sub-processes of method 1400. Additionally, or alternatively, a computer-implemented method may include operations corresponding to processes and sub-processes of 1400. Additionally, or alternatively, a computer-implemented system may include one or more processors, a memory, and a computer-readable medium operably coupled to the one or more processors, the computer-readable medium having computer-readable instructions stored thereon that, when executed by the one or more processors, cause a computing device to perform operations corresponding to the processes and sub-processes of method 1400. It should be noted that process 1410 through 1440 may be implemented, at least in part, by processing circuitry. Processing circuitry may refer to one or more computing components configured to execute computer instructions associated with processes 1410 through 1440. Processing circuitry may include one or more processors, one or more processor cores, or one or more hardware logic units configured to perform functionalities associated with processes 1410 through 1440.

As shown in FIG. 14, process 1410 may include receiving (e.g., by processing circuitry) a network visualization request associated with one or more network datasets. Process 1410 may function to initiate automated generation of an interactive network visualization by providing structured input that identifies source data used by downstream processing stages (e.g., process 1420). Using a single network visualization request to generate an interactive network visualization for various types of networks (e.g., georeferenced networks, non-georeferenced networks, networks with a high proportion of nodes to edges, networks with a high proportion of edges to nodes) may provide a standardized means of interacting with the system described herein and may reduce user effort as compared to having separate types of network visualization requests for separate types of networks.

The term “network visualization request” may refer to a structured input received by a computing system that specifies parameters for generating an interactive network visualization file. The network visualization request may identify one or more network datasets to be visualized (e.g., a tabular links dataset or a tabular nodes dataset) and may further specify one or more visualization-related inputs that control how the one or more network datasets are processed, transformed, and rendered. In some examples, the network visualization request may be expressed as a single executable command issued within a programming environment and may include input arguments, such as a network type, attribute mappings for nodes and links, rendering preferences, and, when applicable (e.g., georeferenced networks), geographic configuration information.

The term “network dataset” may refer to a collection of data records that describe structural elements of a network to be visualized. The one or more network datasets may include a tabular nodes dataset, a tabular links dataset, or a combination of a tabular nodes dataset and a tabular links dataset. A tabular nodes dataset may include records representing nodes and may specify one or more node attributes, such as a node identifier attribute, a node label attribute, a node group attribute, a node value attribute, a node shape attribute, and a node color attribute. A tabular links dataset may include records representing links between nodes and may specify one or more link attributes, such as a link source attribute, a link destination attribute, a link weight attribute, a link label attribute, a link group attribute, and a link direction attribute. In some examples, the one or more network datasets may be generated as outputs of network analysis algorithms or network optimization algorithms and may represent network structures at varying scales, ranging from small networks with a limited number of nodes and links to large networks including thousands or millions of nodes and links.

Receiving the network visualization request during process 1410 may involve obtaining the network visualization request from a programming environment executing on a computing system. In some examples, the network visualization request may be received as an executable instruction issued within a code editor or interactive development environment and processed by processing circuitry configured to interpret input arguments supplied with the executable instruction. Receiving the network visualization request may further include parsing the input arguments to identify references to one or more associated network datasets, where such references may include, for instance, data structures, data locations, or data identifiers corresponding to tabular nodes datasets, tabular links datasets, or both.

In some examples, the network visualization request may be capable of addressing outputs produced by a wide range of network analysis algorithms and network optimization algorithms. A capability to address such outputs may enable a single visualization workflow to be reused for various types of algorithms without relying on algorithm-specific network visualization requests.

In some examples, the network visualization request may be configured to visualize one or more network datasets produced by a core decomposition network algorithm. A core decomposition network algorithm may refer to a network analysis algorithm that assigns nodes to nested subgraphs based on connectivity degree. Output of a core decomposition network algorithm may include a tabular nodes dataset in which each node record is annotated with a core identifier attribute indicating subgraph membership. Link relationships between nodes may be obtained from an associated links dataset, inferred from the tabular nodes dataset, or derived from the input network data, thereby enabling visualization.

In some examples, the network visualization request may be configured to visualize one or more network datasets produced by a connected components network algorithm. A connected components network algorithm may refer to a network analysis algorithm that identifies disjoint subsets of nodes in which each node is reachable from any other node within the same subset. Output of a connected components network algorithm may include a tabular nodes dataset with node records annotated with component identifiers. Link relationships between nodes may be obtained from an associated links dataset, inferred from the tabular nodes dataset, or derived from the input network data, thereby enabling visualization.

In some examples, the network visualization request may be configured to visualize one or more network datasets produced by a community detection network algorithm. A community detection network algorithm may refer to a network analysis algorithm that partitions a network into groups of nodes exhibiting relatively high internal connectivity. Output of a community detection network algorithm may include a tabular nodes dataset in which node records are annotated with community identifiers. Link relationships between nodes may be obtained from an associated links dataset, inferred from the tabular nodes dataset, or derived from the input network data, thereby enabling visualization.

In some examples, the network visualization request may be configured to visualize one or more network datasets produced by a reach network algorithm. A reach network algorithm may refer to a network analysis algorithm that determines nodes reachable from one or more starting nodes based on traversal constraints. Output of a reach network algorithm may include tabular nodes dataset indicating reachability status, a tabular links dataset representing traversal paths, or both.

In some examples, the network visualization request may be configured to visualize one or more network datasets produced by a pattern match network algorithm. A pattern match network algorithm may refer to a network analysis algorithm that identifies subgraphs matching a predefined structural pattern. Output of a pattern match network algorithm may include tabular datasets identifying nodes, links, or subgraph instances corresponding to matched patterns.

In some examples, the network visualization request may be configured to visualize one or more network datasets produced by a node similarity network algorithm. A node similarity network algorithm may refer to a network analysis algorithm that identifies relationships between nodes based on similarity metrics derived from attributes or structural properties. Output of a node similarity network algorithm may include a tabular links dataset represented as link records with associated similarity values. Nodes may be obtained from an associated nodes dataset, inferred from the tabular links dataset, or derived from the input network data, thereby enabling visualization.

In some examples, the network visualization request may be configured to visualize one or more network datasets produced by a cycle network algorithm. A cycle network algorithm may refer to a network analysis algorithm that identifies closed traversal paths within a network. Output of a cycle network algorithm may include a tabular nodes dataset indicating a node order or cycle identifiers. Link relationships between nodes may be obtained from an associated links dataset, inferred from the tabular nodes dataset, or derived from the input network data, thereby enabling visualization.

In some examples, the network visualization request may be configured to visualize one or more network datasets produced by a clique network algorithm. A clique network algorithm may refer to a network analysis algorithm that identifies fully connected subsets of nodes. Output of a clique network algorithm may include a tabular nodes dataset with nodes records annotated with clique identifiers. Link relationships representing pairwise connectivity within each clique may be obtained from an associated links dataset, inferred from the tabular nodes dataset, or derived from the input network data, thereby enabling visualization.

In some examples, the network visualization request may be configured to visualize one or more network datasets produced by a topological sort network algorithm. A topological sort network algorithm may refer to a network analysis algorithm that orders nodes according to directed dependency relationships. Output of a topological sort network algorithm may include a tabular nodes dataset in which node records are annotated with precedence order. Directed link relationships representing dependency constraints from an associated links dataset, inferred from the tabular nodes dataset, or derived from the input network data, thereby enabling visualization

In some examples, the network visualization request may be configured to visualize one or more network datasets produced by a shortest path network algorithm. A shortest path network algorithm may refer to a network optimization algorithm that identifies a minimum-cost traversal between nodes. Output of a shortest path network algorithm may include a tabular links dataset with link records corresponding to selected path segments. Nodes may be obtained from an associated nodes dataset, inferred from the tabular links dataset, or derived from the input network data, thereby enabling visualization.

In some examples, the network visualization request may be configured to visualize one or more network datasets produced by a vehicle routing network algorithm. A vehicle routing network algorithm may refer to a network optimization algorithm that determines routes for one or more vehicles subject to routing constraints. Output of a vehicle routing network algorithm may include tabular datasets representing ordered visitation sequences, vehicle identifiers, depots, and destinations. Such datasets may be interpreted to derive node and link representations, thereby enabling visualization.

In some examples, the system described herein may support automatic generation of a tabular links dataset from a tabular nodes dataset when the network visualization request is received in association with a tabular nodes dataset that is not empty while a corresponding tabular links dataset is empty. Automatic generation of a tabular links dataset in such scenarios may enable visualization processing to proceed using a tabular nodes dataset without explicit link construction by a user or an upstream process.

Automatic generation of a tabular links dataset from a tabular nodes dataset may include detecting that the tabular links dataset is empty at a time when the network visualization request is received. Detection that the tabular links dataset is empty may be performed by processing circuitry configured to inspect dataset references associated with the network visualization request and determine whether link-related records are available. Upon determining that the tabular links dataset is empty, processing circuitry may initiate generation of link records based on attributes present in the tabular nodes dataset.

In some examples, automatic generation of the tabular links dataset may be performed in response to a determination that the network type input argument corresponds to a clique network. Correspondence to a clique network may indicate that nodes sharing a common clique identifier attribute are intended to be fully interconnected. Automatic generation of the tabular links dataset for a clique network may include detecting a pair of nodes in the tabular nodes dataset that share a common clique identifier. For each detected pair of nodes, processing circuitry may insert a link record into the tabular links dataset that specifies a connection from a first node in the pair to a second node in the pair. Such insertion operations may be repeated for additional pairs of nodes sharing the same clique identifier, thereby producing a tabular links dataset that represents complete pairwise connectivity within each detected clique.

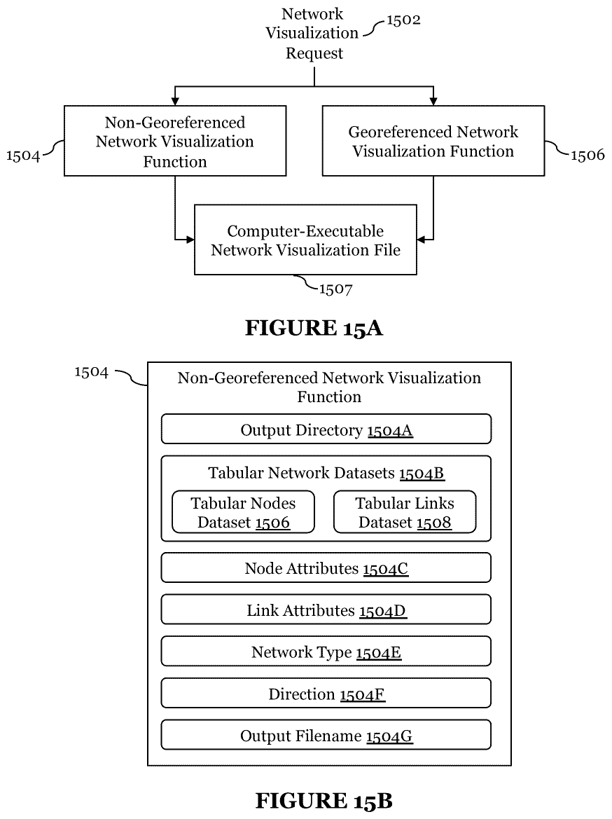

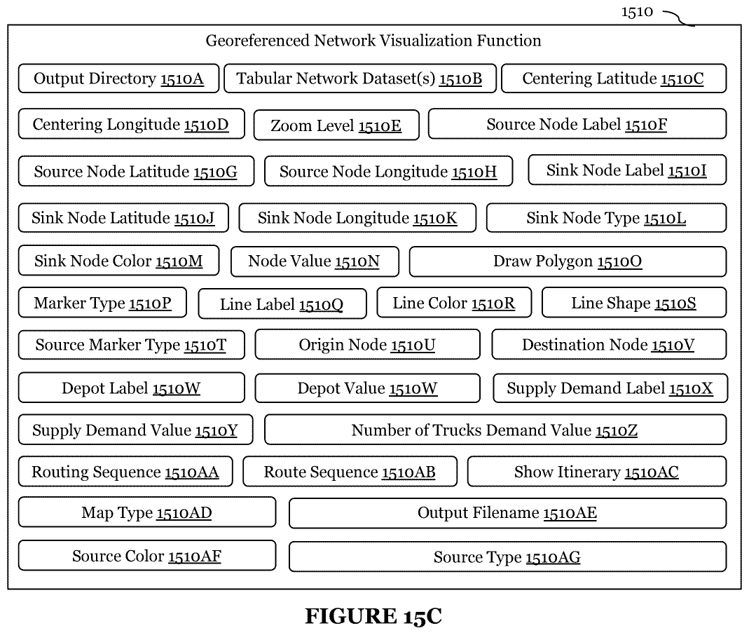

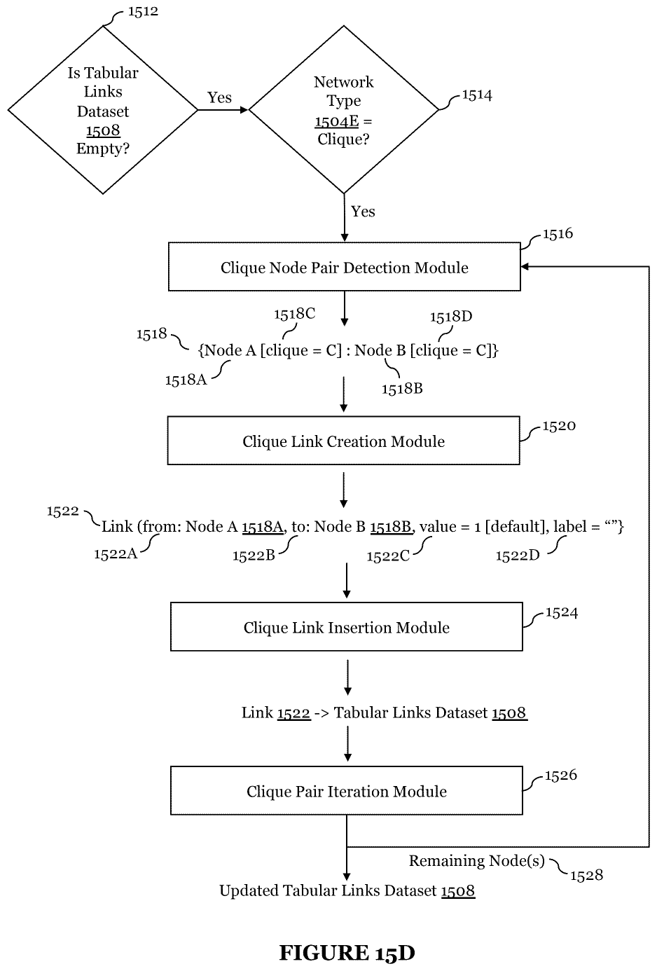

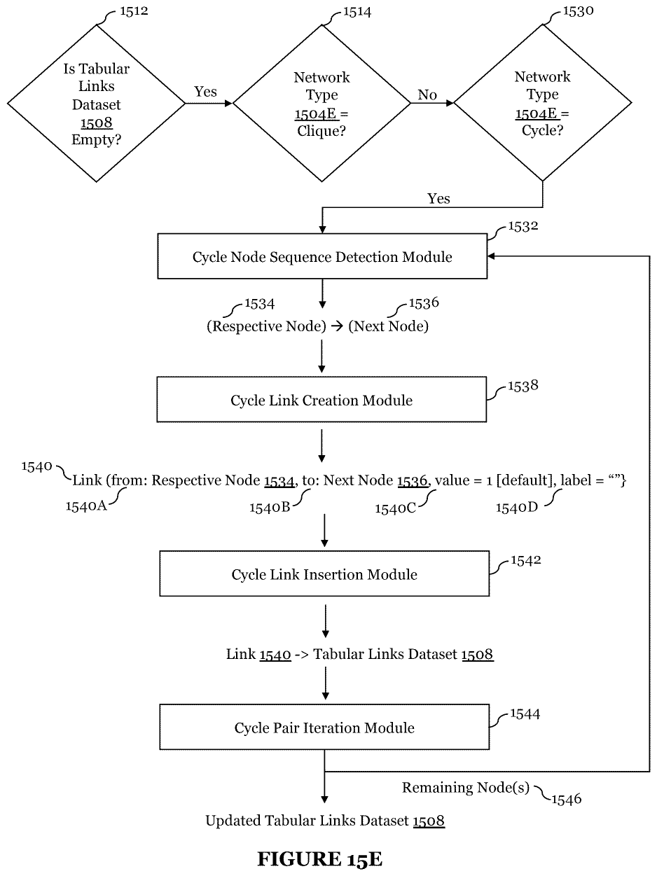

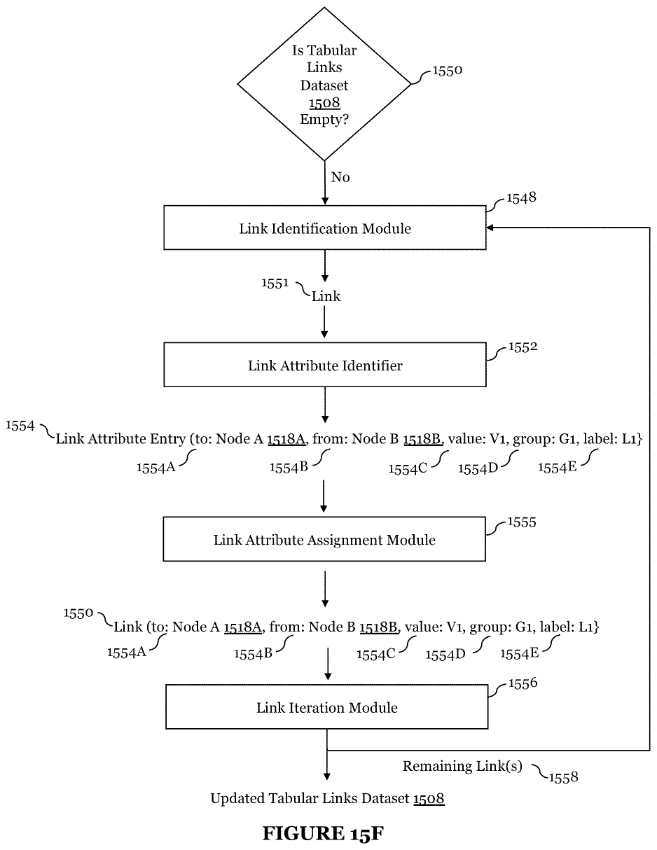

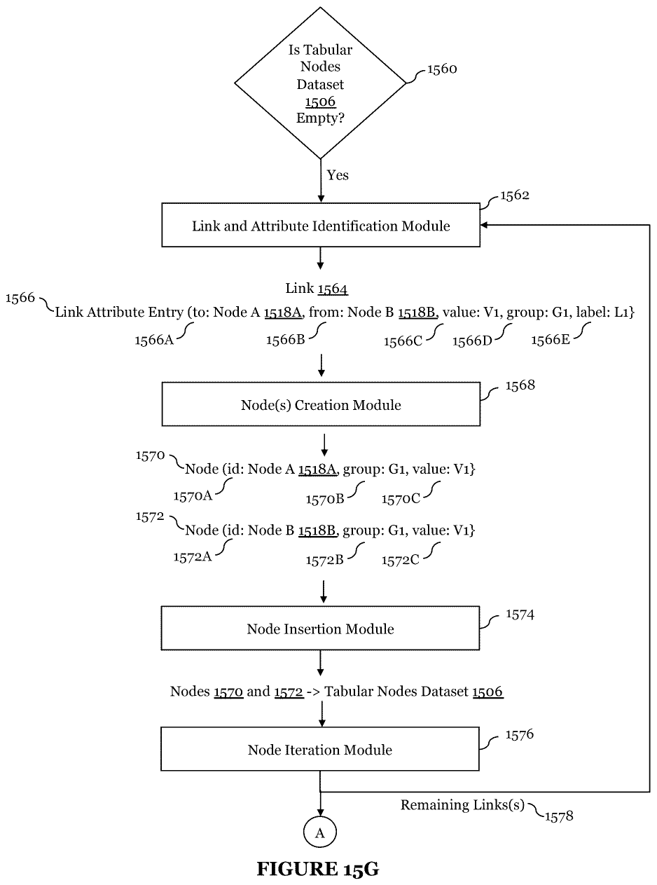

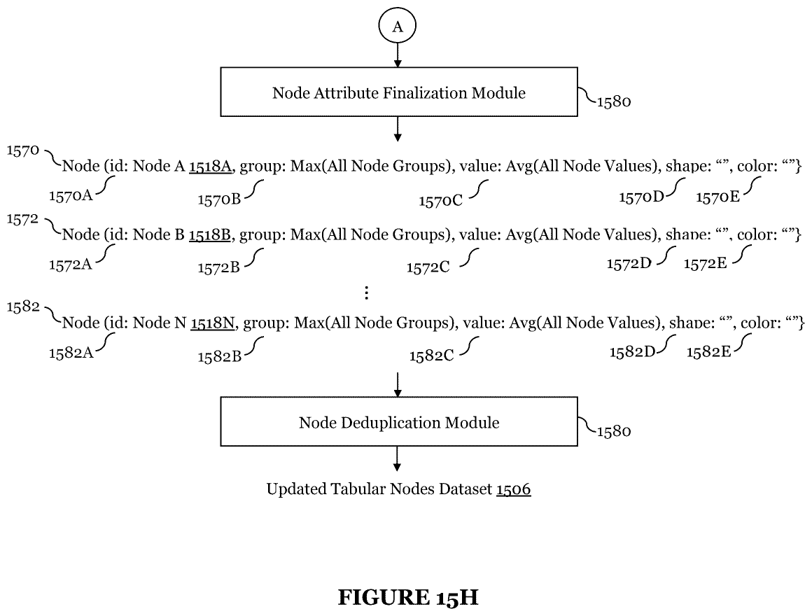

In a non-limiting example, as described with reference to FIG. 15D, processing circuitry may receive a tabular nodes dataset and may determine, at 1512, that a corresponding tabular links dataset 1508 is empty or does not exist and may proceed to 1514. At 1514, the processing circuitry may determine that the network type 1504E is a clique (e.g., based on a corresponding field in the network visualization request) and may provide the tabular nodes dataset to clique node pair detection module 1516. The clique node pair detection module 1516 may detect a clique node pair 1518 within the tabular nodes dataset. For instance, the clique node pair detection module may detect that node 1518A is associated with clique 1518C and node 1518B is associated with clique 1518D. Clique 1518C and 1518D may correspond to the same clique identifier and, accordingly, the clique node pair detection module may determine that nodes 1518A and 1518B are a clique node pair 1518 and may provide the clique node pair 1518 to clique link creation module 1520. Clique link creation module 1520 may create a link record 1522 that includes a first field 1522A for node 1518A, a second field 1522B for node 1518B, a third field 1522C for an associated value and a fourth field 1522D for a label. Clique link creation module 1520 may then provide the link record 1522 to clique link insertion module 1524. Clique link insertion module 1524 may insert the link record 1522 into the tabular links dataset 1508. After clique link insertion module 1524 inserts the link record 1522 into the tabular links dataset, clique pair iteration module 1526 may determine if there are any other remaining pairs of nodes 1528 to be checked. If so, clique node pair detection module 1516 may attempt to detect clique node pairs and the process may repeat. Otherwise, clique pair iteration module 1526 may output the non-empty tabular links dataset 1508 for use in visualization.

In other examples, automatic generation of the tabular links dataset may be performed in response to a determination that the network type input argument corresponds to a cycle network. Correspondence to a cycle network may indicate that nodes are intended to be connected in a closed sequence. Automatic generation of the tabular links dataset for a cycle network may include detecting, from the tabular nodes dataset, a respective node and a next node that follows the respective node according to an ordering defined within the tabular nodes dataset. Processing circuitry may insert a link record into the tabular links dataset that specifies a connection from the respective node to the next node. Such insertion operations may be repeated for remaining nodes in the tabular nodes dataset, thereby producing a tabular links dataset that represents a closed traversal path. Generation of the tabular links dataset in this manner may enable subsequent visualization stages to render cyclic structures that preserve ordering semantics and directional continuity derived from the tabular nodes dataset.

In a non-limiting example, as described with reference to FIG. 15E, processing circuitry may receive a tabular nodes dataset and may determine, at 1512, that a corresponding tabular links dataset 1508 is empty or does not exist and may proceed to 1514. At 1514, the processing circuitry may determine that the network type 1504E is not a clique network and may proceed to 1530. At 1530, the processing circuitry may determine that the network type 1504E is a cycle network (e.g., based on a corresponding field in the network visualization request) and may provide the tabular nodes dataset to a cycle node sequence detection module 1532. The cycle node sequence detection module 1532 may detect that a second node 1536 follows a first node 1534 in a cycle and may provide an indication of the first node 1534 and the second node 1536 to cycle link creation module 1538. Cycle link creation module 1538 may create a link record 1540 that includes a first field 1540A for first node 1534, a second field 1540B for second node 1536, a third field 1540C for an associated identifier, and a fourth field 1540D for a label. Cycle link creation module 1538 may then provide the link record 1540 to cycle link insertion module 1542. Cycle link insertion module 1542 may insert the link record 1540 into the tabular links dataset 1508. After cycle link insertion module 1542 inserts the link record 1522 into the tabular links dataset, cycle pair iteration module 1544 may determine if there are any other ordered node pairs to be checked. If so, the cycle pair iteration module may attempt to detect ordered node pairs for the remaining nodes 1546 and the process may repeat. Otherwise, cycle pair iteration module 1544 may output the non-empty tabular links dataset 1508 for use in visualization.

In some examples, the system described herein may support automatic assignment of link attributes based on link attribute input arguments when the network visualization request is received in association with a tabular links dataset that is not empty but lacks a complete set of link-related attributes used in visualization. Automatic assignment of link attributes in such scenarios may enable enrichment of link records using structured attribute mappings supplied with the network visualization request. Enrichment of link records through automated assignment may reduce manual intervention by eliminating used-configured prepopulating of visualization-specific attributes in analytical outputs.

Automatic assignment of link attributes may include identifying a respective link specified in the tabular links dataset after receipt of the network visualization request during process 1410. Identification of the respective link may include accessing a link record stored in memory and extracting a link identifier, a link source attribute, and a link destination attribute associated with the link record. Processing circuitry may then identify, from a link attributes input argument included in the network visualization request, a link attribute entry corresponding to the respective link. The link attributes input argument may include structured mappings that associate link identifiers or link positions with one or more link attributes.

Assignment of one or more link attributes to the respective link may include populating fields within the link record based on the identified link attribute entry. Such link attributes may include a link weight attribute, a link label attribute, a link group attribute, and/or a link direction attribute. Assignment operations may preserve attribute values explicitly provided in the link attributes input argument while maintaining default values for attributes that are not specified. Processing circuitry may repeat identification and assignment operations for each additional respective link specified in the tabular links dataset, thereby producing an enriched tabular links dataset in which link records are uniformly prepared for subsequent visualization parameter computation and rendering instruction generation.

In a non-limiting example, as described with reference to FIG. 15F, processing circuitry at 1550 may determine that tabular links dataset 1508 is not empty and may provide the tabular links dataset 1508 to link identification module 1548. The link identification module 1548 may identify a respective link record within the tabular links dataset 1508 and may provide the link to link attribute identifier 1552. The link attribute identifier 1552 may determine a link attribute entry 1554 associated with the link record 1551 and may provide the link record 1551 and the link attribute entry 1554 to link attribute assignment module 1555. The link attribute entry 1554 may include, for instance, a first field 1554A indicating an associated first node, a second field 1554B indicating an associated second node, a third field 1554C indicating a value, a fourth field 1554D indicating a group, and a fifth field indicating a label 1554E. Link attribute assignment module 1554 may insert the attributes within link attribute entry 1554 into link record 1551 and may provide an indication that the insertion was successfully performed to link iteration module 1556. Link iteration module 1556 may determine if there are any more link records within the tabular links dataset and may repeat the process with the remaining link records. Otherwise, link iteration module 1556 may output the updated tabular links dataset 1508.

In some examples, the system described herein may support automatic generation of a tabular nodes dataset from a tabular links dataset when the network visualization request is received in association with a tabular links dataset that is not empty while a corresponding tabular nodes dataset is absent. Automatic generation of a tabular nodes dataset in such scenarios may enable visualization processing to proceed without explicit node specification from a user or an upstream analytical process. Generation of node records directly from link records may reduce data redundancy by eliminating effort to separately maintain nodes datasets that duplicate information already present in link relationships.

Automatic generation of the tabular nodes dataset from the tabular links dataset may include detecting that the tabular nodes dataset is empty at a time when the network visualization request is received. Detection of an empty tabular nodes dataset may be performed by processing circuitry configured to inspect dataset references associated with the network visualization request. Upon determining that the tabular nodes dataset is empty and that the network visualization request includes a link attributes input argument, processing circuitry may initiate construction of node records derived from link-related information.

Generation of the tabular nodes dataset may include identifying a respective link in the tabular links dataset and identifying a corresponding link attribute entry associated with the respective link in the link attributes input argument. Based on the identified link and link attribute entry, processing circuitry may add a first node record to the tabular nodes dataset, where the first node corresponds to a source node associated with the respective link. The first node record may include one or more first node attributes derived from the link attribute entry, including attributes associated with grouping, value, color, or shape. Processing circuitry may further add a second node record to the tabular nodes dataset, where the second node corresponds to a destination node associated with the respective link and includes one or more second node attributes derived from the same link attribute entry.

The process of identifying links and adding corresponding source node records and destination node records may be repeated for remaining links specified in the tabular links dataset. After generation of node records corresponding to each link, processing circuitry may assign one or more additional node attributes to each node record added to the tabular nodes dataset, including default attributes where explicit attribute values are not available. Processing circuitry may further perform removal of duplicate node records by identifying node records that share a common node identifier attribute and retaining a single node record for each unique node identifier. Automatic generation of the tabular nodes dataset in this manner may produce a node representation that preserves semantic consistency with the tabular links dataset and enables subsequent visualization processing stages to operate on a complete network structure.

In a non-limiting example, as described with reference to FIGS. 15G and 15H, processing circuitry may, at 1560, receive a non-empty tabular links dataset 1508 and may determine that a tabular nodes dataset is empty or does not exist. Accordingly, the processing circuitry may provide the tabular links dataset 1508 to link and attribute identification module 1562. Link and attribute identification module 1562 may identify a link record 1564 and a corresponding link attribute entry 1566, where the link attribute entry may include, for instance, a first field 1566A corresponding to a first node 1518A, a second field 1566B corresponding to a second node 1518B, a third field 1566C corresponding to a value, a fourth field 1566D corresponding to a group, and a fifth entry 1566E corresponding to a label. Link and attribute identification module 1562 may then provide the link record 1564 and the link attribute entry 1566 to node(s) creation module 1568. Node(s) creation module 1568 may create a first node record 1570 for the first node 1518A in first field 1566A, where the first node record 1570 may have a first field 1570A identifying the first node 1518A, a second field 1570B indicating an associated group (e.g., derived from fourth field 1566D), and a third field 1570C identifying the value (e.g., derived from third field 1566C). Likewise, node(s) creation module 1568 may create a second node record 1572 for second node 1518B, where the second node record 1572 may include a first field 1572A identifying the second node 1518B, a second field 1572B indicating an associated group (e.g., derived from fourth field 1566D), and a third field 1572C identifying the value (e.g., derived from third field 1566C). The first node record 1570 and the second node record 1572 may be provided by the node(s) creation module 1568 to node insertion module 1574. Node insertion module 1574 may insert the new node records into the tabular nodes dataset 1506 and may indicate to node iteration module 1576 that the node records have been inserted. Node iteration module 1576 may determine if there are any more remaining links 1578 to check and if so, node iteration module 1576 may indicate to link and attribute identification module 1562 to repeat the process with one of the remaining links 1578. Otherwise, node insertion module 1576 may indicate to node attribute finalization module 1580 (e.g., as depicted in FIG. 15H), that all links have been checked.

Node attribute finalization module 1580 may update fields and add additional fields to each node record. For instance, node records 1570, 1572, and 1582 may have the second field 1570B, 1572B, and 1582B, respectively, updated to include a maximum of all node groups. Additionally, node records 1570, 1572, and 1582 may have the third field 1570C, 1572C, and 1582C updated to include an average of all node values. Further, node records 1570, 1572, and 1582 may be updated to include a shape field (e.g., 1570D, 1572D, and 1582D, respectively) and a color field (e.g., 1570E, 1572E, and 1582E, respectively). The updated tabular nodes dataset 1506 may be provided to node deduplication module 1580. Node deduplication module 1580 may remove any duplicate nodes from the tabular nodes dataset and may output the updated tabular nodes dataset 1506 without the duplicate nodes.

In some examples, the system described herein may support automatic assignment of node attributes when the network visualization request is received in association with a tabular nodes dataset that includes node records lacking one or more attributes utilized for visualization. Automatic assignment of node attributes in such scenarios may enable completion of node representations without users manually augmenting analytical outputs with visualization-specific properties.

Automatic assignment of node attributes may include identifying a respective node specified in the tabular nodes dataset after receipt of the network visualization request during process 1410. Identification of the respective node may include accessing a node record stored in memory and extracting a node identifier attribute associated with the node record. Processing circuitry may then identify, from a nodes attribute input argument included in the network visualization request, a node attribute entry corresponding to the respective node. The nodes attribute input argument may include structured mappings that associate node identifiers or node positions with one or more node attributes.

Assignment of one or more node attributes to the respective node may include populating fields within the node record based on the identified node attribute entry. Assigned node attributes may include a node label attribute, a node group attribute, a node value attribute, a node shape attribute, and a node color attribute. Assignment operations may preserve attribute values explicitly specified in the nodes attribute input argument while maintaining predefined default values for node attributes that are not specified. Processing circuitry may repeat identification and assignment operations for each additional respective node specified in the tabular nodes dataset, thereby producing an enriched tabular nodes dataset in which node records are uniformly prepared for subsequent visualization parameter computation, rendering instruction generation, and interactive visualization display.

In a non-limiting example, as described with reference to FIG. 15I, processing circuitry at 1583 may determine that a tabular nodes dataset 1506 is non-empty and may provide the tabular nodes dataset 1506 to node identification module 1584. Node identification module 1584 may identify a respective node record 1586 from the tabular nodes dataset 1506 and may provide the node record 1586 to node attribute identifier 1588. Node attribute identifier 1588 may identify an associated node attribute entry 1590 that includes a first field 1590A indicating a node identifier, a second field 1590B indicating a label for the node, a third field 1590C indicating a value for the node, a fourth field 1590D indicating a shape for the node, and a fifth field 1590E indicating a color for the node. Node attribute identifier 1588 may provide the node record 1586 and node attribute entry 1590 to node attribute assignment module 1592. Node attribute assignment module 1592 may insert the fields from the node attribute entry 1590 into the node record 1586 to create an updated node record 1596 with fields corresponding to the fields of the node attribute entry 1590 (e.g., fields 1594A, 1594B, 1594C, 1594D, and 1594E corresponding to fields 1590A, 1590B, 1590C, 1590D, and 1590E, respectively). Node attribute assignment module 1592 may then provide the updated node record 1594 to node iteration module 1596 which may ensure that the node record 1586 is replaced with the corresponding updated node record 1594. Node attribute assignment module 1594 may then determine if there are any remaining nodes 1598 to add attributes to and, if so, may indicate to node identification module 1584 to repeat the process with another node. Otherwise, node iteration module 1596 may output the updated tabular nodes dataset 1506.

In some examples, network visualization processing may include use of default values for attributes associated with nodes and links when such nodes or links are automatically generated during processing of a network visualization request. Use of default values may enable automatically generated records to participate in downstream visualization processing without introducing inconsistencies or gaps in attribute representation. Applying default values in this manner may preserve structural and visual coherence of the interactive network visualization object even when upstream network analysis outputs omit explicit attribute information.

In some examples, default values may be applied when explicit attribute values are not available in the one or more network datasets. Default values may include a predefined label, a predefined group value, a predefined color value, a predefined shape value, a predefined direction indicator, or a predefined numeric value. Selection of such default values may allow automatically generated nodes and links to be visually distinguishable while remaining consistent with existing visualization conventions.

As shown in the process flow, process 1420 may include automatically generating a network visualization file in response to receiving the network visualization request. Process 1420 may function to transform the one or more network datasets associated with the network visualization request into a portable, executable representation that encodes both network data and visualization behavior. Automatic generation of the network visualization file may enable downstream visualization without manual scripting, manual layout selection, or manual parameter tuning by a user.

The term “computer-executable network visualization file” may refer to a digital file that includes executable instructions configured to render an interactive network visualization object when opened by a compatible execution environment. The computer-executable network visualization file may include structured representations of nodes and links, configuration data specifying visualization parameters, and rendering instructions (e.g., expressed in an executable scripting language). In some examples, the computer-executable network visualization file may be formatted using HyperText Markup Language (HTTP) and may embed executable script content configured to invoke one or more visualization libraries when processed by a web-based execution engine. The computer-executable network visualization file may be configured to execute independently of the environment in which the network visualization request was received, thereby enabling portability across operating systems, devices, and user interfaces.

In some examples, automatic generation of the computer-executable network visualization file may depend on whether the one or more network datasets correspond to a non-georeferenced network or a georeferenced network. A non-georeferenced network may represent relationships between nodes without reference to geographic coordinates (e.g., such that positions of graphical nodes are determined through computational layout techniques). A georeferenced network may represent relationships between nodes that are associated with geographic locations (e.g., such that positions of graphical nodes correspond to latitude and longitude coordinates).

It should be noted that generation of the computer-executable network visualization file during process 1420 may decouple visualization logic from the analytical environment in which the one or more network datasets were produced. By encapsulating visualization data objects, visualization parameters, and rendering instructions within a standalone executable artifact, the system may enable the resulting network visualization to be executed, shared, and reused across heterogeneous computing environments independently of the analytical system that generated the network datasets.

As illustrated in FIG. 15A, a network visualization request 1502 may be configured to initiate generation of a computer-executable network visualization file through one of a plurality of specialized visualization pathways. In some examples, the network visualization request 1502 may include one or more attributes or parameters that indicate whether the request corresponds to a non-georeferenced network or a georeferenced network. In some examples, determination of whether the network visualization request 1502 corresponds to a non-georeferenced network or a georeferenced network may be based on characteristics of the one or more network datasets referenced by the network visualization request 1502 or may be explicitly indicated in the network visualization request 1502.

When the network visualization request corresponds to a non-georeferenced network, the network visualization function 1502 may invoke a non-georeferenced network visualization function 1504. The non-georeferenced network visualization function 1504 may be configured to generate visualization data objects, compute network visualization parameters, and embed network visualization rendering instructions suitable for physics-based or layout-based rendering of graphical nodes and graphical links.

When the network visualization request corresponds to a georeferenced network, the network visualization function 1502 may invoke a georeferenced network visualization function 1506. The georeferenced network visualization function 1506 may be configured to generate visualization data objects and rendering instructions suitable for map-based rendering in which graphical nodes are positioned according to geographic coordinates and graphical links are rendered as geographic paths.

Execution of either the non-georeferenced network visualization function 1504 or the georeferenced network visualization function 1506 may produce a computer-executable network visualization file 1507. The computer-executable network visualization file 1507 may encapsulate visualization data objects, configuration values, and executable rendering instructions corresponding to the selected visualization pathway. Generation of the computer-executable network visualization file 1507 in this manner may enable consistent execution of interactive network visualizations while allowing visualization behavior to vary according to whether the underlying network datasets are georeferenced or non-georeferenced.

As illustrated in FIG. 15B, the non-georeferenced network visualization function 1504 may receive a plurality of inputs that define how a computer-executable network visualization file is generated for a non-georeferenced network. In some examples, the plurality of inputs may include an output directory 1504A. The output directory 1504A may specify a storage location in which the computer-executable network visualization file is to be generated and stored. The plurality of inputs may further include tabular network datasets 1504B. The tabular network datasets 1504B may include one or more of a tabular nodes dataset 1506 and a tabular links dataset 1508. The tabular nodes dataset 1506 may include records that identify nodes of the non-georeferenced network and may specify attributes associated with each node. The tabular links dataset 1508 may include records that identify relationships between nodes and may specify attributes associated with each relationship.

In some examples, the plurality of inputs may include node attributes 1504C. The node attributes 1504C may specify which attributes from the tabular nodes dataset 1506 are to be used for visual encoding of graphical nodes. Node attributes 1504C may identify attributes used for labeling, grouping, sizing, coloring, or shaping graphical nodes within the interactive network visualization object. The plurality of inputs may further include link attributes 1504D. The link attributes 1504D may specify which attributes from the tabular links dataset 1508 are to be used for visual encoding of graphical links. Link attributes 1504D may identify attributes used for labeling, width scaling, color assignment, or direction rendering of graphical links.

In some examples, the plurality of inputs may include a network type 1504E. The network type 1504E may indicate a classification of the non-georeferenced network (e.g., which type of network algorithm was used to produce a network dataset). The network type 1504E may influence selection of layout algorithms, visualization parameters, and rendering behavior. The plurality of inputs may further include a direction 1504F. The direction 1504F may specify whether graphical links are rendered with directional indicators, such as arrows, and may define orientation of directionality between source nodes and destination nodes. The direction 1504F may be derived from attributes in the tabular links dataset 1508 or may be specified explicitly as part of the network visualization request. In some examples, the plurality of inputs may include output filenames 1504G. The output filenames 1504G may specify one or more filenames under which the computer-executable network visualization file is to be generated within the output directory 1504A.

As illustrated in FIG. 15C, a georeferenced network visualization function may receive a plurality of inputs that define how a computer-executable network visualization file is generated for a georeferenced network. In some examples, the plurality of inputs may include an output directory 1510A and an output filename 1510AE. The output directory 1510A may specify a storage location in which the computer-executable network visualization file is generated, and the output filename 1510AE may specify a name under which the generated file is stored. The plurality of inputs may further include tabular network dataset(s) 1510B, which may include one or more of the tabular nodes dataset 1506 and the tabular links dataset 1508.

In some examples, the plurality of inputs may include map view configuration parameters, including a centering latitude 1510C, a centering longitude 1510D, and a zoom level 1510E. The centering latitude 1510C and the centering longitude 1510D may define an initial geographic center for rendering the interactive geographic map, and the zoom level 1510E may define an initial scale at which geographic features, graphical nodes, and graphical links are displayed.

The plurality of inputs may further include source node configuration parameters, including a source node label 1510F, a source node latitude 1510G, a source node longitude 1510H, a source color 1510AF, and a source type 1510AG. The source node configuration parameters may define how a source graphical node is positioned and visually encoded within the interactive geographic map. In some examples, the plurality of inputs may include sink node configuration parameters, including a sink node label 1510I, a sink node latitude 1510J, a sink node longitude 1510K, a sink node type 1510L, and a sink node color 1510M. The sink node configuration parameters may define how a destination or terminal graphical node is positioned and visually encoded within the interactive geographic map.

The plurality of inputs may further include quantitative and semantic node attributes, including a node value 1510N, a depot label 1510W, a depot value 1510AH, a supply demand label 1510X, a supply demand value 1510Y, and a number of trucks demand value 1510Z. These inputs may be used to control visual scaling, labeling, or conditional rendering behavior for graphical nodes associated with logistics, routing, or supply chain scenarios.

In some examples, the plurality of inputs may include routing and sequencing parameters, including a routing sequence 1510AA, a route sequence 1510AB, and a show itinerary 1510AC indicator. The routing sequence 1510AA and the route sequence 1510AB may define an ordered traversal of nodes or links to be visualized, and the show itinerary 1510AC indicator may control whether stepwise route information is displayed within the interactive geographic map. The plurality of inputs may further include graphical link rendering parameters, including a line label 1510Q, a line color 1510R, and a line shape 1510S. These inputs may define how graphical links are rendered as polylines on the interactive geographic map and how link-related information is visually encoded.

In some examples, the plurality of inputs may include marker and geometry configuration parameters, including a marker type 1510P, a source marker type 1510T, a draw polygon 15100 indicator, and a map type 1510AD. The marker type 1510P and the source marker type 1510T may define whether graphical nodes are rendered as icons, circles, or other marker styles. The draw polygon 15100 indicator may control whether geographic regions or boundaries are rendered as polygonal overlays. The map type 1510AD may specify a base map or rendering mode used during georeferenced visualization.

In some examples, the plurality of inputs may further include origin and destination identifiers, including an origin node 1510U and a destination node 1510V. The origin node 1510U and the destination node 1510V may identify endpoints of a route or flow to be emphasized within the interactive geographic map.

As part of automatically generating the computer-executable network visualization file, sub-process 1420A may include automatically generating a nodes visualization data object and a links visualization data object from the one or more network datasets. Sub-process 1420A may function to convert network datasets into data objects suitable for use by network visualization rendering instructions. Automatic generation of the nodes visualization data object and the links visualization data object may enable separation between analytical data representations (e.g., network datasets) and visualization-specific representations (e.g., visualization data objects), thereby allowing downstream visualization logic to operate on standardized data objects regardless of the original structure or source of the one or more network datasets.

A nodes visualization data object may refer to a structured executable representation that encodes a collection of node visualization objects corresponding to nodes defined in the one or more network datasets. Each node visualization object may include one or more node attributes derived from the one or more network datasets, including a node identifier attribute, a node label attribute, a node group attribute, a node value attribute, a node shape attribute, and a node color attribute. The nodes visualization data object may be formatted as an executable array structure that can be interpreted by network visualization rendering instructions to generate a plurality of graphical nodes within an interactive network visualization object.

Generation of the nodes visualization data object may include identifying a respective node in the one or more network datasets. Identifying the respective node may include reading a node record from the tabular nodes dataset and extracting one or more node attributes associated with the node (e.g., a node identifier attribute, a node label attribute, a node group value, a node value attribute, a node shape attribute, and a node color attribute).

If the processing circuitry determines that the respective node is at an initial index within the tabular nodes dataset, the processing circuitry may add a first string of text to the nodes visualization data object. The first string of text may initialize an array of node visualization objects and may include a first node visualization object corresponding to the respective node. The first node visualization object may encode one or more attributes of the respective node in a structured form suitable for direct consumption by network visualization rendering instructions.

If the processing circuitry determines that the respective node is not at the initial index, the processing circuitry may append a second string of text to the nodes visualization data object. The second string of text may include a node visualization object corresponding to the respective node and may be appended in a manner that preserves syntactic separation between node visualization objects within the array. Appending node visualization objects in this manner may allow the nodes visualization data object to grow incrementally as additional node records are processed.

The processing circuitry may repeat identification of a respective node and addition or appending of corresponding strings of text for each additional respective node in the one or more network datasets. Each repetition may result in inclusion of an additional node visualization object within the array, with each node visualization object encoding attributes of a different node from the tabular nodes dataset.

After the processing circuitry completes processing of all respective nodes in the one or more network datasets, the processing circuitry may add a final string of text to the nodes visualization data object that syntactically closes the array of node visualization objects. Addition of the final string of text may indicate completion of the nodes visualization data object and may result in a structured executable representation that includes a complete collection of node visualization objects corresponding to the one or more network datasets.

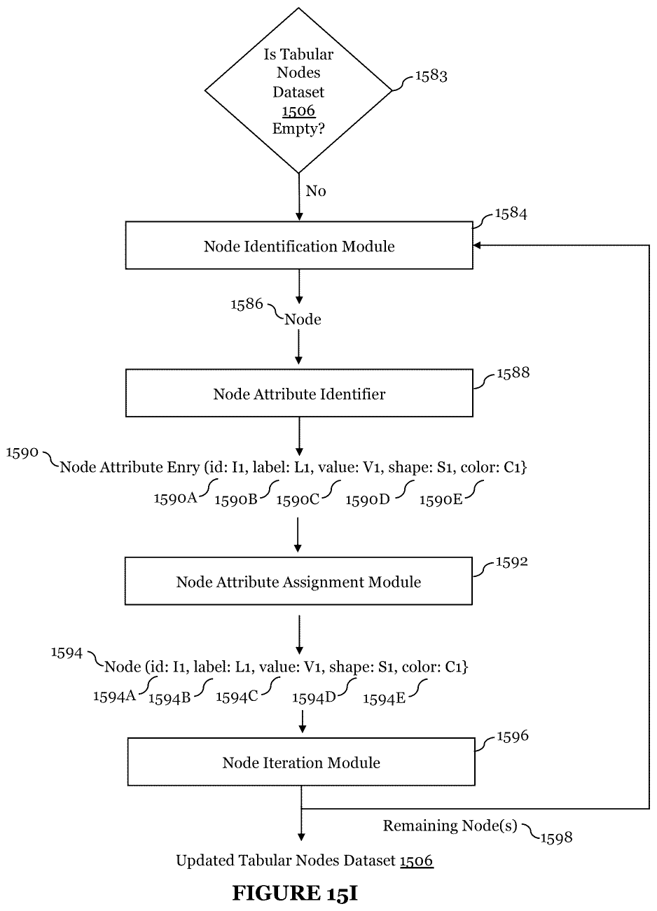

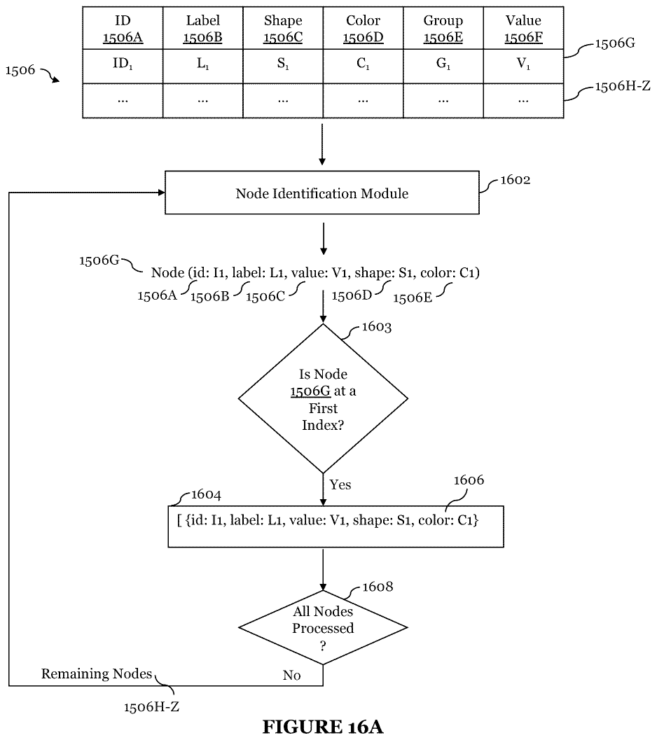

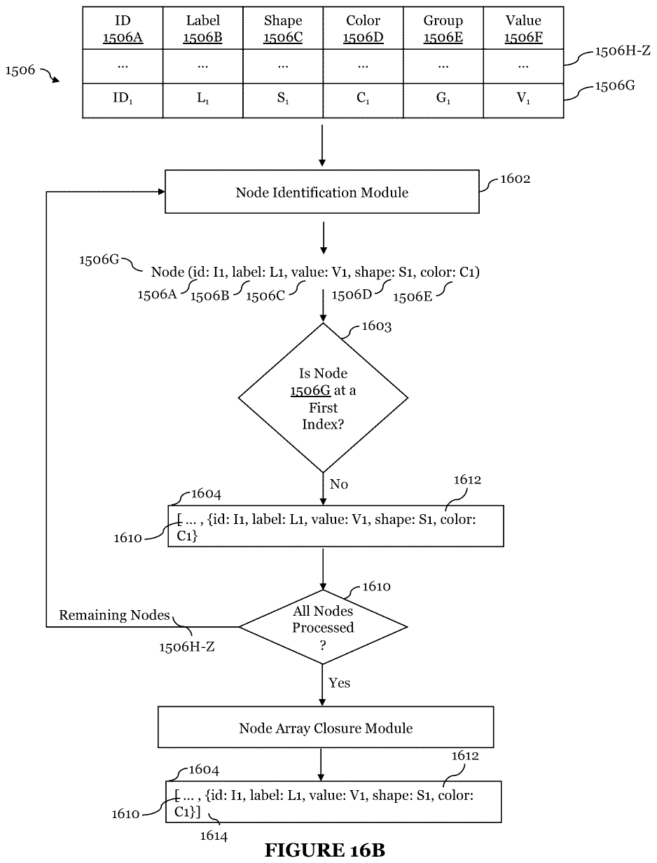

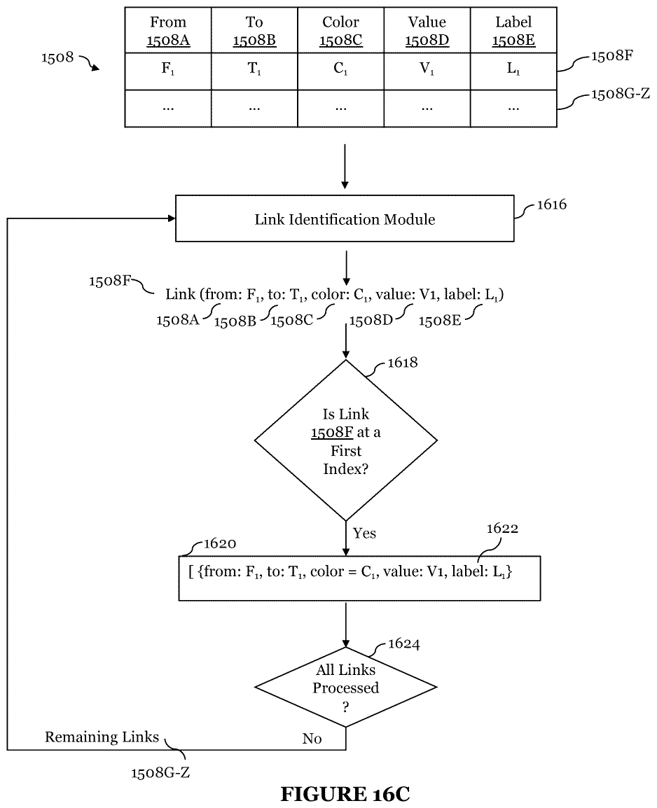

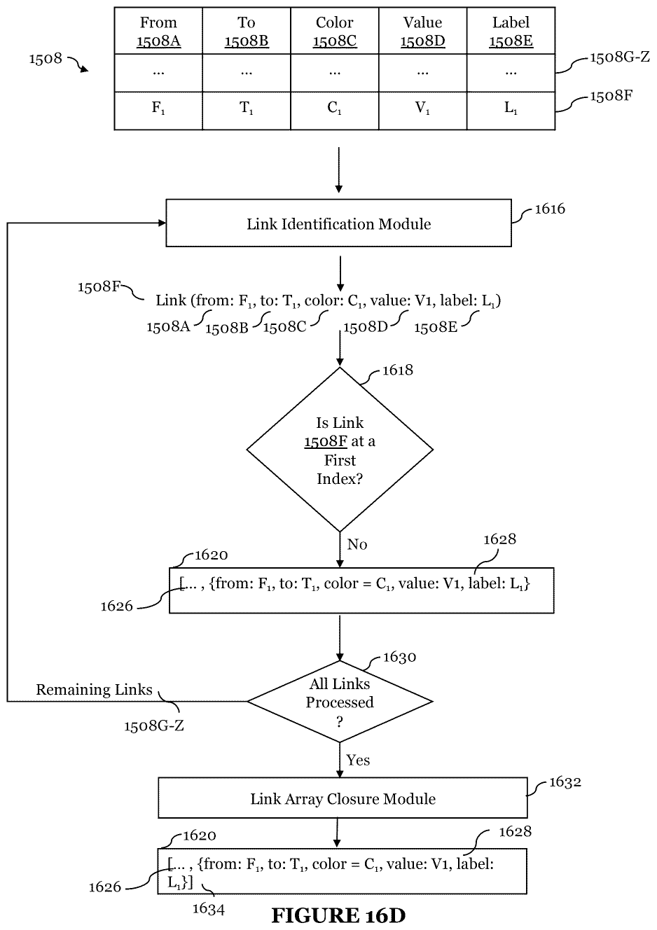

FIG. 16A may depict a first non-limiting example in which an identified node record 1506G is at a first, initial index within the tabular node dataset 1506. In this example, when constructing the nodes visualization data object 1604, node identification module 1602 may receive the tabular nodes dataset 1506 and may identify the node record with the first, initial index (e.g., node record 1506G). Node record 1506G may have associated fields (e.g., fields 1506A, 1506B, 1506C, 1506D, and 1506E). Node identification module 1602 may identify, at 1603, that node record 1506G is associated with the first, initial index and may generate, to add to the nodes visualization data object 1604, a first string of text that initializes an array of node objects and includes a first node visualization object 1606 including one or more attributes of the node associated with node record 1506G. Node identification module 1602 may then determine, at 1608, that there are additional nodes to process (e.g., the ones in node records 1506H through 1506Z) and may accordingly continue processing these node records by appending a respective string of text corresponding to a respective nodes visualization object for each node record.

FIG. 16B may depict a second non-limiting example in which an identified node record 1506G is at a last, final index within the tabular node dataset 1506. In this example, when constructing the nodes visualization data object 1604, the node identification module may receive the tabular nodes dataset 1506 and may identify the node record with the first, initial index (e.g., node record 1506H). Node identification module 1602 may generate, to add to a nodes visualization data object 1604, a first string of text for the array of node objects (e.g., in a similar manner as described for FIG. 16A) and may add a node visualization object for node record 1506H. Then node identification module 1602 may proceed with adding visualization objects for node records 1506I through 1506Z. When node identification module 1602 gets to node record 1506G, node identification module 1602 may add a node visualization object 1612 for node record 1506G to the nodes visualization data object 1604. The node identification module 1602 may then determine, at 1608, that all nodes have been processed, and may provide the nodes visualization data object 1604 to a node array closure module. The node array closure module may add, to the nodes visualization data object 1604, a final string of text 1614 that syntactically closes the array of node objects.

A links visualization data object may refer to a structured executable representation that encodes a collection of link visualization objects corresponding to links defined in the one or more network datasets. Each link visualization object may include one or more link attributes derived from the one or more network datasets, including a link source attribute, a link destination attribute, a link weight attribute, a link label attribute, a link group attribute, and a link direction attribute. The links visualization data object may be formatted as an executable array structure that can be interpreted by network visualization rendering instructions to generate a plurality of graphical links connecting graphical nodes within the interactive network visualization object.

Generation of the links visualization data object may include identifying a respective link in the one or more network datasets. Identifying the respective link may include reading a link record from the tabular links dataset and extracting one or more link attributes associated with the link, including a link source attribute, a link destination attribute, a link weight attribute, a link label attribute, a link group attribute, and a link direction attribute.

If the processing circuitry determines that the respective link is at an initial index within the tabular links dataset, the processing circuitry may add a first string of text to the links visualization data object. The first string of text may initialize an array of link visualization objects and may include a first link visualization object corresponding to the respective link. The first link visualization object may encode one or more attributes of the respective link in a structured form suitable for direct consumption by network visualization rendering instructions.

If the processing circuitry determines that the respective link is not at the initial index, the processing circuitry may append a second string of text to the links visualization data object. The second string of text may include a link visualization object corresponding to the respective link and may be appended in a manner that preserves syntactic separation between link visualization objects within the array. Appending link visualization objects in this manner may allow the links visualization data object to grow incrementally as additional link records are processed.

The processing circuitry may repeat identification of a respective link and addition or appending of corresponding strings of text for each additional respective link in the one or more network datasets. Each repetition may result in inclusion of an additional link visualization object within the array, with each link visualization object encoding attributes of a different link from the tabular links dataset.

After the processing circuitry completes processing of all respective links in the one or more network datasets, the processing circuitry may add a final string of text to the links visualization data object that syntactically closes the array of link visualization objects. Addition of the final string of text may indicate completion of the links visualization data object and may result in a structured executable representation that includes a complete collection of link visualization objects corresponding to the one or more network datasets.

FIG. 16C may depict a first non-limiting example in which an identified link record 1508F is at a first, initial index within the tabular links dataset 1508. In this example, when constructing the links visualization data object 1620, links identification module 1616 may receive the tabular links dataset 1508 and may identify the link record at the first, initial index (e.g., link record 1508F). Link record 1508F may have associated fields (e.g., fields 1508A, 1508B, 1508C, 1508D, and 1508E). Link identification module 16016 may identify, at 1618, that link record 1508F is associated with the first, initial index and may generate, to add to the links visualization data object 1620, a first string of text that initializes an array of link objects and includes a first link visualization object 1622 including one or more attributes of the link associated with link record 1508F. Link identification module 1616 may then determine, at 1624, that there are additional links to process (e.g., the ones in link records 1508G through 1508Z) and may accordingly continue processing these link records by appending a respective string of text corresponding to a respective links visualization object for each link record.

FIG. 16D may depict a second non-limiting example in which an identified link record 1508F is at a last, final index within the tabular links dataset 1508. In this example, when constructing the links visualization data object 1620, link identification module 1616 may receive the tabular links dataset 1508 and may identify the link record with the first, initial index (e.g., link record 1508G). Link identification module 1616 may generate, to add to a links visualization data object 1620, a first string 1626 of text for the array of node objects (e.g., in a similar manner as described for FIG. 16C) and may add a link visualization object for link record 1508G. Then link identification module 1620 may proceed with adding visualization objects for link records 1508H through 1508Z. When link identification module 1616 gets to link record 1508F, link identification module 1620 may add a link visualization object 1628 for link record 1508F to the links visualization data object 1620. The link identification module 1616 may then determine, at 1630, that all links have been processed, and may provide the links visualization data object 1620 to a link array closure module 1632. The link array closure module 1632 may add, to the links visualization data object 1632, a final string of text 1634 that syntactically closes the array of link objects.

As part of automatically generating the computer-executable network visualization file, sub-process 1420B may include automatically computing a plurality of network visualization parameters optimized for the one or more network datasets. Sub-process 1420B may function to derive configuration values that govern layout behavior, visual scaling, and interactive dynamics of an interactive network visualization object based on structural characteristics of the one or more network datasets. Automatic computation of the plurality of network visualization parameters may enable visualization behavior to adapt to variations in network size, density, and topology without manual parameter selection being performed. Computation of network visualization parameters at sub-process 1420B may further enable consistent rendering behavior across networks of different scales by applying systematic parameter derivation logic that responds to measurable properties of the one or more network datasets.

The term “network visualization parameters” may refer to a collection of configuration values that control how graphical nodes and graphical links are rendered, positioned, and updated within an interactive network visualization object. The plurality of network visualization parameters may include parameters that govern node size, node spacing, node font size, link width, link length, link font size, grouping behavior, layout algorithm selection, centering behavior, motion behavior, stiffness behavior, and iteration behavior. Each network visualization parameter may be expressed as a numeric value or a structured value that is consumed by network visualization rendering instructions to influence layout calculations, visual encoding, and interactive response during visualization execution.

Network visualization parameters being optimized for one or more network datasets may refer to parameter values being derived based on quantitative characteristics of the one or more network datasets rather than being statically defined. Optimization for the one or more network datasets may include computing parameter values as functions of a total number of nodes, a total number of links, or ratios derived from node counts and link counts. Such optimization may enable visualization behavior to remain readable and stable as network scale increases by adjusting spacing, sizing, and force-related parameters in proportion to observed network complexity. Automatic computation of the plurality of network visualization parameters may include evaluating dataset metrics at runtime and applying predefined mathematical relationships to generate parameter values without user intervention.

It should be noted that automatic computation of network visualization parameters may ensure that visualization behavior remains stable and interpretable across networks having widely varying structural characteristics. Visualization parameters that are statically defined or tuned for a particular network size, topology, or algorithm output may fail to produce consistent or readable visualizations when applied to networks outside the conditions for which those parameters were selected. Accordingly, derivation of visualization parameters based on measured properties of the one or more network datasets may enable a single visualization procedure to be reused across diverse analytical scenarios without manual parameter selection or algorithm-specific configuration.

In some examples, automatic computation of network visualization parameters may be performed using quantitative relationships derived from structural properties of a graph. For instance, a graph may be represented as G=(N, E), where N corresponds to a set of nodes and E corresponds to a set of links defining relationships between nodes. Structural properties of the graph may include a total number of nodes |N|, a total number of links |E|, and relationships between the node and link count.

In some examples, a respective network visualization parameter P included in the plurality of network visualization parameters may be computed using a function expressed as P=c+m×ƒ(G), where c corresponds to a constant offset value, m corresponds to a multiplier value, and ƒ(G) corresponds to a function derived from one or more structural properties of the graph G. The constant offset value and the multiplier value may be selected heuristically to control sensitivity of the parameter to changes in graph structure.

In some examples, the function ƒ (G) may include one or more logarithmic terms derived from the total number of nodes |N| and the total number of links |E |. For instance, ƒ(G) may include expressions involving log (|N|), log (|E|), ratios of logarithmic terms, or products of logarithmic terms. Use of logarithmic relationships may moderate growth of parameter values as network size increases, thereby allowing visualization behavior to scale smoothly across graphs with widely varying numbers of nodes and links. In some examples, the function may be adapted to compute different classes of parameters. Each parameter may be computed using a respective instance of the function with different constants, multipliers, and graph-derived functions.

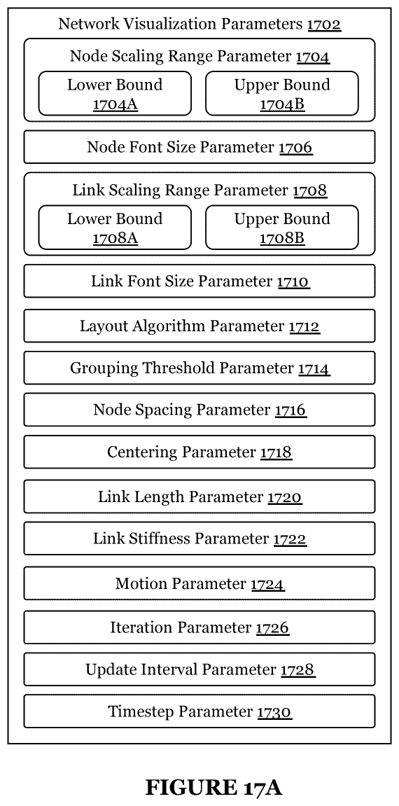

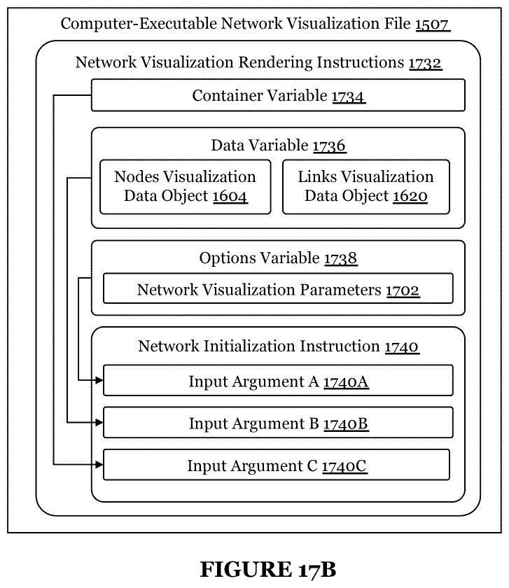

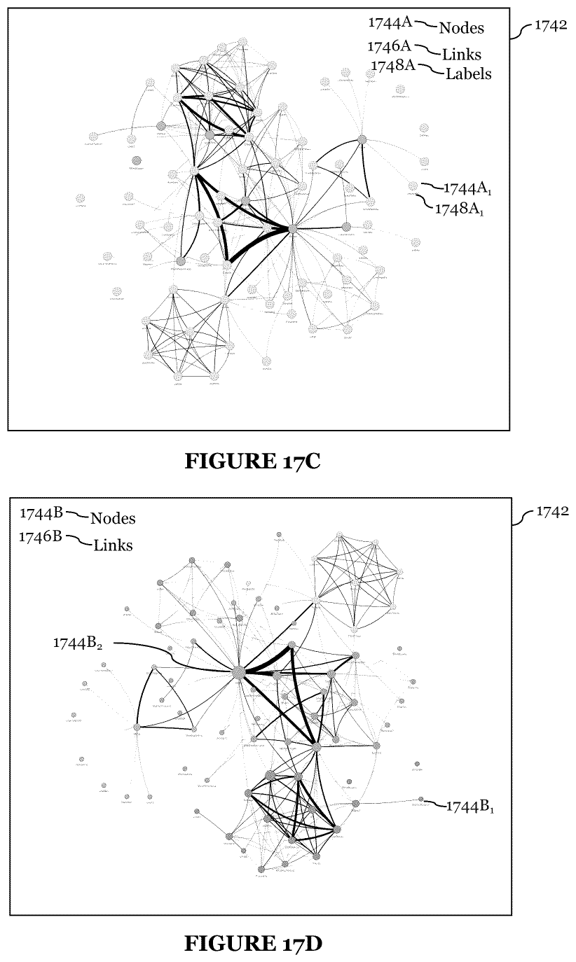

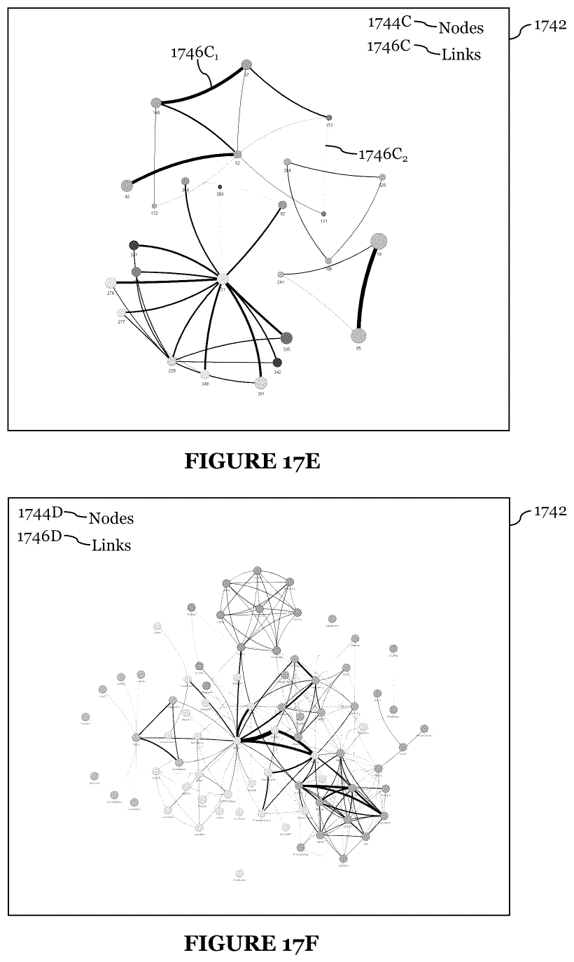

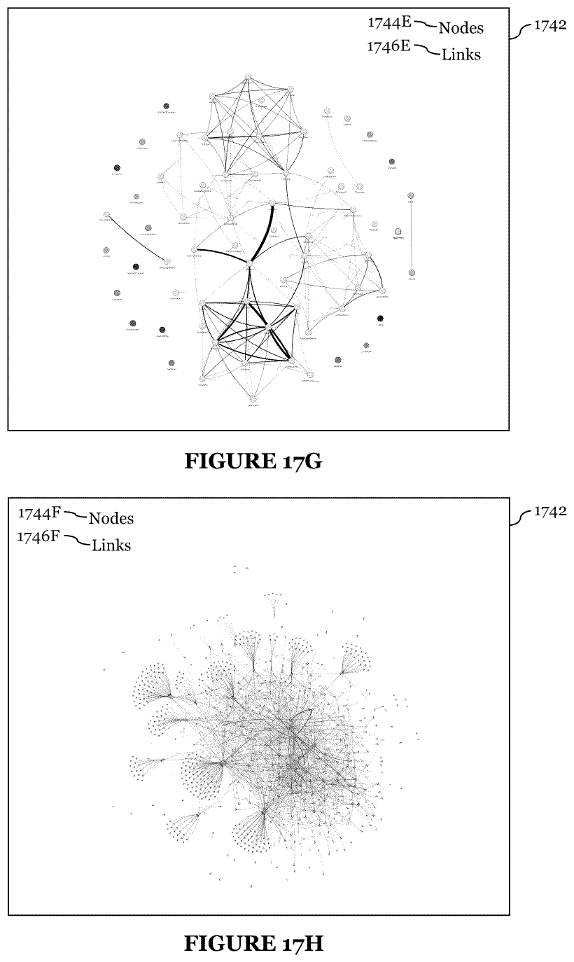

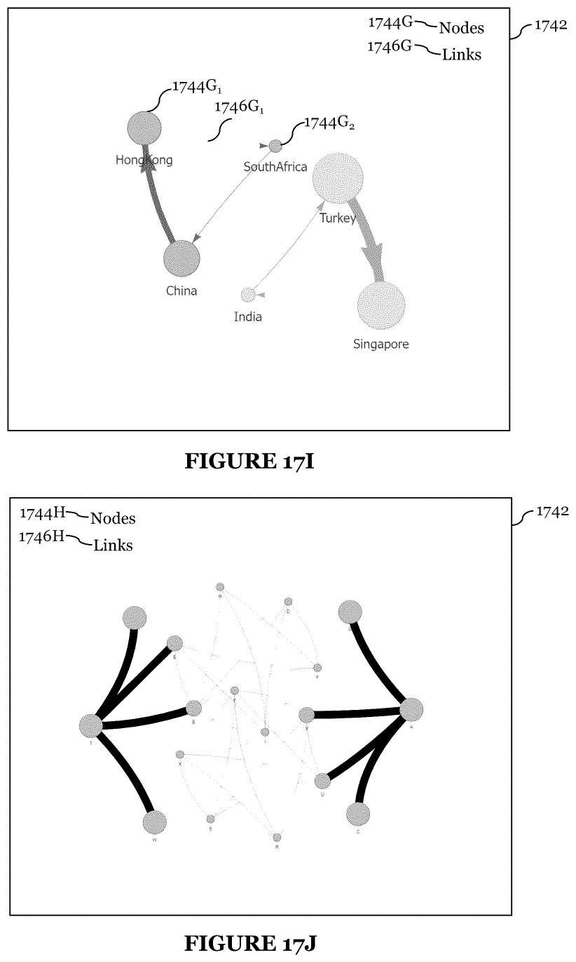

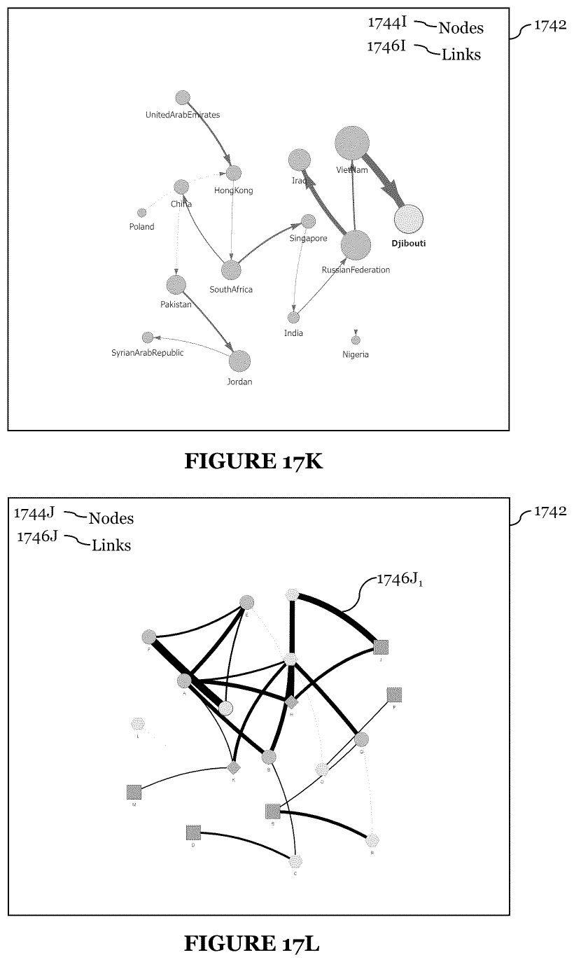

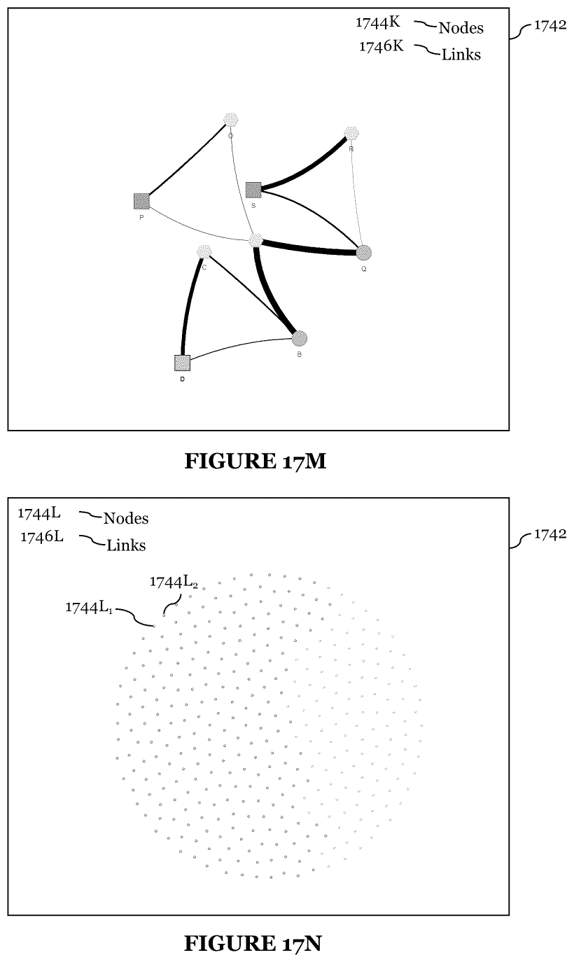

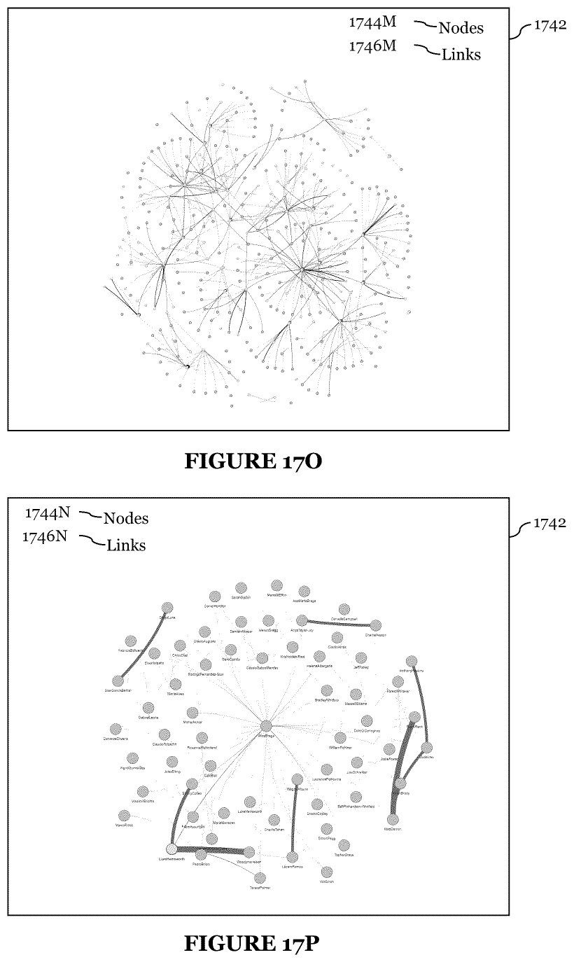

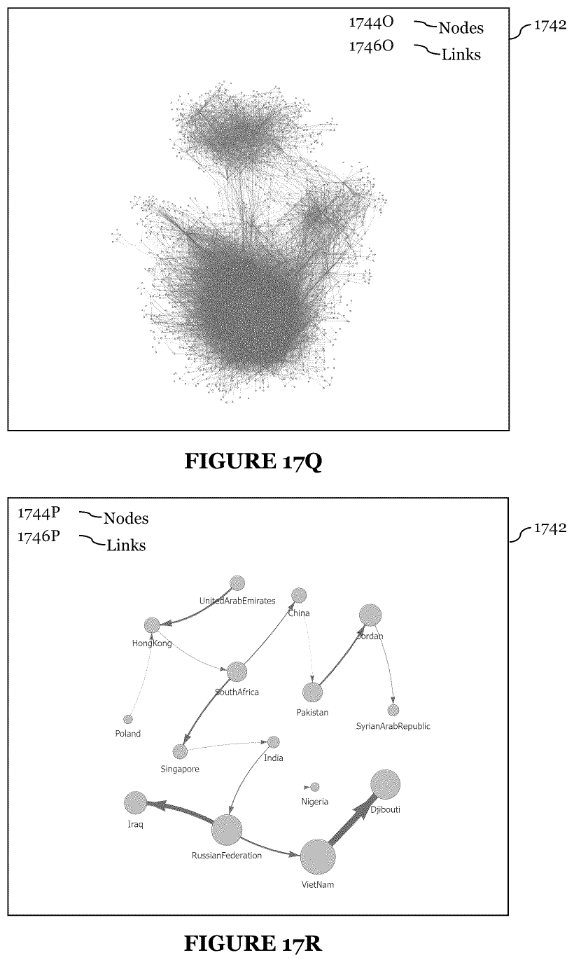

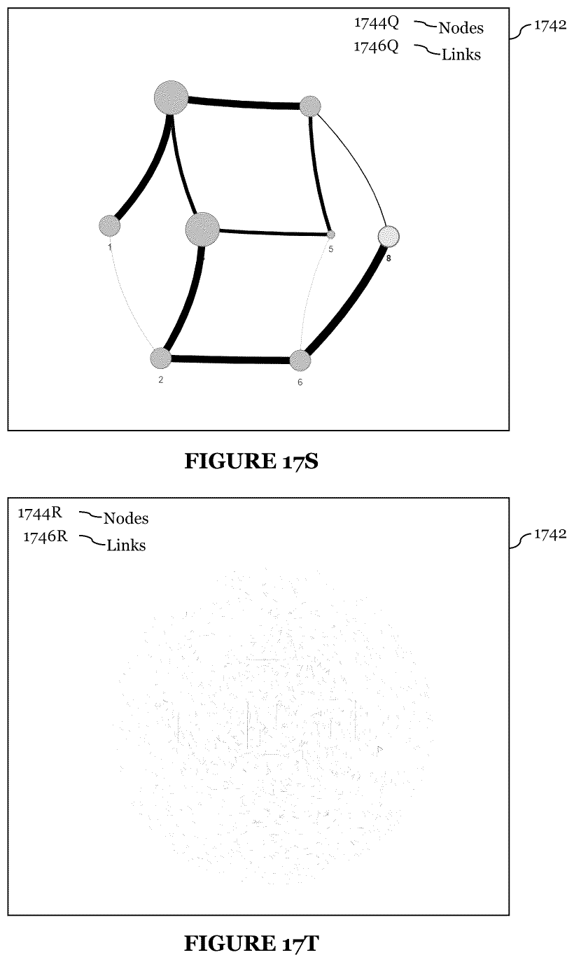

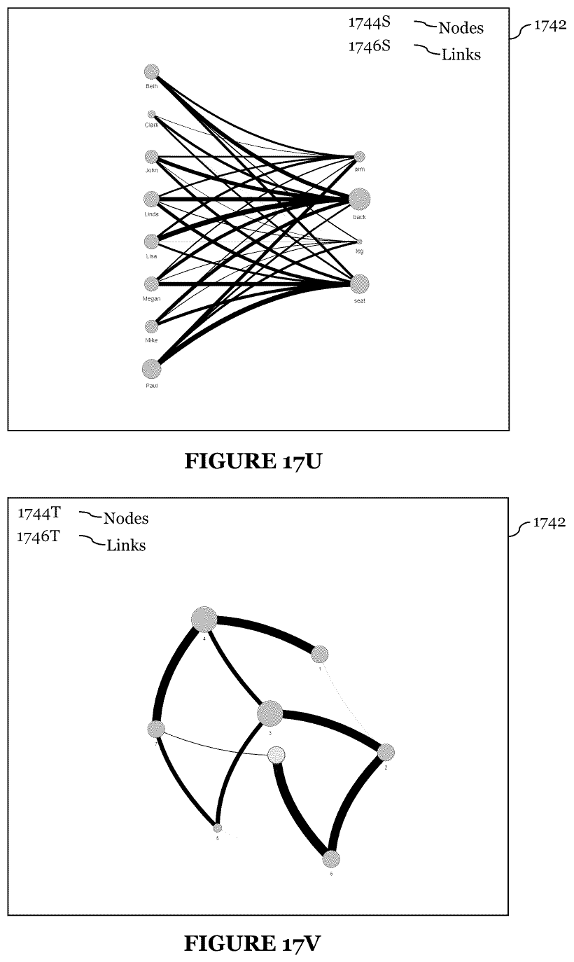

As illustrated in FIG. 17A, the plurality of network visualization parameters 1702 may include a set of parameter values that collectively govern visual encoding, layout behavior, and dynamic update behavior of an interactive network visualization object. The network visualization parameters 1702 may be computed automatically based on characteristics of one or more network datasets and may be embedded into the computer-executable network visualization file for use during visualization rendering and interaction.

In some examples, the network visualization parameters 1702 may include a node scaling range parameter 1704. The node scaling range parameter 1704 may define bounds that constrain sizes of graphical nodes within the interactive network visualization object. The node scaling range parameter 1704 may include one or more of a lower bound 1704A, which may specify a minimum node size, and an upper bound 1704B, which may specify a maximum node size. Use of lower and upper bounds may enable node size variation to remain proportional and visually balanced across networks of varying size.

In some examples, a lower bound of the node scaling range parameter 1704 may correspond to a sum of a first node scaling constant and a logarithm of a total number of nodes in the one or more network datasets. Use of a logarithmic relationship may moderate growth of node size as node count increases, thereby preventing excessive enlargement in larger networks. In some examples, an upper bound 1704B of the node scaling range parameter 1704 may correspond to a sum of a second node scaling constant and a square of the logarithm of the total number of nodes in the one or more network datasets. Use of a squared logarithmic term may allow greater differentiation among nodes in smaller networks while maintaining controlled scaling behavior as network size increases.

The first node scaling constant and the second node scaling constant may create a slope in a node distribution defined by the logarithm of the total number of nodes. Adjustment of the slope may influence how aggressively node sizes vary across different network scales, thereby enabling node size scaling behavior to remain proportional and visually coherent as the interactive network visualization object adapts to different dataset sizes. In a non-limiting example, the node scaling range parameter 1704 may be determined as a range [c₁+log (|N|)) . . . . c₂+ (log (|N|))²], where c₁ and c₂ may represent node scaling constants. It should be noted that there may be examples where the node scaling constants are heuristically determined.

The network visualization parameters 1702 may further include a node font size parameter 1706. The node font size parameter 1706 may control a font size used to render labels associated with graphical nodes. Adjustment of the node font size parameter 1706 may enable labels to remain legible while limiting visual clutter as the number of nodes increases.

In some examples, the node font size parameter 1706 may correspond to a sum of a node font size constant and a logarithm of a total number of nodes in the one or more network datasets. Use of a logarithmic relationship may allow font size to decrease gradually as node count increases, thereby preserving readability in smaller networks while reducing label density in larger networks. The node font size constant may influence a slope of a node label size distribution defined by the logarithm of the total number of nodes. Adjustment of the node font size constant may control how aggressively font size changes across different network scales, enabling label presentation to remain balanced and interpretable across a wide range of dataset sizes. In a non-limiting example, the node font size parameter 1706 may be determined according to c+log (|N|).

In some examples, the network visualization parameters 1702 may include a link scaling range parameter 1708. The link scaling range parameter 1708 may define bounds that constrain widths of graphical links. The link scaling range parameter 1708 may include one or more of a lower bound 1708A, which may specify a minimum link width, and an upper bound 1708B, which may specify a maximum link width. Bounding link widths may reduce overlap in dense networks while preserving visibility in sparser networks.

In some examples, a lower bound of the link scaling range parameter may correspond to a ratio of a logarithm of a total number of links in the one or more network datasets to the total number of links in the one or more network datasets. Use of a ratio in this manner may reduce link width as the number of links increases, thereby limiting excessive overlap in highly connected networks. In some examples, an upper bound of the link scaling range parameter may correspond to a square of a sum of a link width constant and the logarithm of the total number of links in the one or more network datasets. Use of a squared logarithmic relationship may allow differentiation of link widths in smaller networks while maintaining controlled growth as link count increases. In a non-limiting example, the link scaling range parameter 1708 may be determined as a range

$$[ \frac{log ( \vert E \vert )}{\vert E \vert} … c + {( log ( \vert E \vert ) )}^{2} ] .$$

The network visualization parameters 1702 may further include a link font size parameter 1710. The link font size parameter 1710 may control a font size used to render labels associated with graphical links. Adjustment of the link font size parameter 1710 may enable labels to remain legible while limiting visual clutter as the number of links increases.

In some examples, the link font size parameter may correspond to a sum of a link font size constant and a logarithm of a total number of links in the one or more network datasets. Use of a logarithmic relationship may allow link label font size to decrease gradually as link count increases, thereby maintaining legibility in smaller networks while reducing label density in larger networks. The link font size constant may create a slope in a link distribution defined by the logarithm of the total number of links. Adjustment of the slope may control how aggressively font size changes across different network scales. In a non-limiting example, the link font size parameter 1710 may be determined according to c+log (|E|).

In some examples, the network visualization parameters 1702 may include a layout algorithm parameter 1712 that specifies a physics-based layout algorithm used to render a non-georeferenced graph. The layout algorithm parameter 1712 may determine a computational model by which forces are calculated and applied to graphical nodes and graphical links during layout execution. Selection of a physics-based layout algorithm may influence how attraction forces, repulsion forces, spring forces, and grouping behavior are evaluated and combined during iterative rendering. The layout algorithm parameter 1712 may specify one of multiple physics-based layout algorithms (e.g., a Barnes-Hut-based algorithm, a ForceAtlas2-based algorithm, a repulsion-based algorithm, a hierarchical repulsion-based algorithm). In a non-limiting example, the layout algorithm parameter 1712 may be determined according to

$$\frac{log ( \vert N \vert )}{log ( \vert E \vert )} .$$

The network visualization parameters 1702 may further include a grouping threshold parameter 1714. The grouping threshold parameter 1714 may be used to determine a number of groups into which graphical nodes are partitioned during layout calculations. Grouping based on the grouping threshold parameter 1714 may influence clustering behavior and spacing between groups of graphical nodes. A group may refer to a collection of graphical nodes that share a common grouping attribute or are otherwise designated to be treated together during layout calculations. Groups may be used by layout algorithms to apply constraints or forces at a group level rather than solely at an individual node level. Treatment of graphical nodes as groups during layout calculations may influence spacing, clustering behavior, and relative positioning of related nodes within the interactive network visualization object.

In some examples, the grouping threshold parameter may correspond to a product of a grouping threshold constant and a sum of a grouping threshold offset constant and a quotient derived from a ratio of a logarithm of a total number of links in the one or more network datasets to a total number of nodes in the one or more network datasets, scaled by a grouping threshold divisor constant. The grouping threshold offset constant may adjust sensitivity of grouping behavior by shifting how node density and link density influence the number of groups. Adjustment using the grouping threshold offset constant may enable grouping logic to respond smoothly across networks with varying densities, thereby supporting stable layout behavior when network size or connectivity changes. In a non-limiting example, the grouping threshold parameter 1714 may be determined according to

$$m \times ( {c}_{1} + \frac{log ( \frac{\vert N \vert}{\vert E \vert} )}{{c}_{2}} ) .$$

In some examples, the network visualization parameters 1702 may include a node spacing parameter 1716 that represents a gravitational interaction applied between graphical nodes during layout execution. The node spacing parameter 1716 may control whether graphical nodes experience attraction or repulsion relative to one another as forces are iteratively applied by a layout algorithm. Adjustment of the node spacing parameter 1716 may influence how strongly graphical nodes separate in larger networks or cluster in smaller networks, thereby allowing spacing between graphical nodes to emerge dynamically based on network size and structure rather than being explicitly fixed.

In some examples, the gravitational constant may be computed based on a total number of nodes in the one or more network datasets. As node count increases, the gravitational constant may be adjusted to increase repulsive forces between graphical nodes, thereby increasing spacing and reducing congestion caused by a large number of interacting nodes. Conversely, when node count is smaller, the gravitational constant may permit stronger attractive forces, thereby allowing graphical nodes to cluster more closely while maintaining visual clarity.

When a logarithm of a total number of links in the one or more network datasets exceeds a links threshold, the node spacing parameter may correspond to a product of a first spacing constant that adjusts a node distribution defined by a logarithm of a total number of nodes in the one or more network datasets and a sum of a second spacing constant and the logarithm of the total number of nodes in the one or more network datasets. Adjustment of node spacing in this manner may increase separation between graphical nodes as link density increases, thereby reducing congestion caused by a large number of intersecting graphical links.

When the logarithm of the total number of links in the one or more network datasets does not exceed the links threshold, the node spacing parameter may correspond to a product of a third spacing constant that adjusts the node distribution defined by the logarithm of the total number of nodes and the sum of the second spacing constant and the logarithm of the total number of nodes in the one or more network datasets.

In some examples, the node spacing parameter 1716 may be determined according to −cx (1+log (|N|)). Use of such an expression may cause repulsion between graphical nodes to increase as node count grows, thereby increasing spacing in larger networks, while permitting closer node placement in smaller networks. Adjustment of gravitational interaction in this manner may enable node spacing to adapt continuously to changes in network scale during rendering.

The network visualization parameters 1702 may further include a centering parameter 1718 that represents a central gravity applied to the plurality of graphical nodes. The centering parameter 1718 may control a magnitude of an attractive force that draws graphical nodes toward a center of the interactive network visualization object during layout execution. Application of the centering parameter 1718 may counterbalance repulsive and spring-based forces, thereby preventing drift of graphical nodes toward peripheral regions of the display and maintaining a visually coherent and spatially balanced layout within the display region.

In some examples, the central gravity parameter may be independent of a total number of nodes or a total number of links in the one or more network datasets. Use of a constant central attraction may provide a stable reference force that maintains overall cohesion of the network visualization regardless of network scale or connectivity. Central gravity may thereby act as a global stabilizing influence that counterbalances forces that otherwise cause expansion or fragmentation of the layout.

When a logarithm of a total number of links in the one or more network datasets exceeds a links threshold, the centering parameter may correspond to a first centering constant that causes separation of the plurality of graphical nodes by a first distance relative to the center of the interactive network visualization object. Application of the first centering constant may allow larger or denser networks to occupy a broader area around the center. When the logarithm of the total number of links in the one or more network datasets does not exceed the links threshold, the centering parameter may correspond to a second centering constant that causes separation of the plurality of graphical nodes by a second distance relative to the center of the interactive network visualization object. Use of the second centering constant may maintain a more compact layout for smaller or less connected networks while preserving central alignment of graphical nodes within the visualization area. In a non-limiting example, the centering parameter may be determined according to the constant c.

In some examples, the network visualization parameters 1702 may include a link length parameter 1720 that represents a spring length associated with graphical links during physics-based layout execution. The link length parameter 1720 may define a target equilibrium distance between pairs of graphical nodes connected by a graphical link. During layout calculations, spring forces may be applied to graphical nodes to cause connected nodes to move toward or away from one another until an equilibrium corresponding to the spring length is reached.

Adjustment of the link length parameter 1720 may influence how tightly or loosely connected graphical nodes are positioned relative to one another during rendering of the interactive network visualization object. Shorter spring lengths may cause connected nodes to cluster more closely, while longer spring lengths may increase separation between connected nodes to reduce congestion in larger or denser networks. Use of a spring length in this manner may enable link geometry and node positioning to emerge dynamically from simulated physical forces rather than being explicitly specified.

In some examples, the network visualization parameters 1702 may include a link length parameter 1720. The link length parameter 1720 may specify a target distance between connected graphical nodes. Adjustment of the link length parameter 1720 may influence separation of nodes connected by graphical links and may affect overall layout density.

Adjustment of the link length parameter 1720 may influence how tightly or loosely connected graphical nodes are positioned relative to one another during rendering of the interactive network visualization object. Shorter spring lengths may cause connected nodes to cluster more closely, while longer spring lengths may increase separation between connected nodes to reduce congestion in larger or denser networks. Use of a spring length in this manner may enable link geometry and node positioning to emerge dynamically from simulated physical forces rather than being explicitly specified.

When a logarithm of a total number of links in the one or more network datasets exceeds a links threshold, the link length parameter may correspond to a sum of a first link length constant and a product of a second link length constant and a quotient derived from a product of a logarithm of a total number of nodes in the one or more network datasets and the logarithm of the total number of links in the one or more network datasets divided by a link length divisor constant.

When the logarithm of the total number of links in the one or more network datasets does not exceed the links threshold, the link length parameter may correspond to a sum of a third link length constant and a product of the second link length constant and the quotient derived from the product of the logarithm of the total number of nodes and the logarithm of the total number of links divided by the link length divisor constant. In a non-limiting example, the link length parameter 1720 may be determined according to

$${c}_{1} + ( m \times \frac{log ( \vert N \vert ) \times log ( \vert E \vert )}{{c}_{2}} ) .$$

In some examples, the network visualization parameters 1702 may include a link stiffness parameter 1722 that represents a spring constant associated with graphical links during physics-based layout execution. The link stiffness parameter 1722 may control how strongly a graphical link resists deviation from a target equilibrium distance defined by the link length parameter. During layout calculations, the spring constant may influence a magnitude of restorative forces applied to connected graphical nodes when a distance between the nodes deviates from the target spring length.

Adjustment of the link stiffness parameter 1722 may influence a robustness of link geometry during simulation. Higher stiffness values may cause connected graphical nodes to more strongly resist compression or expansion beyond the target link length, thereby stabilizing link structure in densely connected networks. Lower stiffness values may allow greater flexibility in link deformation, thereby permitting graphical nodes to reposition more freely in sparser or less constrained networks. Use of the link stiffness parameter 1722 in this manner may enable stable yet adaptable layout behavior as forces are iteratively applied during rendering of the interactive network visualization object

When a logarithm of a total number of links in the one or more network datasets exceeds a links threshold, the link stiffness parameter may correspond to a product of a first link stiffness constant multiplier and a sum of a first link stiffness constant offset and a quotient derived from a ratio of the logarithm of the total number of links in the one or more network datasets to a logarithm of a total number of nodes in the one or more network datasets. Use of this relationship may increase stiffness in networks with a high ratio of links to nodes.

When the logarithm of the total number of links in the one or more network datasets does not exceed the links threshold, the link stiffness parameter may correspond to a product of a second link stiffness constant multiplier and the sum of the first link stiffness constant offset and the quotient derived from the ratio of the logarithm of the total number of links to the logarithm of the total number of nodes. Adjustment using the second link stiffness constant multiplier may allow greater flexibility in networks with lower connectivity density. In a non-limiting example, the link stiffness parameter 1722 may be determined according to

$$m \times ( 1 + log ( \frac{\vert E \vert}{\vert N \vert} ) .$$

In some examples, the network visualization parameters 1702 may include a motion parameter 1724. The motion parameter 1724 may limit an amount of positional change permitted for graphical nodes between successive layout iterations. Limiting motion using the motion parameter 1724 may reduce oscillation and support smooth convergence of the layout.

In some examples, the motion parameter may correspond to a minimum of a motion constant and a quotient derived from a logarithm of a total number of nodes in the one or more network datasets divided by a logarithm of a total number of links in the one or more network datasets. Use of a minimum function may bound node motion even when dataset characteristics would otherwise permit larger movements. Scaling the motion parameter based on logarithmic relationships between node count and link count may allow motion damping behavior to adapt to network size and connectivity, thereby limiting oscillation in dense networks while permitting greater movement in sparser networks to facilitate layout convergence. In a non-limiting example, the motion parameter 1724 may be determined according to the range

$$[ 1 … \frac{log ( \vert N \vert )}{log ( \vert E \vert )} .$$

The network visualization parameters 1702 may further include an iteration parameter 1726. The iteration parameter 1726 may specify a maximum number of layout iterations performed during rendering. Adjustment of the iteration parameter 1726 may influence convergence quality and computational workload associated with layout execution.

In some examples, the iteration parameter may correspond to a product of an iteration scaling constant and a quotient derived from a sum of an iteration offset constant and a logarithm of a total number of links in the one or more network datasets divided by an iteration divisor constant. Use of this relationship may increase the permitted number of layout iterations as link count increases, thereby allowing more complex networks additional time to stabilize. Application of the iteration offset constant may prevent iteration counts from dropping below a minimum threshold for smaller networks, thereby ensuring sufficient layout refinement even when network size is limited. In a non-limiting example, the iteration parameter 1726 may be determined according to

$$m \times \frac{1 + log ( \vert E \vert )}{c} .$$

In some examples, the network visualization parameters 1702 may include an update interval parameter 1728 and a timestep parameter 1730. The update interval parameter 1728 may control how frequently visual updates are applied during layout execution, and the timestep parameter 1730 may control a temporal increment used during physics-based calculations. Coordination of the update interval parameter 1728 and the timestep parameter 1730 may enable smooth visual transitions and responsive interaction behavior during execution of the interactive network visualization object. In a non-limiting example, the update interval parameter 1728 may be determined according to

$$1 + \frac{1 + log ( \vert E \vert )}{c} \times m .$$

In some examples, the network visualization parameters may include a velocity parameter. The velocity parameter may constrain a range of permissible movement applied to graphical modes during layout simulation. For instance, the velocity parameter may influence how rapidly graphical nodes respond to applied forces during each iteration of a layout algorithm. Regulation of node velocity may prevent instability or overshoot during layout convergence while still permitting sufficient movement for the layout algorithm to resolve structural relationships. The velocity parameter may be determined according to

$$\frac{m \times ( 1 + \frac{log ( \vert E \vert )}{\vert E \vert} )}{c} .$$

As part of automatically generating the computer-executable network visualization file, sub-process 1420C of process 1420 may include automatically embedding, in the computer-executable network visualization file, one or more network visualization rendering instructions based on the plurality of network visualization parameters, the nodes visualization data object, and the links visualization data object. Sub-process 1420C may function to bind executable rendering logic together with data and configuration values into a single executable artifact that produces an interactive network visualization object when executed.

The term “network visualization rendering instructions” may refer to executable instructions that, when executed by a compatible execution environment, instantiate and control an interactive network visualization object. The network visualization rendering instructions may specify how graphical nodes and graphical links are created, how layout algorithms are invoked, how visualization parameters are applied, and how user interactions are handled during execution. The network visualization rendering instructions may be expressed in an executable scripting language and may be interpreted at runtime to render and manage the interactive network visualization object within a user interface.

Embedding the one or more network visualization rendering instructions into the computer-executable network visualization file may include inserting executable script content that references the plurality of network visualization parameters, the nodes visualization data object, and the links visualization data object. Embedding based on these elements may include encoding references to parameter values that control layout behavior, embedding structured data objects that define nodes and links, and incorporating initialization logic that binds data and parameters to the rendering engine. Embedding in this manner may ensure that rendering instructions execute using parameter values and data objects that correspond directly to the network visualization request, thereby preserving alignment between input data characteristics and visualization behavior.

In some examples, the one or more network visualization rendering instructions may instruct a container variable to store a target region for rendering the interactive network visualization object within a user interface. The container variable may identify a display region, such as a panel or viewport, in which the interactive network visualization object is to be rendered. Assignment of the container variable may enable rendering logic to place the visualization at a specific location within the user interface without manually specified placement logic.

In some examples, the one or more network visualization rendering instructions may instruct a data variable to store the nodes visualization data object and the links visualization data object. The data variable may function as a binding mechanism that supplies node-related data and link-related data to the rendering engine. Storing visualization data objects within the data variable may enable rendering logic to access node attributes and link attributes in a structured manner during visualization initialization and layout computation.

In some examples, the one or more network visualization rendering instructions may instruct an options variable to store at least a subset of the plurality of network visualization parameters. The options variable may include configuration values that control layout algorithms, physics behavior, scaling behavior, and interaction behavior. Storing network visualization parameters within the options variable may enable rendering logic to apply parameter values consistently during layout execution and interactive updates.

In some examples, the one or more network visualization rendering instructions may include a network initialization instruction for initializing the interactive network visualization object. The network initialization instruction may instantiate the interactive network visualization object using the container variable, the data variable, and the options variable. To support this instantiation, the network initialization instruction may have a plurality of input arguments. The first input argument may correspond to the container variable, the second input argument may correspond to the data variable

As illustrated in FIG. 17B, the computer-executable network visualization file 1507 may include network visualization rendering instructions 1732 that collectively define how an interactive network visualization object is instantiated and rendered when the computer-executable network visualization file 1507 is executed. The network visualization rendering instructions 1732 may be embedded within the computer-executable network visualization file 1507 during sub-process 1420C and may be configured to execute within a compatible execution environment.

In some examples, the network visualization rendering instructions 1732 may include executable instructions related to a container variable 1734, a data variable 1736, and an options variable 1738. The container variable 1734 may be configured to store a target region of a user interface in which the interactive network visualization object is rendered. The target region may correspond to a designated display area, viewport, or graphical container within the user interface.

The data variable 1736 may be configured to store visualization data used during rendering of the interactive network visualization object. In some examples, the data variable 1736 may include a nodes visualization data object 1604 and a links visualization data object 1620. The nodes visualization data object 1604 may encode node visualization objects corresponding to nodes of the one or more network datasets, and the links visualization data object 1620 may encode link visualization objects corresponding to relationships defined in the one or more network datasets. Storage of visualization data objects in the data variable 1736 may enable rendering logic to access node-related data and link-related data in a structured and executable form.

In some examples, the options variable 1738 may be configured to store at least a subset of the network visualization parameters 1702. The network visualization parameters 1702 stored in the options variable 1738 may include configuration values that control layout behavior, visual scaling, grouping behavior, spacing behavior, centering behavior, and dynamic update behavior of the interactive network visualization object. Storing the network visualization parameters 1702 in the options variable 1738 may enable rendering instructions to apply parameter values during visualization initialization and execution.

The network visualization rendering instructions 1732 may further include a network initialization instruction 1740 configured to initialize the interactive network visualization object. In some examples, the network initialization instruction 1740 may receive a first input argument 1740A corresponding to container variable 1734 (e.g., an argument that specifies a target region of the user interface in which the interactive network visualization object is displayed); a second input argument corresponding to data variable 1736 (e.g., an argument that includes the nodes visualization data object 1604 and the links visualization data object 1620); and a third input argument corresponding to options variable 1738 (e.g., an argument that includes the plurality of network visualization parameters 1702)

Accordingly, execution of the network initialization instruction 1740 may instantiate the interactive network visualization object using the container variable 1734, the data variable 1736, and the options variable 1738. Instantiation using these variables may cause graphical nodes and graphical links to be rendered within the target region of the user interface in accordance with the visualization data objects and the network visualization parameters 1702. Use of the network initialization instruction 1740 in this manner may enable deterministic initialization of the interactive network visualization object based on contents of the computer-executable network visualization file 1507.

As shown in FIG. 14, process 1430 of method 1400 may include displaying, via a user interface, an interactive network visualization object comprising a plurality of graphical nodes and a plurality of graphical links in response to receiving user input opening the computer-executable network visualization file. Process 1430 may function to transition the computer-executable network visualization file from a static executable artifact into an actively rendered and interactive visual representation of the one or more network datasets. Display of the interactive network visualization object at process 1430 may enable users to visually explore network structure, relationships, and attributes without interacting with the analytical environment that produced the one or more network datasets.

The term “user interface” may refer to a graphical presentation layer through which a user interacts with computing system functionality. The user interface may include one or more display regions configured to present visual content and one or more input mechanisms configured to receive user input. In some examples, the user interface may be delivered through a web browser executing on a user device and may provide a rendering surface for execution of the computer-executable network visualization file.

The term “interactive network visualization object” may refer to an executable visual construct generated by execution of the computer-executable network visualization file. The interactive network visualization object may include graphical elements that represent nodes and links and may support user interaction, including selection, navigation, and inspection of visualized network elements. The interactive network visualization object may be dynamically updated in response to user input and internal layout computations during execution.

The term “graphical nodes” may refer to visual elements rendered within the interactive network visualization object that correspond to node visualization objects defined in the nodes visualization data object. Each graphical node may visually encode one or more node attributes, including a node label attribute, a node shape attribute, a node color attribute, and a node value attribute. Graphical nodes may be positioned within the interactive network visualization object based on layout calculations performed using the plurality of network visualization parameters.

The term “graphical links” may refer to visual elements rendered within the interactive network visualization object that correspond to link visualization objects defined in the links visualization data object. Each graphical link may visually encode one or more link attributes, including a link label attribute, a link color attribute, a link value attribute, a link group attribute, and a link direction attribute. Graphical links may be rendered as connecting elements between graphical nodes and may visually represent relationships, directionality, or flow between nodes.

Receiving user input opening the computer-executable network visualization file may involve detecting a user action that causes execution of the computer-executable network visualization file within a compatible execution environment. Such user input may include selection of the file through a graphical file explorer, activation of a hyperlink referencing the file, or invocation of an execution command within a programming environment. Receipt of the user input may trigger execution of embedded network visualization rendering instructions.

Displaying the interactive network visualization object may involve executing the network visualization rendering instructions to instantiate the interactive network visualization object within a target region of the user interface upon receiving the user input. Displaying the interactive network visualization object may further include rendering graphical nodes and graphical links according to the plurality of network visualization parameters and initializing interaction handlers that enable user engagement with the visualization. Execution and display in response to user input may enable visualization of network structures in real-time without additional configuration or manual initialization steps.

In some examples, the interactive network visualization object displayed during process 1430 may correspond to a non-georeferenced graph in which graphical nodes and graphical links are positioned relative to one another without reference to geographic coordinates. A non-georeferenced graph may represent abstract relationships, dependencies, or connectivity patterns generated by network analysis algorithms and network optimization algorithms, including core decomposition network algorithms, connected components network algorithms, community detection network algorithms, reach network algorithms, pattern match network algorithms, node similarity network algorithms, clique network algorithms, cycle network algorithms, topological sort network algorithms, and shortest path network algorithms. Rendering of non-georeferenced graphs may rely on physics-based layout techniques in which forces, constraints, and iterative calculations are applied to determine positions of graphical nodes and graphical links. Use of physics-based rendering may enable graphical nodes to separate, cluster, and stabilize according to connectivity and weighting characteristics defined by the one or more network datasets, thereby producing visual layouts that reflect underlying network structure and that support interactive exploration without reliance on predefined spatial coordinates. Non-limiting examples of parameters used to perform the physics-based rendering may include a layout algorithm parameter, a grouping threshold parameter, a node spacing parameter, a centering parameter, a link length parameter, a link stiffness parameter, a motion parameter, a update interval parameter, and a timestep parameter.

Each graphical node of the plurality of graphical nodes may be displayed at a respective size determined during rendering of the interactive network visualization object. Determination of the respective size may be based at least on a node scaling range parameter included in the plurality of network visualization parameters (e.g., node scaling range parameter 1704). The node scaling range parameter may define a lower bound (e.g., lower bound 1704A) and an upper bound (e.g., upper bound 1704B) that constrain how node sizes are assigned across the interactive network visualization object. Additionally, each graphical node of the plurality of graphical nodes may be displayed with a respective label rendered using a font size determined during visualization rendering. Determination of the font size may be based on a node font size parameter included in the plurality of network visualization parameters (e.g., node font size parameter 1706)

Each graphical link of the plurality of graphical links may be displayed at a respective width determined during rendering of the interactive network visualization object. Determination of the respective width may be based at least on a link scaling range parameter included in the plurality of network visualization parameters. The link scaling range parameter 1708 may define a lower bound 1708A and an upper bound 1708B that constrain how link widths are assigned across the interactive network visualization object. Additionally, each graphical link of the plurality of graphical links may be displayed with a respective label rendered using a font size determined during visualization rendering. Determination of the font size may be based on a link font size parameter included in the plurality of network visualization parameters. The link font size parameter may influence how label text associated with graphical links scales relative to a total number of links represented in the interactive network visualization object.

As described herein, the interactive network visualization object may be used to render a variety of non-georeferenced graphs generated by different network analysis procedures. FIGS. 17C through 17V illustrate representative examples of non-georeferenced network visualizations 1742 that may be generated using different network analysis procedures.

FIG. 17C illustrates a biconnected components network graph in which articulation points within a network may be automatically identified and visually distinguished. The biconnected components network graph may have nodes 1744A (e.g., node 1744A1), links 1746A, and labels 1748A (e.g., label 1748A1). A visualization procedure may flag articulation nodes that connect multiple biconnected components, enabling identification of nodes whose removal would disconnect portions of the network.

FIG. 17D illustrates a centrality network graph in which centrality properties of nodes and links may be visually emphasized. The centrality network graph may have nodes 1744B (e.g., 1744B1 and 1744B2) and links 1746B. A visualization procedure may represent relative importance by varying node sizes, link thicknesses, and color assignments (e.g., nodes 1744B1 and 1744B2 may have different sizes), enabling highly central nodes and heavily utilized links to be distinguished from less influential elements.

FIG. 17E illustrates a clique network graph in which fully connected subgraphs may be automatically identified. The clique network graph may have nodes 1744C and links 1746C (e.g., 1746C1 and 1746C2). A visualization procedure may assign distinct colors to nodes belonging to different cliques, enabling visual separation of densely connected node groups within the broader network.

FIG. 17F illustrates a community network graph generated through community detection analysis. The community network graph may have nodes 1744D and links 1746D. A visualization procedure may highlight detected communities by assigning distinct colors to nodes associated with each community, thereby revealing modular structure and clustering behavior within the network.

FIG. 17G illustrates a connected components network graph in which disconnected subgraphs may be automatically identified. The connected components graph may have nodes 1744E and links 1746E. A visualization procedure may assign distinct colors to nodes belonging to different connected components, enabling visual separation of independent network regions.

FIG. 17H illustrates a core network graph in which cores derived from core decomposition analysis may be visually distinguished. The core network graph may have nodes 1744F and links 1746F. A visualization procedure may assign different colors to nodes based on core membership, allowing layered connectivity strength to be observed across the network.

FIG. 17I illustrates a cycle network graph in which cyclic structures may be highlighted. The cyclic network graph may have nodes 1744G (e.g., 1744G1 and 1744G2) and links 1746G (e.g., 1746G1). A visualization procedure may indicate cycles through a combination of link directionality and node color assignments, enabling identification of feedback loops and cyclic dependencies within the network.

FIG. 17J illustrates a node similarity network graph in which nodes exhibiting similar structural or attribute-based characteristics may be visually emphasized. The node-similarity network graph may have nodes 1744H and links 1746H. A visualization procedure may highlight similarity relationships by accentuating shared connections or overlapping neighborhoods among similar nodes.

FIG. 17K illustrates a path network graph in which traversal paths may be emphasized. The path network graph may have nodes 1744I and links 1746I. A visualization procedure may indicate paths through directed links, enabling visualization of ordered sequences and directional relationships across the network.

FIGS. 17L and 17M illustrate pattern matching network graphs, with FIG. 17L showing an original network and FIG. 17M showing an output network produced by pattern matching analysis. The original network may have nodes 1744J and links 1746J (e.g., link 1746J1) and the output network may include nodes 1744K and links 1746K. A visualization procedure may distinguish the original network, a query subgraph, and resulting matched structures by varying node colors, node sizes, and link thicknesses, enabling visual comparison between input patterns and detected matches.

FIGS. 17N and 170 illustrate projection network graphs generated through network projection analysis. FIG. 17N may depict an intermediate representation emphasizing projected nodes, while FIG. 170 may depict the resulting projected network including both nodes and links. The intermediate representation may have nodes 1744L (e.g., nodes 1744L1 and 1744L2) and may, in some cases, have links 1746L. Additionally, the resulting projected network may likewise have nodes 1744M and links 1746M. A visualization procedure may output the projected network structure by rendering nodes and inferred relationships derived from the projection process.

FIGS. 17P and 17Q illustrate reach network graphs corresponding to different reach distances. FIG. 17P may illustrate a first-degree reach network graph with nodes 1744N and links 1746N, while FIG. 17Q may illustrate a second-degree reach network graph with nodes 17440 and links 17460. A visualization procedure may highlight nodes reachable within a specified number of hops from a reference node, enabling visualization of localized versus extended reachability.

FIG. 17R illustrates a shortest path network graph in which shortest paths across the network may be emphasized. The shortest path network graph may have nodes 1744P and links 1746P. A visualization procedure may indicate shortest paths through link directionality, enabling visual tracing of optimal traversal routes between nodes.

FIG. 17S illustrates a topological sort network graph generated from a directed acyclic network. The topological sort network graph may have nodes 1744Q and links 1746Q. A visualization procedure may highlight topological ordering by encoding order information within node labels, enabling visualization of dependency-respecting execution or processing sequences.

FIG. 17T illustrates a transitive closure network graph in which reachable relationships between nodes may be represented. The transitive closure network graph may have nodes 1744R and links 1746R. A visualization procedure may display links implied by transitive reachability, enabling visualization of indirect connectivity throughout the network.

FIG. 17U illustrates a linear assignment network graph representing a bipartite structure. The linear assignment network graph may have nodes 1744S and links 1746S. A visualization procedure may depict two disjoint sets of nodes with links representing assignment relationships, enabling visualization of pairing or matching solutions generated by linear assignment analysis.

FIG. 17V illustrates a minimum cut network graph in which cut sets separating the network into partitions may be visualized. The minimum cut network graph may have nodes 1744T and nodes 1746T. A visualization procedure may represent minimum cuts through node and link depiction, enabling identification of critical separations and vulnerability points within the network.

In some examples, the interactive network visualization object displayed during process 1430 may correspond to a georeferenced graph in which graphical nodes and graphical links are positioned based on geographic coordinates rather than relative layout calculations. A georeferenced graph may represent network structures in which nodes are associated with latitude and longitude values and links represent spatial relationships or traversal paths between geographic locations. Georeferenced graphs may be generated by network optimization algorithms and routing algorithms, including shortest path network algorithms, vehicle routing network algorithms, traveling salesman network algorithms, and minimum cost network flow algorithms. Rendering of georeferenced graphs may rely on map-based visualization techniques in which graphical nodes are rendered as markers or symbols at specified geographic locations and graphical links are rendered as polylines or paths over an interactive geographic map, thereby enabling visualization of spatial relationships, routes, and flows without application of physics-based layout algorithms.

In some examples, georeferenced rendering of the interactive network visualization object may include configuring an initial geographic view based on information provided in the network visualization request. The processing circuitry described herein may determine a geographic center for the interactive map using latitude and longitude values specified in the request and may initialize the map display around the determined geographic center.

Additionally, the processing circuitry described herein may determine an initial zoom level for the interactive geographic map based on a zoom value specified in the network visualization request. The zoom level may control a geographic scale at which map features, graphical nodes, and graphical links are displayed. During rendering, each graphical node may be positioned at a location corresponding to latitude and longitude coordinates associated with the respective node, thereby preserving geographic relationships represented in the one or more network datasets.

In some examples, georeferenced rendering may include displaying graphical nodes as geometric shapes positioned at geographic coordinates on the interactive map. Each graphical node may be rendered with a combination of visual attributes, including shape, size, color, and label, while maintaining alignment with underlying geographic coordinates.

The processing circuitry described herein may select a geometric representation for graphical nodes based on configuration information provided in the network visualization request. Color assignment may be determined using a categorical attribute associated with each graphical node, such as a node type, by indexing a predefined color set. Node size may be determined using a value associated with the graphical node, where nodes with non-positive values are rendered using a baseline size and nodes with positive values are rendered using a scaled size that reflects the relative magnitude of the value within a range of node values. Labels displayed with graphical nodes may be derived from label attributes specified in corresponding records of the one or more network datasets.

In some examples, georeferenced rendering may include representing graphical nodes using icon-based markers positioned at geographic coordinates. Icon-based rendering may be used to convey semantic roles or functional categories of nodes while preserving precise geographic placement.

Processing circuitry may determine visual characteristics of each marker based on attributes associated with the corresponding graphical node. Marker color may be selected based on a node type attribute. A label associated with the graphical node may be displayed in association with the marker. When a quantitative value associated with the graphical node exceeds a threshold, the value may also be displayed or otherwise bound to the marker.

In some examples, when a graphical node represents an origin or similar focal location, rendering may further include displaying an additional geometric overlay centered at the geographic location of the node. The overlay may be rendered with a radius and color and may include one or more bound attributes associated with the node, including a label, a value, or depot-related information, thereby enabling layered representation of node-related data within the geographic map.

In some examples, georeferenced rendering may include displaying graphical links as linear paths over the interactive geographic map. A graphical link may be rendered as a polyline connecting geographic coordinates associated with a source graphical node and a sink graphical node, thereby representing a route, flow, or connection between geographic locations.

Processing circuitry may determine visual properties of the polyline based on attributes included in corresponding records of the one or more network datasets. A thickness of the polyline may reflect a value associated with the graphical link, and a color of the polyline may reflect a categorical attribute associated with the graphical link. When label information is available, the label may be bound to the polyline as an interactive element, such as a tooltip, enabling access to additional link-related information without cluttering the map display.

In some examples, georeferenced rendering of graphical links may include selectively placing markers at endpoints of rendered polylines based on routing semantics or visualization configuration. Processing circuitry may render markers at geographic locations corresponding to source and sink graphical nodes associated with a graphical link, and may bind identifying labels to the markers when such labels are available.

In some examples, marker appearance may vary depending on a routing or marker configuration specified in the network visualization request. Marker color may be determined based on node type attributes associated with the corresponding graphical nodes. In other examples, rendering may include placing markers at origin and destination nodes associated with a route and binding label attributes to those markers. Conditional marker placement in this manner may enable endpoint roles, directionality, and routing semantics to be conveyed clearly within the interactive geographic map.

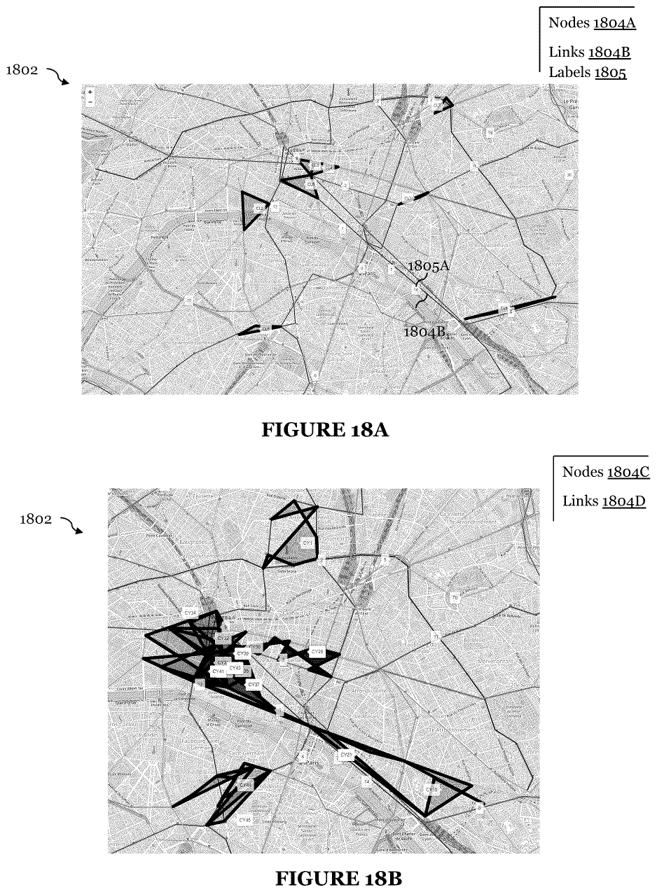

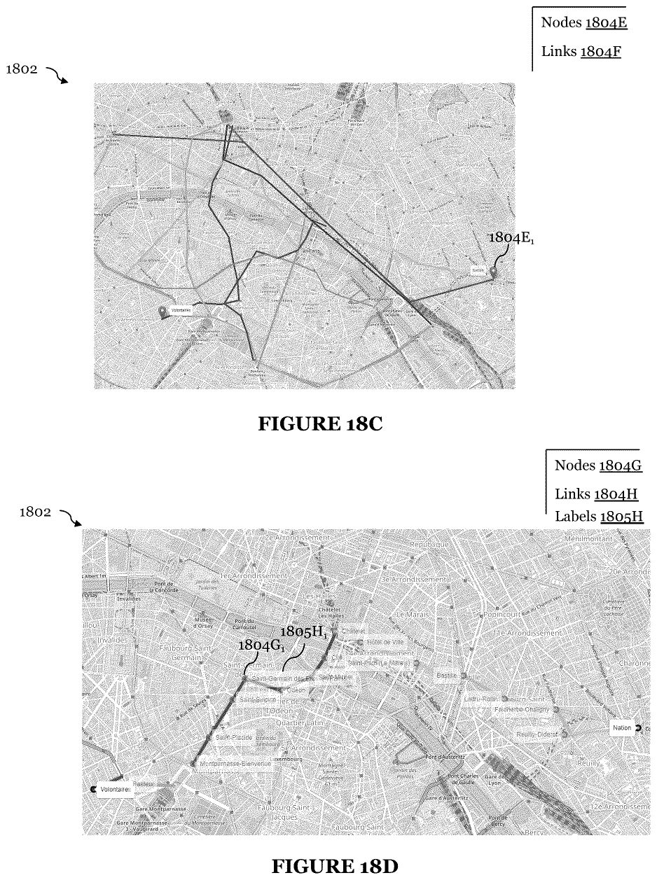

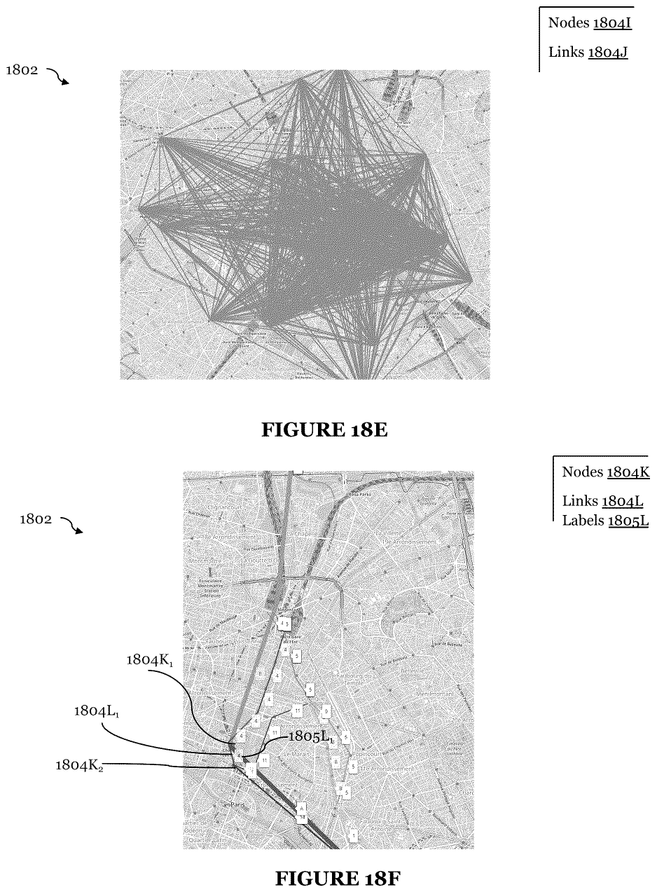

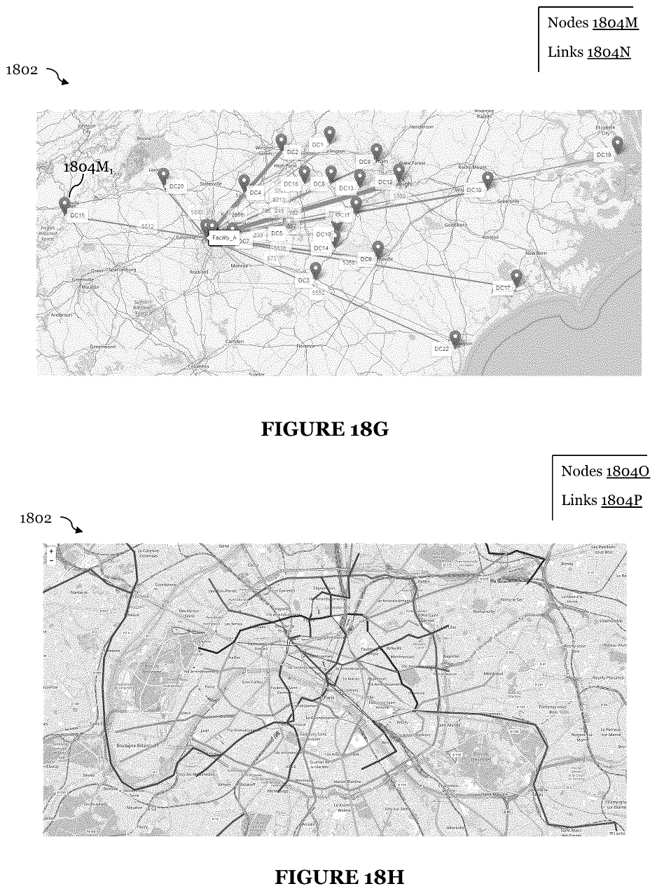

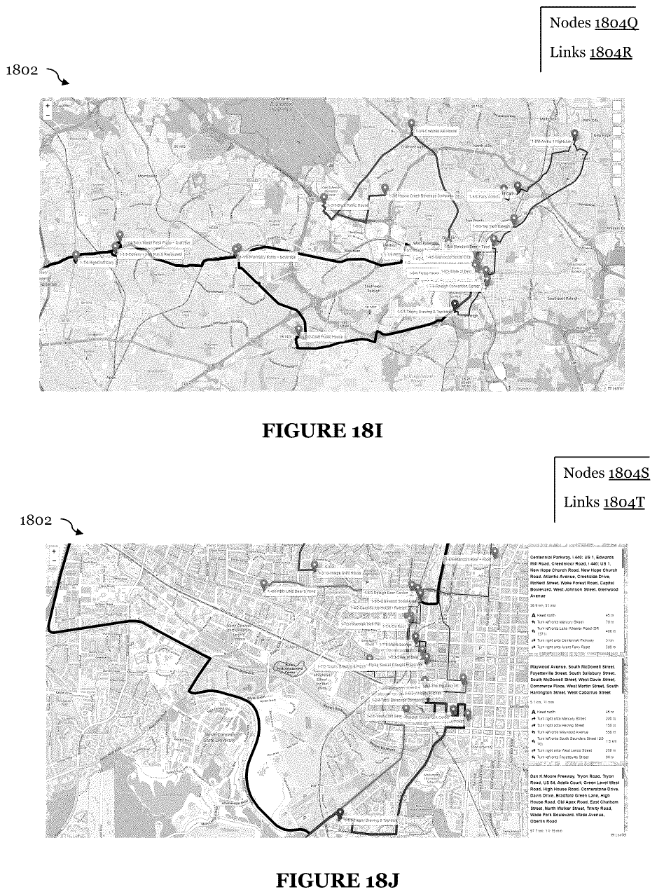

In some examples, the interactive network visualization object may be used to render georeferenced graphs derived from network analysis and network optimization procedures. Such georeferenced graphs may represent analytical results overlaid on an interactive geographic map, in which graphical nodes are positioned at latitude and longitude coordinates and graphical links are rendered as geographic paths. A visualization procedure may encode analytical outcomes using visual attributes such as line thickness, line color, node markers, labels, and annotations, thereby enabling spatial interpretation of network structure, routing behavior, and flow characteristics. FIGS. 18A through 18J illustrate representative examples of georeferenced network visualizations 1802 generated using different network analysis procedures. It should be noted that the examples depicted in FIGS. 18A through 18J are plotted using Leaflet and base map imagery from OpenStreetMap, @OpenStreetMap. However, other map databases and/or map visualization libraries may be utilized without deviating from the scope of the present disclosure.

FIG. 18A illustrates a georeferenced clique network graph in which fully connected subgraphs may be identified within a spatial network. The georeferenced clique network graph may include nodes 1804A, links 1804B (e.g., link 1804B1), and labels 1805 (e.g., 1805A). A visualization procedure may highlight cliques by visually distinguishing nodes and links associated with each clique, enabling identification of densely interconnected geographic regions.

FIG. 18B illustrates a georeferenced cycle network graph in which cyclic paths within the network may be identified. The georeferenced cycle network graph may include nodes 1804C and links 1804D. A visualization procedure may highlight existing cycles using directional link representations or distinct visual encodings, enabling detection of feedback loops or circular routes within the geographic context.

FIG. 18C illustrates a georeferenced path network graph in which traversal paths may be represented across the interactive geographic map. The georeferenced path network graph may include nodes 1804E (e.g., node 1804E1) and links 1804F. A visualization procedure may display paths as lines connecting geographic locations, enabling visualization of ordered sequences or routes spanning multiple nodes.

FIG. 18D illustrates a georeferenced shortest path network graph in which shortest paths between nodes may be determined and displayed. The georeferenced shortest path network graph may include nodes 1804G (e.g. node 1804G1), links 1804H, and labels 1805H (e.g., label 1805H1). A visualization procedure may render the shortest paths as geographic lines, enabling identification of optimal routes across the map.

FIG. 18E illustrates a georeferenced transitive closure network graph in which indirect connectivity relationships may be visualized. The georeferenced transitive closure network may include nodes 1804I and links 1804J. A visualization procedure may highlight all reachable connections between nodes in the original network, enabling visualization of connectivity throughout the network.

FIG. 18F illustrates a georeferenced maximum flow network graph in which flow capacity results may be visualized. The georeferenced maximum flow graph may include nodes 1804K (e.g., nodes 1804K1 and 1804K2), links 1804L (e.g., label 1804L1), and labels 1805L (e.g., label 1805L1). A visualization procedure may represent links associated with maximum flow using line thickness and volume labels, enabling geographic interpretation of capacity utilization and flow distribution.

FIG. 18G illustrates a georeferenced minimum-cost network flow graph in which cost-optimized flows may be displayed. The georeferenced minimum-cost network flow graph may include nodes 1804M and links 1804N. A visualization procedure may represent flow paths using geographic lines and volume labels, enabling visualization of cost-efficient routing across spatially distributed nodes.

FIG. 18H illustrates a georeferenced minimum spanning tree network graph in which a spanning structure connecting all nodes at minimal total weight may be visualized. The georeferenced minimum spanning tree network graph may include nodes 18040 and links 1804P. A visualization procedure may render the minimum spanning tree using thicker lines or distinct colors, enabling differentiation of selected links from non-selected links on the map.

FIGS. 18I and 18J illustrate georeferenced vehicle routing problem network graphs, with FIG. 18I depicting routes with itineraries and FIG. 18J depicting routes without itineraries. The georeferenced vehicle routing problem network depicting routes with itineraries may have nodes 18040 and links 1804R. The georeferenced vehicle routing problem network depicting routes without itineraries may have nodes 1804S and links 1804T. A visualization procedure may represent vehicle routes using line thickness, line color, sequence labels, volume labels, and optional itinerary overlays, enabling visualization of routing order, load distribution, and traversal paths across the geographic map.

As shown in FIG. 14, process 1440 of method 1400 may include modifying, in the interactive network visualization object, one or more of the plurality of graphical nodes and the plurality of graphical links in response to receiving a network manipulation user input while the user interface is displaying the interactive network visualization object. Process 1440 may enable iterative investigative analysis without regenerating visualization logic or reissuing a network visualization request. Modification of graphical nodes and graphical links in response to user input may allow investigation of network structure by adjusting visual elements, triggering layout recalculations, or revealing additional attribute information, thereby supporting repeated examination and comparison of network behaviors as analytical conditions change without regenerating the computer-executable network visualization file.

The term “network manipulation user input” may refer to a user-initiated interaction directed at the interactive network visualization object that is intended to alter visual state or behavior of one or more graphical nodes or one or more graphical links. The network manipulation user input may include actions such as selecting a graphical node, selecting a graphical link, dragging a graphical node to a new position, zooming within the visualization, panning the visualization, or triggering display of attribute information associated with graphical elements. The network manipulation user input may be received through one or more input devices associated with the user interface, including a pointing device, a keyboard, or a touch-sensitive input surface.

Receiving a network manipulation user input while the user interface is displaying the interactive network visualization object may include detecting user interaction events generated during execution of the network visualization rendering instructions. Detection of the network manipulation user input may occur while graphical nodes and graphical links are actively rendered within the user interface. Receipt of the network manipulation user input during display may enable real-time response by processing circuitry without interruption of visualization execution.

Modifying one or more of the plurality of graphical nodes and the plurality of graphical links in response to receiving the network manipulation user input may involve updating visual properties, positions, or visibility states of graphical elements within the interactive network visualization object. Modification may include repositioning graphical nodes during drag operations, recalculating layout forces following user interaction, highlighting selected graphical nodes or graphical links, or updating displayed labels or attribute values.

In some examples, execution of the computer-executable network visualization file may occur within a web browser that provides an execution environment for rendering graphical content and processing user input events. Rendering of the interactive network visualization object within the web browser may include execution of network visualization rendering instructions expressed in an executable scripting language supported by the web browser. Execution within the web browser may enable rendering of graphical nodes and graphical links using browser-native rendering capabilities, including dynamic layout computation, event handling, and incremental visual updates, without installation of specialized visualization software on a user device.

Rendering within the web browser may further include iterative execution of layout algorithms, physics simulations, and visual updates that operate continuously or in response to user interaction. For non-georeferenced graphs, browser-based rendering may include repeated evaluation of visualization parameters to update positions of graphical nodes and graphical links in real time. For georeferenced graphs, browser-based rendering may include integration with interactive geographic map components that support panning, zooming, and layered rendering of markers, shapes, and polylines based on geographic coordinates.

User manipulation of the interactive network visualization object may be enabled through browser-generated input events that are bound to the graphical nodes and graphical links during rendering. Such user manipulation may include selecting graphical nodes or graphical links, dragging graphical nodes to new positions, zooming the visualization view, panning across the visualization area, and triggering display of attribute information associated with selected elements. Detection and handling of user manipulation events may be performed by executable event handlers embedded within the network visualization rendering instructions, thereby enabling direct coupling between user input and visual state updates.

Browser-based execution of the interactive network visualization object may further enable responsive performance by leveraging client-side computation for layout iteration, visual updates, and interaction handling. Such execution may reduce reliance on server-side rendering and may allow visual feedback to be presented immediately in response to user input.

It shall also be noted that the system and methods of the embodiments and variations described herein can be embodied and/or implemented at least in part as a machine comprising a computer-readable medium storing computer-readable instructions. The instructions may be executed by computer-executable components integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, memory sticks (e.g., SD cards, USB flash drives), cloud-based services (e.g., cloud storage), magnetic storage devices, Solid-State Drives (SSDs), or any suitable device. The computer-executable component is preferably a general or application-specific processor, but any suitable dedicated hardware or hardware/firmware combination device can alternatively or additionally execute the instructions.

It shall be noted that, in the method(s) described herein where one or more steps (e.g., processes) are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The systems and methods of the preferred embodiments may additionally, or alternatively, be implemented on an integrated data analytics software application and/or software architecture such as those offered by SAS Institute Inc. of Cary, N.C., USA. Merely for illustration, the systems and methods of the preferred embodiments may be implemented using or integrated with one or more SAS software tools such as SAS® Viya™ which is developed and provided by SAS Institute Inc. of Cary, N.C., USA.

Although omitted for conciseness, the preferred embodiments include every combination and permutation of the implementations of the systems and methods described herein in real-time or near real-time, asynchronously (e.g., sequentially), concurrently (e.g., in parallel), or in any other suitable order by and/or using one or more instances of the systems, elements, and/or entities described herein. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

Embodiments of the system and/or method can include every combination and permutation of the various system components and the various method processes, wherein one or more instances of the method and/or processes described herein can be performed in real-time or near real-time, asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the application without departing from the scope of the various described embodiments

What is claimed is:

1. A computer-program product comprising a non-transitory machine-readable storage medium storing computer instructions that, when executed by processing circuitry, perform operations comprising:
receiving a network visualization request associated with one or more network datasets;
automatically generating a network visualization file in response to receiving the network visualization request, wherein automatically generating the network visualization file includes:
automatically generating a nodes visualization data object and a links visualization data object from the one or more network datasets,
automatically computing a plurality of network visualization parameters optimized for the one or more network datasets, and
automatically embedding, in the network visualization file, one or more network visualization rendering instructions based on the plurality of network visualization parameters, the nodes visualization data object, and the links visualization data object;
displaying, via a user interface, an interactive network visualization object comprising a plurality of graphical nodes and a plurality of graphical links in response to receiving user input opening the network visualization file; and
modifying, in the interactive network visualization object, one or more of the plurality of graphical nodes and the plurality of graphical links in response to receiving a network manipulation user input while the user interface is displaying the interactive network visualization object.

2. The computer-program product according to claim 1, wherein:
a respective graphical node of the plurality of graphical nodes is a visual representation of a respective node visualization object in the nodes visualization data object, and
the respective graphical node visually represents one or more of:
a label attribute specified in the respective node visualization object;
a shape attribute specified in the respective node visualization object;
a color attribute specified in the respective node visualization object; and
a value attribute specified in the respective node visualization object.

3. The computer-program product according to claim 1, wherein:
a respective graphical link of the plurality of graphical links is a visual representation of a respective link visualization object in the links visualization data object, and
the respective graphical link visually represents one or more of:
a label attribute specified in the respective link visualization object;
a color attribute specified in the respective link visualization object;
a value attribute specified in the respective link visualization object;
a connection from a source node and a target node specified in the respective link visualization object; and
a direction attribute specified in the plurality of network visualization parameters that indicates whether the connection from the source node to the target node includes an arrow.

4. The computer-program product according to claim 1, wherein generating the nodes visualization data object includes:
(a) identifying a respective node in the one or more network datasets,
(b) in accordance with a determination that the respective node is at a first index, adding, to the nodes visualization data object, a first string of text that:
initializes an array of node objects, and
includes a first node visualization object comprising one or more attributes of the respective node;
(c) in accordance with a determination that the respective node is not at the first index, appending, to the nodes visualization data object, a second string of text comprising the first node visualization object;
(d) repeating (a)-(c) for each additional respective node in the one or more network datasets; and
(e) adding, to the nodes visualization data object, a final string of text that syntactically closes the array of node objects.

5. The computer-program product according to claim 1, wherein generating the links visualization data object includes:
(a) identifying a respective link in the one or more network datasets,
(b) in accordance with a determination that the respective link is at a first index, adding, to the links visualization data object, a first string of text that:
initializes an array of link objects, and
includes a first link visualization object comprising one or more attributes of the respective link;
(c) in accordance with a determination that the respective link is not at the first index, appending, to the links visualization data object, a second string of text comprising the first link visualization object;
(d) repeating (a)-(c) for each additional respective link in the one or more network datasets; and
(e) adding, to the links visualization data object, a final string of text that syntactically closes the array of link objects.

6. The computer-program product according to claim 1, wherein the one or more network visualization rendering instructions:
instruct a container variable to store a target region for rendering the interactive network visualization object in the user interface,
instruct a data variable to store the nodes visualization data object and the links visualization data object,
instruct an options variable to store at least a subset of the plurality of network visualization parameters, and
instantiate the interactive network visualization object using the container variable, the data variable, and the options variable.

7. The computer-program product according to claim 1, wherein:
the network visualization request is configured to visualize a plurality of types of network datasets, and
the plurality of types of network datasets that the network visualization request is configured to visualize includes one or more of:
the one or more network datasets generated by a core decomposition network algorithm,
one or more network datasets generated by a connected components network algorithm,
one or more network datasets generated by a community detection network algorithm,
one or more network datasets generated by a reach network algorithm,
one or more network datasets generated by a pattern match network algorithm,
one or more network datasets generated by a node similarity network algorithm,
one or more network datasets generated by a cycle network algorithm,
one or more network datasets generated by a clique network algorithm,
one or more network datasets generated by a topological sort network algorithm,
one or more network datasets generated by a shortest path network algorithm, and
one or more network datasets generated by a vehicle routing network algorithm.

8. The computer-program product according to claim 1, wherein:
the one or more network datasets include a tabular nodes dataset that is not empty and a tabular links dataset that is empty,
the tabular links dataset is automatically generated from the tabular nodes dataset in response to a determination that the tabular links dataset is empty, and
automatically generating the tabular links dataset includes:
in accordance with a determination that a network type input argument included in the network visualization request corresponds to a clique network:
(a) detecting a pair of nodes in the tabular nodes dataset that have a common clique identifier;
(b) inserting, into the tabular links dataset, a link from a first node specified in the pair to a second node specified in the pair; and
(c) repeating steps (a) and (b) for one or more additional pairs of nodes that have one or more second common clique identifiers.

9. The computer-program product according to claim 8, wherein:
automatically generating the tabular links dataset from the tabular nodes dataset further includes:
in accordance with a determination that the network type input argument included in the network visualization request corresponds to a cycle network:
(a) detecting, from the tabular nodes dataset, a respective node and a next node that follows the respective node;
(b) inserting, into the tabular links dataset, a link from the respective node to the next node; and
(c) repeating steps (a) and (b) for a remainder of nodes in the tabular nodes dataset.

10. The computer-program product according to claim 1, wherein:
the one or more network datasets include a tabular links dataset that is not empty, and
the computer instructions, when executed by the processing circuitry, perform the operations comprising:
(a) identifying a respective link specified in the tabular links dataset,
(b) identifying, from a link attributes input argument, a link attribute entry corresponding to the respective link,
(c) assigning one or more link attributes to the respective link based on the link attribute entry, and
(d) repeating steps (a)-(c) for each additional respective link specified in the tabular links dataset.

11. The computer-program product according to claim 1, wherein:
the one or more network datasets include a tabular links dataset that is not empty and a tabular nodes dataset that is empty, and the network visualization request includes a link attributes input argument,
the tabular nodes dataset is automatically generated from the tabular links dataset in response to a determination that the tabular nodes dataset is empty, and
automatically generating the tabular nodes dataset includes:
(a) identifying a respective link in the tabular links dataset and a link attribute entry corresponding to the respective link in the link attributes input argument,
(b) adding, to the tabular nodes dataset, a first node that corresponds to a source node associated with the respective link and includes one or more first node attributes derived from the link attribute entry,
(c) adding, to the tabular nodes dataset, a second node that corresponds to a destination node associated with the respective link and includes one or more second node attributes derived from the link attribute entry,
(d) repeating steps (a)-(c) for a remainder of links specified in the tabular links dataset,
(e) assigning one or more additional node attributes to each node added to the tabular nodes dataset in steps (a)-(d), and
(f) removing one or more duplicate nodes in the tabular nodes dataset after performing steps (a)-(e).

12. The computer-program product according to claim 1, wherein:
the one or more network datasets include a tabular nodes dataset that is not empty, and
the computer instructions, when executed by the processing circuitry, perform the operations comprising:
(a) identifying a respective node specified in the tabular nodes dataset,
(b) identifying, from a nodes attribute input argument, a node attribute entry corresponding to the respective node,
(c) assigning one or more node attributes to the respective node based on the node attribute entry, and
(d) repeating steps (a)-(c) for each additional respective node specified in the tabular nodes dataset.

13. The computer-program product according to claim 1, wherein:
a respective link in the one or more network datasets includes one or more of: a link source attribute, a link destination attribute, a link weight attribute, a link label attribute, a link group attribute, and a link direction attribute;
a respective node in the one or more network datasets includes one or more of: a node identifier attribute, a node label attribute, a node group value, a node value attribute, a node shape attribute, and a node color attribute; and
if the respective link or the respective node is automatically generated, at least one attribute of the respective link or the respective node corresponds to a default value.

14. The computer-program product according to claim 1, wherein:
the interactive network visualization object corresponds to an interactive geographic map,
a display center of the interactive geographic map is determined from a centering latitude input argument and a centering longitude input argument specified in the network visualization request,
a display zoom of the interactive geographic map is determined from a zoom level input argument specified in the network visualization request, and
the interactive geographic map displays a respective graphical node of the plurality of graphical node at a position that corresponds to a latitude and longitude coordinate associated with the respective graphical node.

15. The computer-program product according to claim 1, wherein:
the interactive network visualization object is an interactive geographic map that displays a respective graphical node of the plurality of graphical nodes with one or more of: a respective shape, a respective radius, a respective color, and a respective label, and
when a map type input argument of the network visualization request corresponds to a first shape, the one or more network visualization rendering instructions:
set the respective shape of the respective graphical node to the first shape,
select the respective color of the respective graphical node by indexing a color array based on a type specified for the respective graphical node in a source node type input argument,
set the respective radius of the respective graphical node to:
a predefined constant when a value of the respective graphical node is non-positive; and
a scaled value when the value of the respective graphical node is positive, wherein the scaled value is proportional to the value of the respective graphical node relative to a range of node values and offset by a minimum radius, and
set the respective label of the respective graphical node to a label attribute specified in a corresponding record of the one or more network datasets.

16. The computer-program product according to claim 1, wherein:
the interactive network visualization object is an interactive geographic map that visually represents a respective graphical node of the plurality of graphical nodes as an icon, and
when a map type input argument of the network visualization request corresponds to a marker type, the one or more network visualization rendering instructions:
set the icon as a marker,
set a color of the marker based on a type specified for the respective graphical node in a source node type input argument,
render the marker at a latitude and longitude associated with the respective graphical node,
bind, to the marker, a label associated with the respective graphical node,
bind, to the marker, a value associated with the respective graphical node when the value exceeds a threshold,
display a circle centered at the latitude and longitude of the respective graphical node with a respective radius and a respective color when the respective graphical node corresponds an origin node input argument, and
bind, to the circle, one or more attributes of the respective graphical node including at least one of: the label, the value, a depot label, and a depot value when the value exceeds the threshold.

17. The computer-program product according to claim 1, wherein when a map type input argument of the network visualization request corresponds to a line type, the one or more network visualization rendering instructions cause the interactive network visualization object to:
render a respective graphical link of the plurality of graphical links as a polyline between a latitude and longitude of a source graphical node and a latitude and longitude of a sink graphical node,
set a thickness of the polyline based on a value attribute included in a corresponding record in the one or more network datasets,
set a color of the polyline based on a color attribute included in the corresponding record, and
when a label attribute is present in the corresponding record, bind the label attribute to the polyline as a tooltip.

18. The computer-program product according to claim 17, wherein when the map type input argument of the network visualization request corresponds to the line type, the one or more network visualization rendering instructions further cause the interactive network visualization object to:
when a marker type input argument corresponds to a first marker type:
render a first marker at the latitude and longitude of the source graphical node,
when a node label attribute is present for the source graphical node, bind the node label attribute of the source graphical node to the first marker,
set a color of the first marker based on a type of the source graphical node,
render a second marker at the latitude and longitude of the sink graphical node,
when a node label attribute is present for the sink graphical node, bind the node label attribute of the sink graphical node to the second marker, and
set a color of the second marker based on a type of the sink graphical node; and
when the marker type input argument corresponds to a second marker type:
render a third marker at a latitude and longitude of an origin graphical node,
bind, to the third marker, a label node attribute associated with the origin graphical node,
render a fourth marker at a latitude and longitude of a destination graphical node, and
bind, to the fourth marker, a label node attribute associated with the destination graphical node.

19. The computer-program product according to claim 1, wherein:
the one or more network visualization rendering instructions includes a network initialization instruction for initializing the interactive network visualization object, and
the network initialization instruction receives a plurality of input arguments, including:
a first input argument that specifies a target region of the user interface to display the interactive network visualization object,
a second input argument that includes the nodes visualization data object and the links visualization data object, and
a third input argument that includes the plurality of network visualization parameters.

20. The computer-program product according to claim 1, wherein:
a respective graphical node of the plurality of graphical nodes is displayed at a respective size,
the interactive network visualization object determines the respective size for the respective graphical node based at least on a node scaling range parameter included in the plurality of network visualization parameters,
a lower bound of the node scaling range parameter corresponds to a sum of a first node scaling constant and a logarithm of a total number of nodes in the one or more network datasets,
an upper bound of the node scaling range parameter corresponds to a sum of a second node scaling constant and a square of the logarithm of the total number of nodes in the one or more network datasets, and
the first node scaling constant and the second node scaling constant creates a slope in a node distribution defined by the logarithm of the total number of nodes.

21. The computer-program product according to claim 1, wherein:
a respective graphical node of the plurality of graphical nodes is displayed with a respective label,
the interactive network visualization object displays the respective label based on a node font size parameter included in the plurality of network visualization parameters,
the node font size parameter corresponds to a sum of a node font size constant and a square of a logarithm of a total number of nodes in the one or more network datasets, and
the node font size constant creates a slope in a node distribution defined by the logarithm of the total number of nodes.

22. The computer-program product according to claim 1, wherein:
a respective graphical link of the plurality of graphical links is displayed at a respective width,
the interactive network visualization object determines the respective width for the respective graphical link based at least on a link scaling range parameter included in the plurality of network visualization parameters,
a lower bound of the link scaling range parameter corresponds to a ratio of a logarithm of a total number of links in the one or more network datasets to the total number of links in the one or more network datasets,
an upper bound of the link scaling range parameter corresponds to a square of a sum of a link width constant and the logarithm of the total number of links in the one or more network datasets, and
the link width constant creates a slope in a link distribution defined by the logarithm of the total number of links.

23. The computer-program product according to claim 1, wherein:
a respective graphical link of the plurality of graphical links is displayed with a respective label,
the interactive network visualization object displays the respective label based on a link font size parameter included in the plurality of network visualization parameters,
the link font size parameter corresponds to a sum of a link font size constant and a logarithm of a total number of links in the one or more network datasets, and
the link font size constant creates a slope in a link distribution defined by the logarithm of the total number of links.

24. The computer-program product according to claim 1, wherein:
the interactive network visualization object determines a layout for the plurality of graphical nodes and the plurality of graphical links based at least on a layout algorithm parameter included in the plurality of network visualization parameters,
the layout algorithm parameter specifies a first layout algorithm when a logarithm of a total number of links in the one or more network datasets exceeds a links threshold that creates a slope in a link distribution defined by the logarithm of the total number of links, and
the layout algorithm parameter specifies a second layout algorithm when the logarithm of the total number of links does not exceed the links threshold.

25. The computer-program product according to claim 1, wherein:
the interactive network visualization object determines a number of groups of graphical nodes to be used during layout calculations,
the interactive network visualization object determines the number of groups of graphical nodes based on a grouping threshold parameter included in the plurality of network visualization parameters,
the grouping threshold parameter corresponds to a product of:
a grouping threshold constant, and
a sum of:
a grouping threshold offset constant, and
a quotient of:
a ratio of a logarithm of a total number of links in the one or more network datasets to a total number of nodes in the one or more network datasets, and
a grouping threshold divisor constant that sets a scale of the ratio, and
the grouping threshold offset constant adjusts a nodes and a link distribution defined by the logarithm of the total number of links and a logarithm of the total number of nodes.

26. The computer-program product according to claim 1, wherein:
the interactive network visualization object determines a spacing between the plurality of graphical nodes,
the interactive network visualization object determines the spacing based on a node spacing parameter included in the plurality of network visualization parameters,
when a logarithm of a total number of links in the one or more network datasets exceeds a links threshold, the node spacing parameter corresponds to a product of:
a first spacing constant that adjusts a node distribution defined by a logarithm of a total number of nodes in the one or more network datasets, and
a sum of:
a second spacing constant; and
the logarithm of the total number of nodes in the one or more network datasets, and
when the logarithm of the total number of links in the one or more network datasets does not exceed the links threshold, the node spacing parameter corresponds to a product of:
a third spacing constant that adjusts the node distribution defined by the logarithm of the total number of nodes, and
the sum of:
the second spacing constant, and
the logarithm of the total number of nodes in the one or more network datasets.

27. The computer-program product according to claim 1, wherein:
the interactive network visualization object positions the plurality of graphical nodes relative to a center of the interactive network visualization object,
the interactive network visualization object determines the positions of the plurality of graphical nodes relative to the center of the interactive network visualization object based on a centering parameter included in the plurality of network visualization parameters,
when a logarithm of a total number of links in the one or more network datasets exceeds a links threshold, the centering parameter corresponds to a first centering constant that causes separation of the plurality of graphical nodes by a first distance in the interactive network visualization object, and
when the logarithm of the total number of links in the one or more network datasets does not exceed the links threshold, the centering parameter corresponds to a second centering constant that causes separation of the plurality of graphical nodes by a second distance in the interactive network visualization object.

28. The computer-program product according to claim 1, wherein:
a respective graphical link of the plurality of graphical links is displayed in the interactive network visualization object with a respective length,
the interactive network visualization object determines the respective length for the respective graphical link based on a link length parameter included in the plurality of network visualization parameters,
when a logarithm of a total number of links in the one or more network datasets exceeds a links threshold, the link length parameter corresponds to a sum of:
a first link length constant that adjusts distances of the plurality of graphical links in the interactive network visualization object by a first amount, and
a product of:
a second link length constant; and
a quotient of:
a product of a logarithm of a total number of nodes in the one or more network datasets and the logarithm of the total number of links in the one or more network datasets; and
a link length divisor constant, and
the second link length constant scales an average nodes and links distribution defined by the quotient,
when the logarithm of the total number of links in the one or more network datasets does not exceed the links threshold, the link length parameter corresponds to a sum of:
a third link length constant that adjusts distances of the plurality of graphical links in the interactive network visualization object by a second amount, and
the product of:
the second link length constant; and
the quotient of:
the product of the logarithm of the total number of nodes in the one or more network datasets and the logarithm of the total number of links in the one or more network datasets; and
the link length divisor constant.

29. A computer-implemented method, comprising:
receiving a network visualization request associated with one or more network datasets;
automatically generating a network visualization file in response to receiving the network visualization request, wherein automatically generating the network visualization file includes:
automatically generating a nodes visualization data object and a links visualization data object from the one or more network datasets,
automatically computing a plurality of network visualization parameters optimized for the one or more network datasets, and
automatically embedding, in the network visualization file, one or more network visualization rendering instructions based on the plurality of network visualization parameters, the nodes visualization data object, and the links visualization data object;
displaying, via a user interface, an interactive network visualization object comprising a plurality of graphical nodes and a plurality of graphical links in response to receiving user input opening the network visualization file; and
modifying, in the interactive network visualization object, one or more of the plurality of graphical nodes and the plurality of graphical links in response to receiving a network manipulation user input while the user interface is displaying the interactive network visualization object.

30. A computer-implemented system comprising:
processing circuitry;
a memory; and
a computer-readable medium operably coupled to the processing circuitry the computer-readable medium having computer-readable instructions stored thereon that, when executed by the processing circuitry, cause a computing device to perform operations comprising:
receiving a network visualization request associated with one or more network datasets;
automatically generating a network visualization file in response to receiving the network visualization request, wherein automatically generating the network visualization file includes:
automatically generating a nodes visualization data object and a links visualization data object from the one or more network datasets,
automatically computing a plurality of network visualization parameters optimized for the one or more network datasets, and
automatically embedding, in the network visualization file, one or more network visualization rendering instructions based on the plurality of network visualization parameters, the nodes visualization data object, and the links visualization data object;
displaying, via a user interface, an interactive network visualization object comprising a plurality of graphical nodes and a plurality of graphical links in response to receiving user input opening the network visualization file; and
modifying, in the interactive network visualization object, one or more of the plurality of graphical nodes and the plurality of graphical links in response to receiving a network manipulation user input while the user interface is displaying the interactive network visualization object.
